(19) United States
(12) Patent Application Publication
(10) Pub. No.: US 2025/0264697 A1
(43) Pub. Date: Aug. 21, 2025

(54) IMAGING LENS AND IMAGING APPARATUS

(71) Applicant: FUJIFILM Corporation, Tokyo (JP)

(72) Inventors: Yu KITAHARA, Saitama-shi (JP); Masanao Kawana, Saitama-shi (JP); Masato Kondo, Saitama-shi (JP)

(73) Assignee: FUJIFILM Corporation, Tokyo (JP)

(21) Appl. No.: 19/204,088

(22) Filed: May 9, 2025

Related U.S. Application Data
(63) Continuation of application No. PCT/JP2023/038062, filed on Oct. 20, 2023.

(30) Foreign Application Priority Data
Nov. 24, 2022 (JP) 2022-187440

(51) Int. Cl. G02B 13/00; G02B 13/18

(52) U.S. Cl. CPC G02B 13/0045; G02B 13/18

(57) ABSTRACT

An imaging lens consists of, in order from an object side, a front group, a stop, and a rear group. The front group includes, in successive order from a side closest to the object side, a first lens that is a negative lens having a concave surface facing an image side and a second lens that is a negative lens having a concave surface facing the image side. Two or less focus lens groups are disposed on the image side with respect to the second lens. During focusing, the two or less focus lens groups move along an optical axis, and lenses other than the two or less focus lens groups are fixed with respect to an image plane. The imaging lens satisfies a predetermined conditional expression.

### CROSS-REFERENCE TO RELATED APPLICATIONS

This application is a continuation application of International Application No. PCT/JP2023/038062, filed on Oct. 20, 2023, which claims priority from Japanese Patent Application No. 2022-187440, filed on Nov. 24, 2022. The entire disclosure of each of the above applications is incorporated herein by reference.

### BACKGROUND

### Technical Field

The technology of the present disclosure relates to an imaging lens and an imaging apparatus.

### Related Art

In the related art, as an imaging lens that can be used in an imaging apparatus, such as a digital camera, an imaging lens disclosed in JP2022-033487A and JP2016-038418A are known.

### SUMMARY

There has been a demand for an imaging lens that has a small size and that maintains favorable optical performance. These requirement levels are increasing year by year.

An object of the present disclosure is to provide an imaging lens that has a small size and that maintains favorable optical performance, and an imaging apparatus comprising the imaging lens.

A first aspect of the present disclosure relates to an imaging lens consisting of, in order from an object side to an image side, a front group, a stop, and a rear group, in which the front group includes, in successive order from a side closest to the object side to the image side, a first lens that is a negative lens having a concave surface facing the image side and a second lens that is a negative lens having a concave surface facing the image side, two or less focus lens groups are disposed on the image side with respect to the second lens, during focusing, the two or less focus lens groups move along an optical axis, and lenses other than the two or less focus lens groups are fixed with respect to an image plane, and in a case in which a back focus of an entire system at an air conversion distance in a state in which an infinite distance object is in focus is denoted by Bf, a focal length of the entire system in a state in which the infinite distance object is in focus is denoted by f, and a maximum half angle of view in a state in which the infinite distance object is in focus is denoted by ωm, Conditional Expression (1) is satisfied, which is represented by 0.3<Bf/(f×tan ωm)<1.5 (1).

A second aspect of the present disclosure relates to the imaging lens according to the first aspect, in which, in a case in which a distance on the optical axis from a lens surface of the imaging lens closest to the object side to the stop in a state in which the infinite distance object is in focus is denoted by STI, and a sum of a distance on the optical axis from the lens surface of the imaging lens closest to the object side to a lens surface of the imaging lens closest to the image side and the back focus of the entire system at the air conversion distance, in a state in which the infinite distance object is in focus, is denoted by TL, Conditional Expression (2) is satisfied, which is represented by 0.3<STI/TL<0.75 (2).

A third aspect of the present disclosure relates to the imaging lens according to the first aspect, in which, in a case in which a focal length of the front group in a state in which the infinite distance object is in focus is denoted by fF, and a focal length of the rear group in a state in which the infinite distance object is in focus is denoted by fR, Conditional Expression (3) is satisfied, which is represented by −2<fR/fF<4 (3).

A fourth aspect of the present disclosure relates to the imaging lens according to the first aspect, in which, in a case in which a paraxial curvature radius of an object side surface of the first lens is denoted by RL1f, Conditional Expression (4) is satisfied, which is represented by −0.3<f/RL1f<8 (4).

A fifth aspect of the present disclosure relates to the imaging lens according to the first aspect, in which, in a case in which a paraxial curvature radius of an image side surface of the first lens is denoted by RL1r, Conditional Expression (5) is satisfied, which is represented by 0<f/RL1r<4 (5).

A sixth aspect of the present disclosure relates to the imaging lens according to the first aspect, in which, in a case in which a focal length of the front group in a state in which the infinite distance object is in focus is denoted by fF, Conditional Expression (6) is satisfied, which is represented by −1<f/fF<2 (6).

A seventh aspect of the present disclosure relates to the imaging lens according to the first aspect, in which, in a case in which a maximum imaging magnification of the imaging lens is denoted by β, Conditional Expression (7) is satisfied, which is represented by 0.06<|β|<0.5 (7).

An eighth aspect of the present disclosure relates to the imaging lens according to the first aspect, in which, in a case in which a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (8) is satisfied, which is represented by 3<TL/(f×tan ωm)<7 (8).

A ninth aspect of the present disclosure relates to the imaging lens according to the first aspect, in which, in a case in which an open F-number in a state in which the infinite distance object is in focus is denoted by FNo, Conditional Expression (9) is satisfied, which is represented by 0.55<FNo/tan ωm<2 (9).

A tenth aspect of the present disclosure relates to the imaging lens according to the first aspect, in which, in a case in which an Abbe number of the first lens based on a d line is denoted by νL1, Conditional Expression (10) is satisfied, which is represented by 20<νL1<95 (10).

An eleventh aspect of the present disclosure relates to the imaging lens according to the first aspect, in which, in a case in which a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (8-3) is satisfied, which is represented by 3.5<TL/(f×tan ωm)<5.65 (8-3).

A twelfth aspect of the present disclosure relates to the imaging lens according to the eleventh aspect, in which, in a case in which an open F-number in a state in which the infinite distance object is in focus is denoted by FNo, Conditional Expression (9-3) is satisfied, which is represented by 0.7<FNo/tan ωm<1.35 (9-3).

A thirteenth aspect of the present disclosure relates to the imaging lens according to the twelfth aspect, in which, in a case in which an Abbe number of the first lens based on a d line is denoted by νL1, Conditional Expression (10-1) is satisfied, which is represented by 28<νL1<59 (10-1).

A fourteenth aspect of the present disclosure relates to the imaging lens according to the first aspect, in which the imaging lens includes only one focus lens group, the focus lens group is disposed in the rear group, and in a case in which a focal length of the focus lens group is denoted by ff, Conditional Expression (11) is satisfied, which is represented by 0.05<|f/ff|<0.9 (11).

A fifteenth aspect of the present disclosure relates to the imaging lens according to the first aspect, in which the imaging lens includes only one focus lens group, the focus lens group is disposed in the rear group, and in a case in which a focal length of the focus lens group is denoted by ff, and a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (12) is satisfied, which is represented by 0.1<|TL/ff|<6 (12).

A sixteenth aspect of the present disclosure relates to the imaging lens according to the fourteenth aspect, in which, in a case in which a combined focal length of all lenses on the image side with respect to the focus lens group is denoted by ff_r, Conditional Expression (13) is satisfied, which is represented by 0.05<f/ff_r<1.5 (13).

A seventeenth aspect of the present disclosure relates to the imaging lens according to the fourteenth aspect, in which, in a case in which a combined focal length of all lenses on the object side with respect to the focus lens group is denoted by ff_f, Conditional Expression (14) is satisfied, which is represented by −3<f/ff_f<0 (14).

An eighteenth aspect of the present disclosure relates to the imaging lens according to the fourteenth aspect, in which, in a case in which a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (8-1) is satisfied, which is represented by 3.2<TL/(f×tan ωm)<6.5 (8-1).

A nineteenth aspect of the present disclosure relates to the imaging lens according to the eighteenth aspect, in which, in a case in which an open F-number in a state in which the infinite distance object is in focus is denoted by FNo, Conditional Expression (9-3) is satisfied, which is represented by 0.7<FNo/tan ωm<1.35 (9-3).

A twentieth aspect of the present disclosure relates to the imaging lens according to the nineteenth aspect, in which, in a case in which an Abbe number of the first lens based on a d line is denoted by νL1, Conditional Expression (10-1) is satisfied, which is represented by 28<νL1<59 (10-1).

A twenty-first aspect of the present disclosure relates to the imaging lens according to the first aspect, in which the imaging lens includes only one focus lens group, and the focus lens group is disposed in the front group.

A twenty-second aspect of the present disclosure relates to the imaging lens according to the twenty-first aspect, in which, in a case in which a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (8-2) is satisfied, which is represented by 3.4<TL/(f×tan ωm)<5.9 (8-2).

A twenty-third aspect of the present disclosure relates to the imaging lens according to the twenty-second aspect, in which, in a case in which an open F-number in a state in which the infinite distance object is in focus is denoted by FNo, Conditional Expression (9-2) is satisfied, which is represented by 0.66<FNo/tan ωm<1.55 (9-2).

A twenty-fourth aspect of the present disclosure relates to the imaging lens according to the first aspect, in which the focus lens group includes the stop, and the stop moves along the optical axis during focusing.

A twenty-fifth aspect of the present disclosure relates to the imaging lens according to the twenty-fourth aspect, in which the imaging lens includes only one focus lens group, and in a case in which a focal length of the focus lens group is denoted by ffs, Conditional Expression (15) is satisfied, which is represented by 0.1<f/ffs<0.5 (15).

A twenty-sixth aspect of the present disclosure relates to the imaging lens according to the twenty-fourth aspect, in which, in a case in which a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (8-2) is satisfied, which is represented by 3.4<TL/(f×tan ωm)<5.9 (8-2).

A twenty-seventh aspect of the present disclosure relates to the imaging lens according to the twenty-sixth aspect, in which, in a case in which an open F-number in a state in which the infinite distance object is in focus is denoted by FNo, Conditional Expression (9) is satisfied, which is represented by 0.55<FNo/tan ωm<2 (9).

A twenty-eighth aspect of the present disclosure relates to the imaging lens according to the twenty-fourth aspect, in which, in a case in which a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (8) is satisfied, which is represented by 3<TL/(f×tan ωm)<7 (8).

A twenty-ninth aspect of the present disclosure relates to the imaging lens according to the twenty-eighth aspect, in which, in a case in which an open F-number in a state in which the infinite distance object is in focus is denoted by FNo, Conditional Expression (9-1) is satisfied, which is represented by 0.64<FNo/tan ωm<1.62 (9-1).

A thirtieth aspect of the present disclosure relates to the imaging lens according to the first aspect, in which the imaging lens includes two focus lens groups, and in a case in which, among the two focus lens groups, the focus lens group on the object side is defined as a first focus lens group, and the focus lens group on the image side is defined as a second focus lens group, the first focus lens group and the second focus lens group move by different movement amounts during focusing.

A thirty-first aspect of the present disclosure relates to the imaging lens according to the thirtieth aspect, in which, in a case in which a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (8-2) is satisfied, which is represented by 3.4<TL/(f×tan ωm)<5.9 (8-2).

A thirty-second aspect of the present disclosure relates to the imaging lens according to the thirty-first aspect, in which, in a case in which an open F-number in a state in which the infinite distance object is in focus is denoted by FNo, Conditional Expression (9-2) is satisfied, which is represented by 0.66<FNo/tan ωm<1.55 (9-2).

A thirty-third aspect of the present disclosure relates to the imaging lens according to the thirtieth aspect, in which the first focus lens group is disposed in the front group, and the second focus lens group is disposed in the rear group.

A thirty-fourth aspect of the present disclosure relates to the imaging lens according to the thirty-third aspect, in which, in a case in which a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (8) is satisfied, which is represented by 3<TL/(f×tan ωm)<7 (8).

A thirty-fifth aspect of the present disclosure relates to the imaging lens according to the thirty-fourth aspect, in which, in a case in which an open F-number in a state in which the infinite distance object is in focus is denoted by FNo, Conditional Expression (9-2) is satisfied, which is represented by 0.66<FNo/tan ωm<1.55 (9-2).

A thirty-sixth aspect of the present disclosure relates to the imaging lens according to the thirty-fifth aspect, in which Conditional Expression (1-1) is satisfied, which is represented by 0.43<Bf/(f×tan ωm)<1.1 (1-1).

A thirty-seventh aspect of the present disclosure relates to the imaging lens according to the thirty-sixth aspect, in which, in a case in which an Abbe number of the first lens based on a d line is denoted by νL1, Conditional Expression (10) is satisfied, which is represented by 20<νL1<95 (10).

A thirty-eighth aspect of the present disclosure relates to the imaging lens according to the thirtieth aspect, in which, in a case in which a focal length of the first focus lens group is denoted by ff1, and a focal length of the second focus lens group is denoted by ff2, Conditional Expression (16) is satisfied, which is represented by 0.2<ff1/ff2|<5 (16).

A thirty-ninth aspect of the present disclosure relates to the imaging lens according to the thirtieth aspect, in which, in a case in which a lateral magnification of the first focus lens group in a state in which the infinite distance object is in focus is denoted by βf1, and a lateral magnification of the second focus lens group in a state in which the infinite distance object is in focus is denoted by βf2, Conditional Expression (17) is satisfied, which is represented by 0<|βf1/βf2|<0.6 (17).

A fortieth aspect of the present disclosure relates to the imaging lens according to the thirtieth aspect, in which, in a case in which a lateral magnification of the first focus lens group in a state in which the infinite distance object is in focus is denoted by βf1, Conditional Expression (18) is satisfied, which is represented by 0<{βf1+(1/βf1)}⁻²<0.25 (18).

A forty-first aspect of the present disclosure relates to the imaging lens according to the thirtieth aspect, in which, in a case in which a lateral magnification of the second focus lens group in a state in which the infinite distance object is in focus is denoted by βf2, Conditional Expression (19) is satisfied, which is represented by 0<{βf2+(1/βf2)}⁻²<0.25 (19).

A forty-second aspect of the present disclosure relates to the imaging lens according to the thirtieth aspect, in which, in a case in which a combined focal length of all lenses on the image side with respect to the second focus lens group is denoted by f2r, Conditional Expression (20) is satisfied, which is represented by 0.1<f/f2r<2 (20).

A forty-third aspect of the present disclosure relates to the imaging lens according to the thirtieth aspect, in which, in a case in which a combined focal length of all lenses on the object side with respect to the first focus lens group is denoted by f1f, Conditional Expression (21) is satisfied, which is represented by −3<f/f1f<2 (21).

A forty-fourth aspect of the present disclosure relates to the imaging lens according to the first aspect, in which, in a case in which a focal length of the first lens is denoted by fL1, and a focal length of the second lens is denoted by fL2, Conditional Expression (22) is satisfied, which is represented by 0<fL1/fL2<5.5 (22).

A forty-fifth aspect of the present disclosure relates to the imaging lens according to the first aspect, in which, in a case in which a focal length of the first lens is denoted by fL1, Conditional Expression (23) is satisfied, which is represented by −8<fL1/f<−0.5 (23).

A forty-sixth aspect of the present disclosure relates to the imaging lens according to the first aspect, in which, in a case in which a paraxial curvature radius of an object side surface of the first lens is denoted by RL1f, and a paraxial curvature radius of an image side surface of the first lens is denoted by RL1r, Conditional Expression (24) is satisfied, which is represented by −2.5<(RL1r−RL1f)/(RL1r+RL1f)<−0.1 (24).

A forty-seventh aspect of the present disclosure relates to the imaging lens according to the first aspect, in which, in a case in which a paraxial curvature radius of an object side surface of the second lens is denoted by RL2f, and a paraxial curvature radius of an image side surface of the second lens is denoted by RL2r, Conditional Expression (25) is satisfied, which is represented by −1.5<(RL2r−RL2f)/(RL2r+RL2f)<−0.05 (25).

A forty-eighth aspect of the present disclosure relates to the imaging lens according to the first aspect, in which a third lens that is a negative lens is disposed adjacent to the image side of the second lens, a fourth lens that is a positive lens is disposed adjacent to the image side of the third lens, and in a case in which a focal length of the third lens is denoted by fL3, and a focal length of the fourth lens is denoted by fL4, Conditional Expression (26) is satisfied, which is represented by −8<fL3/fL4<0 (26).

A forty-ninth aspect of the present disclosure relates to the imaging lens according to the first aspect, in which, in a case in which a paraxial curvature radius of an object side surface of a lens of the imaging lens closest to the image side is denoted by RLef, and a paraxial curvature radius of an image side surface of a lens of the imaging lens closest to the image side is denoted by RLer, Conditional Expression (27) is satisfied, which is represented by 0.4<(RLer−RLef)/(RLer+RLef)<5.5 (27).

A fiftieth aspect of the present disclosure relates to the imaging lens according to the first aspect, in which at least one of an object side surface or an image side surface of the first lens is an aspherical surface, and in a case in which a paraxial curvature radius of the object side surface of the first lens is denoted by RL1f, a paraxial curvature radius of the image side surface of the first lens is denoted by RL1r, a curvature radius of the object side surface of the first lens at a position of a maximum effective diameter is denoted by RyL1f, and a curvature radius of the image side surface of the first lens at the position of the maximum effective diameter is denoted by RyL1r, Conditional Expression (28) is satisfied, which is represented by 0.5<(1/RL1f−1/RL1r)/(1/RyL1f−1/RyL1r)<7 (28).

A fifty-first aspect of the present disclosure relates to the imaging lens according to the fiftieth aspect, in which, in a case in which an Abbe number of the first lens based on a d line is denoted by νL1, Conditional Expression (10-2) is satisfied, which is represented by 32<νL1<48 (10-2).

A fifty-second aspect of the present disclosure relates to the imaging lens according to the first aspect, in which the front group includes at least one positive lens, and in a case in which a focal length of a positive lens having a strongest refractive power among the positive lenses included in the front group is denoted by fFp, Conditional Expression (29) is satisfied, which is represented by 0.1<f/fFp<3 (29).

A fifty-third aspect of the present disclosure relates to the imaging lens according to the first aspect, in which the rear group includes at least one positive lens, and in a case in which a focal length of a positive lens having a strongest refractive power among the positive lenses included in the rear group is denoted by fRp, and a focal length of the rear group in a state in which the infinite distance object is in focus is denoted by fR, Conditional Expression (30) is satisfied, which is represented by 0.3<fR/fRp<5 (30).

A fifty-fourth aspect of the present disclosure relates to the imaging lens according to the first aspect, in which the rear group includes a cemented lens in which a positive lens having a convex surface facing the object side and a negative lens are cemented in order from the object side, and in a case in which an Abbe number of the positive lens of the cemented lens based on a d line is denoted by νRp, and an Abbe number of the negative lens of the cemented lens based on the d line is denoted by νRn, Conditional Expression (31) is satisfied, which is represented by 10<νRp−νRn<75 (31).

A fifty-fifth aspect of the present disclosure relates to the imaging lens according to the fifty-fourth aspect, in which, in a case in which a refractive index of the positive lens of the cemented lens at the d line is denoted by NRp, and a refractive index of the negative lens of the cemented lens at the d line is denoted by NRn, Conditional Expression (32) is satisfied, which is represented by 0.2<NRp−NRn<0.9 (32).

A fifty-sixth aspect of the present disclosure relates to the imaging lens according to the first aspect, in which an LFe lens that is a positive lens is disposed on a side of the front group closest to the image side.

A fifty-seventh aspect of the present disclosure relates to the imaging lens according to the fifty-sixth aspect, in which the LFe lens is a biconvex lens.

A fifty-eighth aspect of the present disclosure relates to the imaging lens according to the fifty-sixth aspect, in which at least one of an object side surface or an image side surface of the LFe lens is an aspherical surface, and in a case in which a paraxial curvature radius of the object side surface of the LFe lens is denoted by RcLFef, a paraxial curvature radius of the image side surface of the LFe lens is denoted by RcLFer, a curvature radius of the object side surface of the LFe lens at a position of a maximum effective diameter is denoted by RyLFef, and a curvature radius of the image side surface of the LFe lens at the position of the maximum effective diameter is denoted by RyLFer, Conditional Expression (33) is satisfied, which is represented by 0.5<(1/RcLFef−1/RcLFer)/(1/RyLFef−1/RyLFer)<7 (33).

A fifty-ninth aspect of the present disclosure relates to the imaging lens according to the fifty-sixth aspect, in which, in a case in which a paraxial curvature radius of an object side surface of the LFe lens is denoted by RcLFef, and a paraxial curvature radius of an image side surface of the LFe lens is denoted by RcLFer, Conditional Expression (34) is satisfied, which is represented by −4<(RcLFef−RcLFer)/(RcLFef+RcLFer)<10 (34).

A sixtieth aspect of the present disclosure relates to the imaging lens according to the fifty-sixth aspect, in which, in a case in which an Abbe number of the LFe lens based on a d line is denoted by νLFe, Conditional Expression (35) is satisfied, which is represented by 15<νLFe<90 (35).

A sixty-first aspect of the present disclosure relates to the imaging lens according to the first aspect, in which, in a case in which a central thickness of the first lens is denoted by D1, and a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (36) is satisfied, which is represented by 0.007<D1/TL<0.1 (36).

A sixty-second aspect of the present disclosure relates to the imaging lens according to the first aspect, in which, in a case in which a thickness of the first lens in an optical axis direction at a height of a maximum effective diameter of an image side surface of the first lens is denoted by DH1, and a central thickness of the first lens is denoted by D1, Conditional Expression (37) is satisfied, which is represented by 2<DH1/D1<10 (37).

A sixty-third aspect of the present disclosure relates to the imaging lens according to the first aspect, in which, in a case in which an Abbe number of a lens of the imaging lens closest to the image side based on a d line is denoted by νLe, Conditional Expression (38) is satisfied, which is represented by 30<νLe<95 (38).

A sixty-fourth aspect of the present disclosure relates to the imaging lens according to the first aspect, in which, in a case in which an effective radius of an object side surface of the first lens is denoted by EL1, Conditional Expression (39) is satisfied, which is represented by 0.7<EL1/(f×tan ωm)<2 (39).

A sixty-fifth aspect of the present disclosure relates to the imaging lens according to the first aspect, further comprising: an Ls lens on the image side with respect to the second lens, in which, in a case in which a refractive index of the Ls lens at a d line is denoted by NLs, an Abbe number of the Ls lens based on the d line is denoted by νLs, and a partial dispersion ratio of the Ls lens between a g line and an F line is denoted by θgFLs, Conditional Expressions (40), (41), (42), and (43) are satisfied, which are represented by 0.005<NLs−(2.015−0.0068×νLs)<0.15 (40), 49.8<νLs<65 (41), 0.543<θgFLs<0.58 (42), and −0.011<θgFLs−(0.6418−0.00168×νLs)<0.035 (43).

A sixty-sixth aspect of the present disclosure relates to the imaging lens according to the sixth-fifth aspect, in which, in a case in which a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (8-3) is satisfied, which is represented by 3.5<TL/(f×tan ωm)<5.65 (8-3).

A sixty-seventh aspect of the present disclosure relates to the imaging lens according to the sixty-sixth aspect, in which, in a case in which an open F-number in a state in which the infinite distance object is in focus is denoted by FNo, Conditional Expression (9) is satisfied, which is represented by 0.55<FNo/tan ωm<2 (9).

A sixty-eighth aspect of the present disclosure relates to an imaging apparatus comprising: the imaging lens according to any one of the first to sixty-seventh aspects.

It should be noted that, in the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the shown constituents.

The term “ . . . group having a positive refractive power” in the present specification means that the entire group has a positive refractive power. The term “ . . . group having a negative refractive power” means that the entire group has a negative refractive power. The “focus lens group”, the “first focus lens group”, the “second focus lens group”, and the “single focus lens group” in the present specification are not limited to the configuration consisting of a plurality of lenses, and may consist of only one lens.

A compound aspherical lens (a lens functioning as one aspherical lens as a whole in which a spherical lens and a film of an aspherical shape formed on the spherical lens are formed to be integrated with each other) is not regarded as a cemented lens and is handled as one lens.

Unless otherwise noted, a curvature radius, a sign of a refractive power, and a surface shape related to a lens including an aspherical surface in a paraxial region are used. A sign of the curvature radius is defined such that a sign of the curvature radius of a surface having a convex shape facing the object side is positive, and a sign of the curvature radius of a surface having a convex shape facing the image side is negative.

The term “entire system” in the present specification means the imaging lens. The term “focal length” used in the conditional expressions means a paraxial focal length. Unless otherwise noted, the term “distance on the optical axis” used in the conditional expressions means a geometrical distance. Unless otherwise noted, values used in the conditional expressions are values based on a d line in a state in which the infinite distance object is in focus.

The terms “d line”, “C line”, “F line”, and “g line” described in the present specification mean emission lines, in which a wavelength of the d line is 587.56 nanometers (nm), a wavelength of the C line is 656.27 nanometers (nm), a wavelength of the F line is 486.13 nanometers (nm), and a wavelength of the g line is 435.84 nanometers (nm).

In a case in which refractive indexes with respect to a g line, an F line, and a C line for a lens are denoted by Ng, NF, and NC, respectively, and a partial dispersion ratio between the g line and the F line for the lens is denoted by θgF, θgF is defined as the following expression.

$$θ g F = ( Ng - NF ) / ( NF - NC )$$

According to the present disclosure, it is possible to provide the imaging lens that has a small size and that maintains favorable optical performance, and the imaging apparatus comprising the imaging lens.

### BRIEF DESCRIPTION OF THE DRAWINGS

FIG. 1 is a cross-sectional view showing a configuration of an imaging lens according to an embodiment, which corresponds to an imaging lens according to Example 1.

FIG. 2 is a cross-sectional view showing a configuration and a luminous flux of the imaging lens of FIG. 1.

FIG. 3 is a diagram showing positions of an effective radius and a maximum effective diameter.

FIG. 4 is each aberration diagram of the imaging lens according to Example 1.

FIG. 5 is a cross-sectional view showing a configuration of an imaging lens according to Example 2.

FIG. 6 is each aberration diagram of the imaging lens according to Example 2.

FIG. 7 is a cross-sectional view showing a configuration of an imaging lens according to Example 3.

FIG. 8 is each aberration diagram of the imaging lens according to Example 3.

FIG. 9 is a cross-sectional view showing a configuration of an imaging lens according to Example 4.

FIG. 10 is each aberration diagram of the imaging lens according to Example 4.

FIG. 11 is a cross-sectional view showing a configuration of an imaging lens according to Example 5.

FIG. 12 is each aberration diagram of the imaging lens according to Example 5.

FIG. 13 is a cross-sectional view showing a configuration of an imaging lens according to Example 6.

FIG. 14 is each aberration diagram of the imaging lens according to Example 6.

FIG. 15 is a cross-sectional view showing a configuration of an imaging lens according to Example 7.

FIG. 16 is each aberration diagram of the imaging lens according to Example 7.

FIG. 17 is a cross-sectional view showing a configuration of an imaging lens according to Example 8.

FIG. 18 is each aberration diagram of the imaging lens according to Example 8.

FIG. 19 is a cross-sectional view showing a configuration of an imaging lens according to Example 9.

FIG. 20 is each aberration diagram of the imaging lens according to Example 9.

FIG. 21 is a cross-sectional view showing a configuration of an imaging lens according to Example 10.

FIG. 22 is each aberration diagram of the imaging lens according to Example 10.

FIG. 23 is a cross-sectional view showing a configuration of an imaging lens according to Example 11.

FIG. 24 is each aberration diagram of the imaging lens according to Example 11.

FIG. 25 is a cross-sectional view showing a configuration of an imaging lens according to Example 12.

FIG. 26 is each aberration diagram of the imaging lens according to Example 12.

FIG. 27 is a cross-sectional view showing a configuration of an imaging lens according to Example 13.

FIG. 28 is each aberration diagram of the imaging lens according to Example 13.

FIG. 29 is a cross-sectional view showing a configuration of an imaging lens according to Example 14.

FIG. 30 is each aberration diagram of the imaging lens according to Example 14.

FIG. 31 is a cross-sectional view showing a configuration of an imaging lens according to Example 15.

FIG. 32 is each aberration diagram of the imaging lens according to Example 15.

FIG. 33 is a cross-sectional view showing a configuration of an imaging lens according to Example 16.

FIG. 34 is each aberration diagram of the imaging lens according to Example 16.

FIG. 35 is a cross-sectional view showing a configuration of an imaging lens according to Example 17.

FIG. 36 is each aberration diagram of the imaging lens according to Example 17.

FIG. 37 is a cross-sectional view showing a configuration of an imaging lens according to Example 18.

FIG. 38 is each aberration diagram of the imaging lens according to Example 18.

FIG. 39 is a cross-sectional view showing a configuration of an imaging lens according to Example 19.

FIG. 40 is each aberration diagram of the imaging lens according to Example 19.

FIG. 41 is a cross-sectional view showing a configuration of an imaging lens according to Example 20.

FIG. 42 is each aberration diagram of the imaging lens according to Example 20.

FIG. 43 is a cross-sectional view showing a configuration of an imaging lens according to Example 21.

FIG. 44 is each aberration diagram of the imaging lens according to Example 21.

FIG. 45 is a perspective view showing a front side of an imaging apparatus according to an embodiment.

FIG. 46 is a perspective view showing a front side of the imaging apparatus according to the embodiment.

### DETAILED DESCRIPTION

Hereinafter, embodiments of the present disclosure will be described with reference to the drawings.

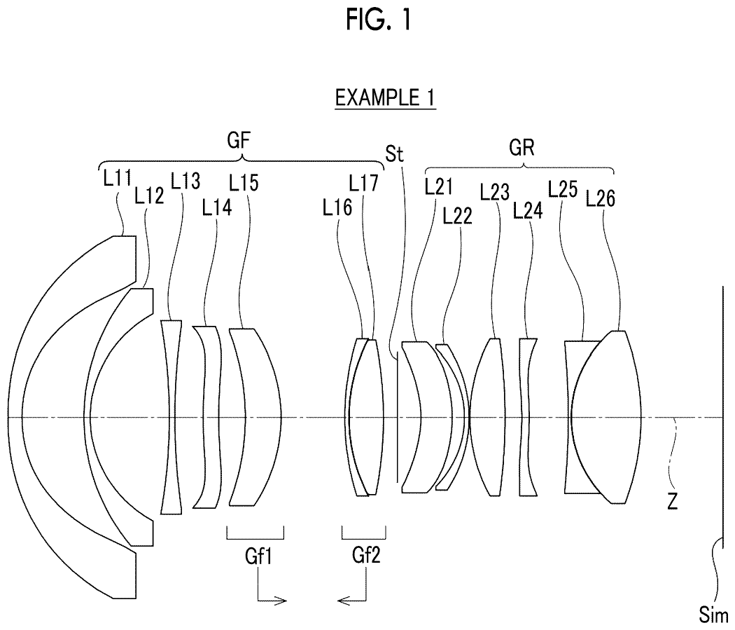

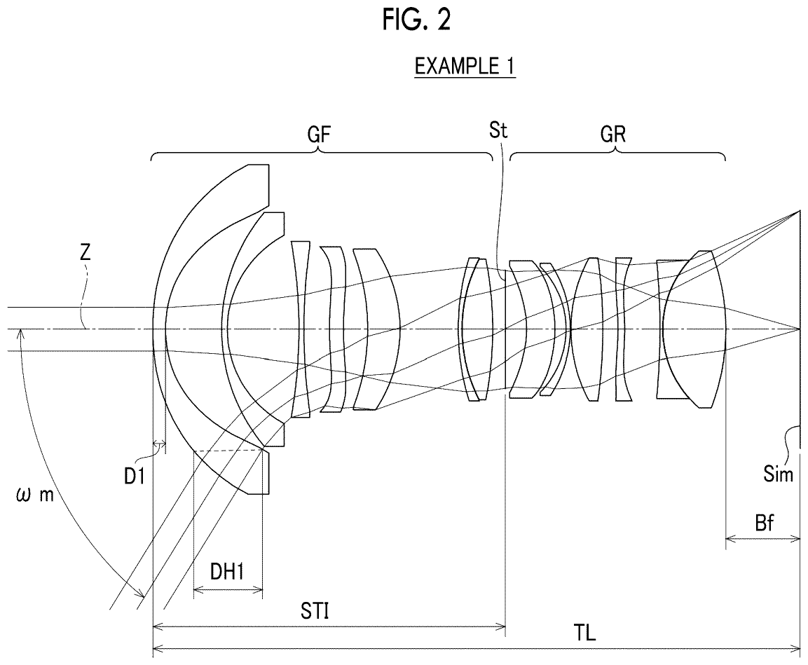

FIG. 1 shows a cross-sectional view of a configuration of an imaging lens according to the embodiment of the present disclosure. FIG. 2 is a cross-sectional view of a configuration and a luminous flux of the imaging lens in FIG. 1. FIG. 2 shows, as the luminous flux, an on-axis luminous flux and a luminous flux of a maximum half angle of view ωm. FIGS. 1 and 2 show a state in which a left side is the object side, a right side is the image side, and the infinite distance object is in focus. In the present specification, an object at an infinite distance will be referred to as an infinite distance object. The examples shown in FIGS. 1 and 2 correspond to an imaging lens according to Example 1 described later. Hereinafter, the description will be made mainly with reference to FIG. 1.

The imaging lens according to the present disclosure consists of, along an optical axis Z, in order from the object side to the image side, a front group GF, an aperture stop St, and a rear group GR. The front group GF includes, in successive order from a side closest to the object side to the image side, a first lens that is a negative lens having a concave surface facing the image side and a second lens that is a negative lens having a concave surface facing the image side. The front group GF having the above-described configuration serves as a wide converter, and by sharing a negative refractive power on the object side between the first lens and the second lens, there is an advantage in correcting various aberrations such as distortion and field curvature. Further, by disposing the first lens and the second lens as described above, there is an advantage in suppressing various aberrations while ensuring an angle of view.

As an example, each group of the imaging lens in FIG. 1 is formed as follows. The front group GF consists of seven lenses of the lenses L11 to L17 in order from the object side to the image side. The rear group GR consists of six lenses of the lenses L21 to L26 in order from the object side to the image side. In the example in FIG. 1, the lens L11 corresponds to the first lens, and the lens L12 corresponds to the second lens. The aperture stop St in FIG. 1 does not indicate a size and a shape, and indicates a position in an optical axis direction. This showing method of the aperture stop St also applies to other cross-sectional views in the same manner.

In the imaging lens according to the present disclosure, two or less focus lens groups are disposed on the image side with respect to the second lens. During focusing, two or less focus lens groups move along the optical axis Z, and lenses other than the two or less focus lens groups are fixed with respect to the image plane Sim. By moving the lens group to the image side with respect to the second lens during focusing, it is possible to suppress a fluctuation in the angle of view during focusing.

As an example, the imaging lens of FIG. 1 comprises two focus lens groups. By comprising two focus lens groups, the movement amount of each focus lens group can be suppressed, and thus there is an advantage in high-speed focusing.

Hereinafter, in the configuration in which the imaging lens comprises two focus lens groups, among the two focus lens groups, the focus lens group on the object side will be referred to as a first focus lens group Gf1, and the focus lens group on the image side will be referred to as a second focus lens group Gf2. During focusing, the first focus lens group Gf1 and the second focus lens group Gf2 move by different movement amounts. By moving the two focus lens groups by different movement amounts, it is possible to satisfactorily suppress the aberration fluctuation caused by the fluctuation in the imaging distance.

As an example, in the imaging lens of FIG. 1, the first focus lens group Gf1 consists of the lens L15, and the second focus lens group Gf2 consists of the lens L16 and the lens L17. In FIG. 1, an arrow indicates a direction in which each focus lens group moves during focusing on the closest object from the infinite distance object. In the example of FIG. 1, during focusing from the infinite distance object to the closest object, the first focus lens group Gf1 moves to the image side, and the second focus lens group Gf2 moves to the object side.

In the imaging lens according to the present disclosure, a positive lens may be disposed on a side of the front group GF closest to the image side. In a case in which such a configuration is adopted, there is an advantage in the spherical aberration correction. Hereinafter, for convenience of description, the positive lens disposed on a side of the front group GF closest to the image side will be referred to as an LFe lens. It is preferable that the LFe lens is a biconvex lens.

In a case in which such a configuration is adopted, there is an advantage in the spherical aberration correction. In the example of FIG. 1, the lens L17 corresponds to the LFe lens.

The rear group GR may include a cemented lens in which a positive lens having a convex surface facing the object side and a negative lens are cemented in order from the object side. In a case in which such a configuration is adopted, there is an advantage in the chromatic aberration correction.

The lens of the rear group GR closest to the image side may be configured to be a positive lens. In such a case, it is possible to suppress an increase in an incidence angle of an off-axis principal ray on the image plane Sim, and thus there is an advantage in ensuring the quantity of peripheral light.

Hereinafter, preferred configurations of the imaging lens according to the present disclosure related to conditional expressions will be described. In the following description of the conditional expressions, in order to avoid redundancy, the same symbol will be used for the same definition, and the duplicate description of the symbol will be omitted. Hereinafter, the “imaging lens according to the present disclosure” will be simply referred to as the “imaging lens” in order to avoid redundancy.

It is preferable that the imaging lens satisfies Conditional Expression (1). Here, back focus of the entire system as an air conversion distance in a state in which the infinite distance object is in focus is denoted by Bf. A focal length of the entire system in a state in which the infinite distance object is in focus is denoted by f. A maximum half angle of view in a state in which the infinite distance object is in focus is denoted by ωm. The back focus Bf at the air conversion distance is an air conversion distance on the optical axis from the lens surface of the imaging lens closest to the image side to the image plane Sim. As an example, the back focus Bf is shown in FIG. 2. Here, tan indicates a tangent. By not allowing the corresponding values in Conditional Expression (1) to be equal to or less than the lower limit thereof, it is possible to suppress the increase in the diameter of the lens of the imaging lens closest to the image side. By not allowing the corresponding values in Conditional Expression (1) to be equal to or greater than the upper limit thereof, there is an advantage in achieving the reduction in the total length of the optical system.

$$0.3 < Bf / ( f \times tan ω m ) < 1.5 \qquad ( 1 )$$

In order to obtain more favorable characteristics, it is preferable to set the lower limit of Conditional Expression (1) to any of 0.35, 0.4, 0.43, or 0.45, instead of 0.3. In addition, it is preferable to set the upper limit of Conditional Expression (1) to any of 1.3, 1.2, 1.1, or 1, instead of 1.5. For example, it is more preferable that the imaging lens satisfies Conditional Expression (1-1).

$$0.43 < Bf / ( f \times tan ω m ) < 1.1 \qquad ( 1 - 1 )$$

It is preferable that the imaging lens satisfies Conditional Expression (2). Here, a distance on the optical axis from the lens surface of the imaging lens closest to the object side to the aperture stop St in a state in which the infinite distance object is in focus is denoted by STI. A sum of the back focus Bf of the entire system at the air conversion distance and the distance on the optical axis from the lens surface of the imaging lens closest to the object side to the lens surface of the imaging lens closest to the image side, in a state in which the infinite distance object is in focus, is denoted by TL. TL is a lens system total length. As an example, FIG. 2 shows the distance STI and the lens system total length TL. By not allowing the corresponding values in Conditional Expression (2) to be equal to or less than the lower limit thereof, a more sufficient object side space than the aperture stop St can be ensured, so that the imaging lens can be configured without forcibly reducing an absolute value of the curvature radius of the lens by disposing an appropriate number of lenses. As a result, suitable correction of various aberrations is facilitated. By not allowing the corresponding values in Conditional Expression (2) to be equal to or greater than the upper limit thereof, it is possible to prevent the position of the aperture stop St from being excessively close to the image plane Sim, so that it is possible to prevent the incidence angle of the off-axis principal ray, which is incident to the imaging element disposed on the image plane Sim in the imaging apparatus, from becoming excessively large.

$$0.3 < STI / TL < 0 \text{.75} \qquad ( 2 )$$

In order to obtain more favorable characteristics, it is preferable to set the lower limit of Conditional Expression (2) to 0.35 or 0.4, instead of 0.3. In addition, it is preferable to set the upper limit of Conditional Expression (2) to 0.7 or 0.65, instead of 0.75.

It is preferable that the imaging lens satisfies Conditional Expression (3). Here, a focal length of the front group GF in a state in which the infinite distance object is in focus is denoted by fF. A focal length of the rear group GR in a state in which the infinite distance object is in focus is denoted by fR. Conditional Expression (3) is an expression for appropriately setting a ratio between a refractive power of the front group GF and a refractive power of the rear group GR. The front group GF serves as the wide converter that increases the angle of view while sufficiently ensuring the back focus in the entire optical system. By not allowing the corresponding values in Conditional Expression (3) to be equal to or less than the lower limit thereof, it is possible to suppress various aberrations such as the spherical aberration. By not allowing the corresponding values in Conditional Expression (3) to be equal to or greater than the upper limit thereof, there is an advantage in achieving a wide angle of view.

$$- 2 < fR / fF < 4 \qquad ( 3 )$$

In order to obtain more favorable characteristics, it is preferable to set the lower limit of Conditional Expression (3) to any of −1.5, −1, or −0.7, instead of −2. In addition, it is preferable to set the upper limit of Conditional Expression (3) to any of 3.5, 3, or 2.5, instead of 4.

In a case in which a paraxial curvature radius of an object side surface of the first lens is denoted by RL1f, it is preferable that the imaging lens satisfies Conditional Expression (4). By not allowing the corresponding values in Conditional Expression (4) to be equal to or less than the lower limit thereof, there is an advantage in achieving correcting a distortion. By not allowing the corresponding values in Conditional Expression (4) to be equal to or greater than the upper limit thereof, there is an advantage in correcting astigmatism.

$$- 0.3 < f / RL 1 f < 8 \qquad ( 4 )$$

In order to obtain more favorable characteristics, it is preferable to set the lower limit of Conditional Expression (4) to any of −0.2, −0.1, or 0, instead of −0.3. In addition, it is preferable to set the upper limit of Conditional Expression (4) to any of 4, 1, or 0.4, instead of 8.

In a case in which a paraxial curvature radius of an image side surface of the first lens is denoted by RL1r, it is preferable that the imaging lens satisfies Conditional Expression (5). By not allowing the corresponding values in Conditional Expression (5) to be equal to or less than the lower limit thereof, there is an advantage in achieving correcting a distortion. By not allowing the corresponding values Conditional Expression (5) to be equal to or greater than the upper limit thereof, there is an advantage in correcting astigmatism.

$$0 < f / RL 1 r < 4 \qquad ( 5 )$$

In order to obtain more favorable characteristics, it is preferable to set the lower limit of Conditional Expression (5) to any of 0.15, 0.25, 0.35, or 0.4, instead of 0. In addition, it is preferable to set the upper limit of Conditional Expression (5) to any of 3, 2, 1.4, or 0.95, instead of 4.

It is preferable that the imaging lens satisfies Conditional Expression (6). By not allowing the corresponding values in Conditional Expression (6) to be equal to or less than the lower limit thereof, it is possible to prevent the negative refractive power of the front group GF from being excessively strong, so that there is an advantage in achieving reducing the total optical length. By not allowing the corresponding values in Conditional Expression (6) to be equal to or greater than the upper limit thereof, it is possible to prevent the strong positive refractive power of the front group GF from being excessively strong, so that there is an advantage in correcting the distortion and the field curvature.

$$- 1 < f / fF < 2 \qquad ( 6 )$$

In order to obtain more favorable characteristics, it is preferable to set the lower limit of Conditional Expression (6) to any of −0.8, −0.6, or −0.4, instead of −1. In addition, it is preferable to set the upper limit of Conditional Expression (6) to any of 1.3, 0.7, or 0.18, instead of 2.

In a case in which a maximum imaging magnification of the imaging lens is denoted by β, it is preferable that the imaging lens satisfies Conditional Expression (7). It should be noted that, in the present specification, the imaging magnification in a state in which the closest object is in focus will be referred to as the maximum imaging magnification. By not allowing the corresponding values in Conditional Expression (7) to be equal to or less than the lower limit thereof, it is possible to suppress the narrowing of the range of the imaging distance at which the imaging can be performed, so that it is possible to secure the added value suitable as the imaging lens.

By not allowing the corresponding values in Conditional Expression (7) to be equal to or greater than the upper limit thereof, it is possible to suppress the movement amount of the focus lens group during focusing, so that it is possible to contribute to the reduction in the size of the optical system.

$$0.06 < \vert β \vert < 0.5 \qquad ( 7 )$$

In order to obtain more favorable characteristics, it is preferable to set the lower limit of Conditional Expression (7) to 0.07 or 0.08, instead of 0.06. In addition, it is preferable to set the upper limit of Conditional Expression (7) to 0.35 or 0.21, instead of 0.5.

It is preferable that the imaging lens satisfies Conditional Expression (8). By not allowing the corresponding values in Conditional Expression (8) to be equal to or less than the lower limit thereof, there is an advantage in maintaining high optical performance. By not allowing the corresponding values in Conditional Expression (8) to be equal to or greater than the upper limit thereof, there is an advantage in achieving the reduction in the size of the optical system.

$$3 < TL / ( f \times tan ω m ) < 7 \qquad ( 8 )$$

In order to obtain more favorable characteristics, it is preferable to set the lower limit of Conditional Expression (8) to any of 3.2, 3.4, 3.5, 3.7, or 3.9, instead of 3. In addition, it is preferable to set the upper limit of Conditional Expression (8) to any of 6.5, 5.9, 5.65, 5.3, or 4.9, instead of 7. For example, it is more preferable that the imaging lens satisfies Conditional Expression (8-1) to be described later, it is still more preferable that the imaging lens satisfies Conditional Expression (8-2) to be described later, and it is still more preferable that the imaging lens satisfies Conditional Expression (8-3) to be described later.

$$3.2 < TL / ( f \times tan ω m ) < 6.5 \qquad ( 8 - 1 )$$

$$3.4 < TL / ( f \times tan ω m ) < 5.9 \qquad ( 8 - 2 )$$

$$3.5 < TL / ( f \times tan ω m ) < 5 \text{.65} \qquad ( 8 - 3 )$$

In a case in which an open F-number in a state in which the infinite distance object is in focus is denoted by FNo, it is preferable that the imaging lens satisfies Conditional Expression (9). By not allowing the corresponding values in Conditional Expression (9) to be equal to or less than the lower limit thereof, it is easy to suppress an increase in number of lenses and suppress an increase in size of the optical system while obtaining favorable optical performance. By not allowing the corresponding values in Conditional Expression (9) to be equal to or greater than the upper limit thereof, the angle of view can be widened, or the open F-number can be reduced, so that the imaging lens can be used for a wide range of applications, and can be made as a high value imaging lens.

$$0.55 < FNo / tan ω m < 2 \qquad ( 9 )$$

In order to obtain more favorable characteristics, it is preferable to set the lower limit of Conditional Expression (9) to any of 0.58, 0.6, 0.62, 0.64, 0.66, 0.68, or 0.7, instead of 0.55. In addition, it is preferable to set the upper limit of Conditional Expression (9) to any of 1.9, 1.8, 1.7, 1.62, 1.55, 1.45, or 1.35, instead of 2. For example, it is more preferable that the imaging lens satisfies Conditional Expression (9-1) to be described later, it is still more preferable that the imaging lens satisfies Conditional Expression (9-2) to be described later, and it is still more preferable that the imaging lens satisfies Conditional Expression (9-3) to be described later.

$$0.65 < FNo / tan ω m < 1 \text{.62} \qquad ( 9 - 1 )$$

$$0.66 < FNo / tan ω m < 1 \text{.55} \qquad ( 9 - 2 )$$

$$0.7 < FNo / tan ω m < 1 \text{.35} \qquad ( 9 - 3 )$$

In a case in which an Abbe number of the first lens based on a d line is denoted by νL1, it is preferable that the imaging lens satisfies Conditional Expression (10). By not allowing the corresponding values in Conditional Expression (10) to be equal to or less than the lower limit thereof, it is possible to prevent the Abbe number of the first lens, which is a negative lens, from being excessively decreased, so that there is an advantage in satisfactorily correcting the lateral chromatic aberration. In general, in a case in which the Abbe number of the optical material increases, the refractive index tends to decrease.

By not allowing the corresponding values in Conditional Expression (10) to be equal to or greater than the upper limit thereof, it is possible to prevent the Abbe number of the first lens, which is a negative lens, from being excessively increased, so that the refractive index of the first lens is not excessively decreased. Therefore, there is an advantage in satisfactorily correcting distortion and field curvature.

$$20 < v L 1 < 95 \qquad ( 10 )$$

In order to obtain more favorable characteristics, it is preferable to set the lower limit of Conditional Expression (10) to any of 21, 22, 23, 24, 26, 28, 30, 31, or 32, instead of 20. In addition, it is preferable to set the upper limit of Conditional Expression (10) to any of 83, 75, 69, 64, 62, 59, 56, 52, or 48, instead of 95. For example, it is more preferable that the imaging lens satisfies Conditional Expression (10-1), and it is still more preferable that the imaging lens satisfies Conditional Expression (10-2).

$$28 < v L 1 < 59 \qquad ( 10 - 1 )$$

$$32 < vL 1 < 48 \qquad ( 10 - 2 )$$

In the configuration in which the imaging lens comprises two focus lens groups, it is preferable that the imaging lens satisfies Conditional Expression (16). Here, a focal length of the first focus lens group Gf1 is denoted by ff1. A focal length of the second focus lens group Gf2 is denoted by ff2. By not allowing the corresponding values in Conditional Expression (16) to be equal to or less than the lower limit thereof, it is possible to prevent the refractive power of the first focus lens group Gf1 from being excessively increased, so that it is easy to correct the astigmatism. By not allowing the corresponding values in Conditional Expression (16) to be equal to or greater than the upper limit thereof, it is possible to prevent the refractive power of the first focus lens group Gf1 from being excessively decreased, so that it is easy to correct field curvature.

$$0.2 < \vert ff 1 / ff 2 \vert < 5 \qquad ( 16 )$$

In order to obtain more favorable characteristics, it is preferable to set the lower limit of Conditional Expression (16) to 0.6 or 1, instead of 0.2. In addition, it is preferable to set the upper limit of Conditional Expression (16) to 3.5 or 2.5, instead of 5.

In the configuration in which the imaging lens comprises two focus lens groups, it is preferable that the imaging lens satisfies Conditional Expression (17). Here, a lateral magnification of the first focus lens group Gf1 in a state in which the infinite distance object is in focus is denoted by βf1. A lateral magnification of the second focus lens group Gf2 in a state in which the infinite distance object is in focus is denoted by βf2. By not allowing the corresponding values in Conditional Expression (17) to be equal to or less than the lower limit thereof, it is easy to correct the astigmatism in a case in which the closest object is in focus. By not allowing the corresponding values in Conditional Expression (17) to be equal to or greater than the upper limit thereof, it is easy to correct the field curvature in a case in which the closest object is in focus.

$$0 < \vert β f 1 / β f 2 \vert < 0.6 \qquad ( 17 )$$

In order to obtain more favorable characteristics, it is preferable to set the lower limit of Conditional Expression (17) to 0.02 or 0.04, instead of 0. In addition, it is preferable to set the upper limit of Conditional Expression (17) to 0.5 or 0.4, instead of 0.6.

In the configuration in which the imaging lens comprises two focus lens groups, it is preferable that the imaging lens satisfies Conditional Expression (18). By not allowing the corresponding values in Conditional Expression (18) to be equal to or less than the lower limit thereof, it is easy to correct the spherical aberration and the axial chromatic aberration. By not allowing the corresponding values in Conditional Expression (18) to be equal to or greater than the upper limit thereof, it is easy to correct the astigmatism, and the movement amount of the first focus lens group Gf1 from a state in which the infinite distance object is in focus to a state in which the closest object is in focus can be suppressed, so that there is an advantage in achieving the reduction in the size.

$$0 < {\{ β f 1 + ( 1 / β f 1 ) \}}^{- 2} < 0.25 \qquad ( 18 )$$

In order to obtain more favorable characteristics, it is preferable to set the lower limit of Conditional Expression (18) to 0.05 or 0.1, instead of 0.

In addition, it is preferable to set the upper limit of Conditional Expression (18) to 0.23 or 0.22, instead of 0.25.

In the configuration in which the imaging lens comprises two focus lens groups, it is preferable that the imaging lens satisfies Conditional Expression (19). By not allowing the corresponding values in Conditional Expression (19) to be equal to or less than the lower limit thereof, it is easy to correct field curvature and astigmatism. By not allowing the corresponding values in Conditional Expression (19) to be equal to or greater than the upper limit thereof, it is easy to correct the astigmatism, and the movement amount of the second focus lens group Gf2 from a state in which the infinite distance object is in focus to a state in which the closest object is in focus can be suppressed, so that there is an advantage in achieving the reduction in the size.

$$0 < {\{ β f 2 + ( 1 / β f 2 ) \}}^{- 2} < 0.25 \qquad ( 19 )$$

In order to obtain more favorable characteristics, it is preferable to set the lower limit of Conditional Expression (19) to 0.05 or 0.1, instead of 0. In addition, it is preferable to set the upper limit of Conditional Expression (19) to 0.24 or 0.22, instead of 0.25.

In the configuration in which the imaging lens comprises two focus lens groups, in a case in which a combined focal length of all lenses on the image side with respect to the second focus lens group Gf2 is denoted by f2r, it is preferable that the imaging lens satisfies Conditional Expression (20). By not allowing the corresponding values in Conditional Expression (20) to be equal to or less than the lower limit thereof, it is possible to prevent the combined refractive power of all lenses on the image side with respect to the second focus lens group Gf2 from being excessively decreased, so that there is an advantage in correcting the lateral chromatic aberration. By not allowing the corresponding values in Conditional Expression (20) to be equal to or greater than the upper limit thereof, it is possible to prevent the combined refractive power of all lenses on the image side with respect to the second focus lens group Gf2 from being excessively increased, so that there is an advantage in correcting distortion and field curvature.

$$0.1 < f / f 2 r < 2 \qquad ( 20 )$$

In order to obtain more favorable characteristics, it is preferable to set the lower limit of Conditional Expression (20) to any of 0.15, 0.2, or 0.25, instead of 0.1. In addition, it is preferable to set the upper limit of Conditional Expression (20) to any of 1.5, 1, or 0.8, instead of 2.

In a configuration in which the imaging lens comprises two focus lens groups, in a case in which a combined focal length of all lenses on the object side with respect to the first focus lens group Gf1 is denoted by f1f, it is preferable that the imaging lens satisfies Conditional Expression (21). By not allowing the corresponding values in Conditional Expression (21) to be equal to or less than the lower limit thereof, it is possible to prevent the negative combined refractive power of all lenses on the object side with respect to the first focus lens group Gf1 from being excessively increased, so that there is an advantage in shortening the total length of the optical system, and it is easy to ensure the quantity of peripheral light. By not allowing the corresponding values in Conditional Expression (21) to be equal to or greater than the upper limit thereof, it is possible to prevent the positive combined refractive power of all lenses on the object side with respect to the first focus lens group Gf1 from being excessively increased, so that there is an advantage in correcting distortion and field curvature.

$$- 3 < f / f 1 f < 2 \qquad ( 21 )$$

In order to obtain more favorable characteristics, it is preferable to set the lower limit of Conditional Expression (21) to any of −2.5, −2, or −1.5, instead of −3. In addition, it is preferable to set the upper limit of Conditional Expression (21) to any of 1.5, 1, or 0.75, instead of 2.

In a case in which a focal length of the first lens is denoted by fL1 and a focal length of the second lens is denoted by fL2, it is preferable that the imaging lens satisfies Conditional Expression (22). The front group GF serves as the wide converter, and there is an advantage in correcting various aberrations such as distortion and field curvature by sharing the role between a negative refractive power on the object side between the first lens and the second lens. Since both the first lens and the second lens are negative lenses, regarding the lower limit of Conditional Expression (22), 0<fL1/fL2 is satisfied. By not allowing the corresponding values in Conditional Expression (22) to be equal to or greater than the upper limit thereof, the negative refractive power of the first lens can be prevented from being excessively weakened, so that it is easy to satisfactorily correct the lateral chromatic aberration by the first lens.

$$0 < fL 1 / fL 2 < 5.5 \qquad ( 22 )$$

In order to obtain more favorable characteristics, it is preferable to set the lower limit of Conditional Expression (22) to 0.1, instead of 0. In such a case, the negative refractive power of the second lens is not excessively weakened, so that there is an advantage in correcting distortion and field curvature. In order to obtain more favorable characteristics, it is preferable to set the lower limit of Conditional Expression (22) to 0.2 or 0.3, instead of 0. In addition, in order to obtain more favorable characteristics, it is preferable to set the upper limit of Conditional Expression (22) to any of 4, 2.5, or 1.5, instead of 5.5.

It is preferable that the imaging lens satisfies Conditional Expression (23). As described above, the first lens is a lens sharing the role of the wide converter. Conditional Expression (23) defines a preferable range for performing favorable aberration correction while increasing the angle of view of this first lens. By not allowing the corresponding values in Conditional Expression (23) to be equal to or less than the lower limit thereof, the negative refractive power of the first lens with respect to the refractive power of the entire system can be prevented from becoming excessively weak, so that, in the front group GF that serves as the wide converter, the first lens and the second lens can suitably share the negative refractive power. Therefore, there is an advantage in correcting various aberrations such as distortion and field curvature. By not allowing the corresponding values in Conditional Expression (23) to be equal to or greater than the upper limit thereof, the refractive power of the first lens can be prevented from being excessively strong with respect to the refractive power of the entire system, so that it is easy to satisfactorily correct the lateral chromatic aberration by the first lens.

$$- 8 < fL 1 / f < - 0.5 \qquad ( 23 )$$

In order to obtain more favorable characteristics, it is preferable to set the lower limit of Conditional Expression (23) to any of −7, −6, or −5, instead of −8. In addition, it is preferable to set the upper limit of Conditional Expression (23) to any of −1, −1.3, or −1.5, instead of −0.5.

It is preferable that the imaging lens satisfies Conditional Expression (24). Here, a paraxial curvature radius of the object side surface of the first lens is denoted by RL1f. A paraxial curvature radius of an image side surface of the FIRST lens is denoted by RL1r. Conditional Expression (24) defines a shape factor of the first lens. By not allowing the corresponding values in Conditional Expression (24) to be equal to or less than the lower limit thereof, it is easy to satisfactorily correct astigmatism. By not allowing the corresponding values in Conditional Expression (24) to be equal to or greater than the upper limit thereof, it is easy to satisfactorily correct the spherical aberration. By not allowing the corresponding values in Conditional Expression (24) to be equal to or greater than the upper limit thereof, the refractive power of the lens can be prevented from being excessively weakened, so that it is easy to achieve an increase in angle of view.

$$- 2.5 < ( RL 1 r - RL 1 f ) / ( RL 1 r + RL 1 f ) < - 0.1 \qquad ( 24 )$$

In order to obtain more favorable characteristics, it is preferable to set the lower limit of Conditional Expression (24) to −2 or −1.5, instead of −2.5. In addition, it is preferable to set the upper limit of Conditional Expression (24) to −0.2 or −0.3, instead of −0.1.

It is preferable that the imaging lens satisfies Conditional Expression (25). Here, a paraxial curvature radius of the object side surface of the second lens is denoted by RL2f. A paraxial curvature radius of an image side surface of the second lens is denoted by RL2r. Conditional Expression (25) defines a shape factor of the second lens. By not allowing the corresponding values in Conditional Expression (25) to be equal to or less than the lower limit thereof, it is easy to satisfactorily correct astigmatism. By not allowing the corresponding values in Conditional Expression (25) to be equal to or greater than the upper limit thereof, it is easy to satisfactorily correct the spherical aberration. By not allowing the corresponding values in Conditional Expression (25) to be equal to or greater than the upper limit thereof, the refractive power of the lens can be prevented from being excessively weakened, so that it is easy to achieve an increase in angle of view.

$$- 1.5 < ( RL 2 r - RL 2 f ) / ( RL 2 r + RL 2 f ) < - 0.05 \qquad ( 25 )$$

In order to obtain more favorable characteristics, it is preferable to set the lower limit of Conditional Expression (25) to −1 or −0.7, instead of −1.5. In addition, it is preferable to set the upper limit of Conditional Expression (25) to −0.09 or −0.15, instead of −0.05.

In the imaging lens according to the present disclosure, a third lens that is a negative lens may be disposed adjacent to the image side of the second lens, and a fourth lens that is a positive lens may be disposed adjacent to the image side of the third lens. In the configuration in which the imaging lens includes the third lens and the fourth lens, in a case in which a focal length of the third lens is denoted by fL3 and a focal length of the fourth lens is denoted by fL4, it is preferable that the imaging lens satisfies Conditional Expression (26). By not allowing the corresponding values in Conditional Expression (26) to be equal to or less than the lower limit thereof, the negative refractive power of the third lens can be prevented from being excessively decreased, so that it is easy to correct various aberrations such as distortion and field curvature. Since the signs of the refractive powers of the third lens and the fourth lens are positive, regarding the upper limit of Conditional Expression (26), fL3/fL4<0 is satisfied.

$$- 8 < fL 3 / fL 4 < 0 \qquad ( 26 )$$

In order to obtain more favorable characteristics, it is preferable to set the lower limit of Conditional Expression (26) to −5.5 or −3.5, instead of −8. In addition, it is preferable to set the upper limit of Conditional Expression (26) to −0.03, instead of 0. In such a case, since the positive refractive power of the fourth lens can be prevented from being excessively weakened, it is easy to correct the spherical aberration. In order to obtain more favorable characteristics, it is preferable to set the upper limit of Conditional Expression (26) to −0.1 or −0.15, instead of 0.

It is preferable that the imaging lens satisfies Conditional Expression (27). Here, a paraxial curvature radius of the object side surface of the lens of the imaging lens closest to the image side is denoted by RLef. A paraxial curvature radius of an image side surface of a lens of the imaging lens closest to the image side is denoted by RLer. By not allowing the corresponding values in Conditional Expression (27) to be equal to or less than the lower limit thereof, it is easy to shorten the back focus, so that there is an advantage in achieving the reduction in the size of the optical system. By not allowing the corresponding values in Conditional Expression (27) to be equal to or greater than the upper limit thereof, it is easy to satisfactorily correct various aberrations such as field curvature.

$$0.4 < ( RLer - RLef ) / ( RLer + RLef ) < 5.5 \qquad ( 27 )$$

In order to obtain more favorable characteristics, it is preferable to set the lower limit of Conditional Expression (27) to 0.5 or 0.6, instead of 0.4. In addition, it is preferable to set the upper limit of Conditional Expression (27) to 4.2 or 3.3, instead of 5.5.

At least one of the object side surface or the image side surface of the first lens may be formed to be an aspherical surface. In the configuration in which at least one of the object side surface or the image side surface of the first lens is the aspherical surface, it is preferable that the imaging lens satisfies Conditional Expression (28). Here, a paraxial curvature radius of the object side surface of the first lens is denoted by RL1f. A paraxial curvature radius of an image side surface of the FIRST lens is denoted by RL1r. A curvature radius of the object side surface of the first lens at the position of the maximum effective diameter is denoted by RyL1f. A curvature radius of the image side surface of the first lens at the position of the maximum effective diameter is denoted by RyL1r. By not allowing the corresponding values in Conditional Expression (28) to be equal to or less than the lower limit thereof, the refractive power on the peripheral side of the lens can be prevented from being excessively strong, so that it is possible to suppress excessive correction of the field curvature. By not allowing the corresponding values in Conditional Expression (28) to be equal to or greater than the upper limit thereof, it is possible to prevent the refractive power on the peripheral side of the lens from being excessively decreased, so that there is an advantage in correcting field curvature.

$$0.5 < ( 1 / RL 1 f - 1 / RL 1 r ) / ( 1 / RyL 1 f - 1 / RyL 1 r ) < 7 \qquad ( 28 )$$

In order to obtain more favorable characteristics, it is preferable to set the lower limit of Conditional Expression (28) to any of 0.7, 0.9, or 1.1, instead of 0.5. In addition, it is preferable to set the upper limit of Conditional Expression (28) to any of 5.7, 4.5, or 3.5, instead of 7.

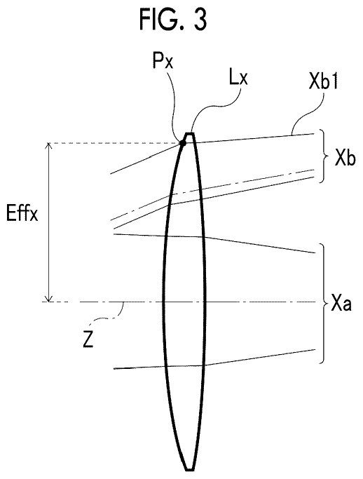

FIG. 3 shows an example of a position Px of the maximum effective diameter as a diagram for description. In FIG. 3, a left side is the object side, and a right side is the image side. In FIG. 3, an on-axis luminous flux Xa and an off-axis luminous flux Xb that pass through a lens Lx are shown. In the example in FIG. 3, a ray Xb1 that is an upper ray in the off-axis luminous flux Xb is a ray passing through an outermost side. In the present specification, a distance to the optical axis Z from an intersection between the lens surface and the ray passing through the outermost side among rays incident to the lens surface from the object side and emitted to the image side is defined as an “effective radius” of the lens surface. The term “outer side” herein means an outer side in a diameter direction centered on the optical axis Z, that is, a side away from the optical axis Z. In the example of FIG. 3, a distance from the intersection point between the ray Xb1 and the object side surface of the lens Lx to the optical axis Z is defined as an effective radius Effx of the object side surface of the lens Lx. A position of the intersection between the ray passing through the outermost side and the lens surface is the position Px of the maximum effective diameter. It should be noted that, while the upper ray of the off-axis luminous flux Xb is the ray passing through the outermost side in the example in FIG. 3, which ray is the ray passing through the outermost side varies depending on the optical system.

The front group GF may include at least one positive lens. In the configuration in which the front group GF includes at least one positive lens, it is preferable that the imaging lens satisfies Conditional Expression (29). Here, a focal length of a positive lens having a strongest refractive power among the positive lenses included in the front group GF is denoted by fFp. By not allowing the corresponding values in Conditional Expression (29) to be equal to or less than the lower limit thereof, it is easy to shorten the flange back and reduce the size. By not allowing the corresponding values in Conditional Expression (28) to be equal to or greater than the upper limit thereof, the refractive power of the positive lens in the front group GF can be prevented from being excessively strong, so that it is easy to correct various aberrations such as the spherical aberration.

$$0.1 < f / fFp < 3 \qquad ( 29 )$$

In order to obtain more favorable characteristics, it is preferable to set the lower limit of Conditional Expression (29) to 0.2 or 0.3, instead of 0.1. In addition, it is preferable to set the upper limit of Conditional Expression (29) to 2 or 1.5, instead of 3.

The rear group GR may include at least one positive lens. In the configuration in which the rear group GR includes at least one positive lens, it is preferable that the imaging lens satisfies Conditional Expression (30). Here, a focal length of a positive lens having the strongest refractive power among the positive lenses included in the rear group GR is denoted by fRp. By not allowing the corresponding values in Conditional Expression (30) to be equal to or less than the lower limit thereof, the refractive power of the positive lens in the rear group GR can be prevented from being excessively decreased, so that it is easy to correct various aberrations such as the spherical aberration. By not allowing the corresponding values in Conditional Expression (30) to be equal to or greater than the upper limit thereof, it is easy to shorten the flange back and to reduce the size.

$$0.3 < fR / fRp < 5 \qquad ( 30 )$$

In order to obtain more favorable characteristics, it is preferable to set the lower limit of Conditional Expression (30) to 0.6 or 0.8, instead of 0.3. In addition, it is preferable to set the upper limit of Conditional Expression (30) to 4 or 3.2, instead of 5.

In the configuration in which the rear group GR includes the cemented lens in which the positive lens having a convex surface facing the object side and the negative lens are cemented in order from the object side, it is preferable that the imaging lens satisfies Conditional Expression (31). Here, an Abbe number of the positive lens of the cemented lens of the rear group GR based on the d line is denoted by νRp. An Abbe number of the negative lens of the cemented lens in the rear group GR based on the d line is denoted by νRn. By not allowing the corresponding values in Conditional Expression (31) to be equal to or less than the lower limit thereof, it is easy to correct the lateral chromatic aberration. By not allowing the corresponding values in Conditional Expression (31) to be equal to or greater than the upper limit thereof, it is possible to suppress the overcorrection of the axial chromatic aberration.

$$10 < vRp - vRn < 75 \qquad ( 31 )$$

In order to obtain more favorable characteristics, it is preferable to set the lower limit of Conditional Expression (31) to 20 or 25, instead of 10.

In addition, it is preferable to set the upper limit of Conditional Expression (31) to 70 or 68, instead of 75.

In the configuration in which the rear group GR includes the cemented lens in which the positive lens having a convex surface facing the object side and the negative lens are cemented in order from the object side, it is preferable that the imaging lens satisfies Conditional Expression (32). Here, a refractive index of the positive lens of the cemented lens of the rear group GR at the d line is denoted by NRp. A refractive index of the negative lens of the cemented lens in the rear group GR based on the d line is denoted by NRn. By not allowing the corresponding values in Conditional Expression (32) to be equal to or less than the lower limit thereof, it is easy to correct the lateral chromatic aberration. By not allowing the corresponding values in Conditional Expression (32) to be equal to or greater than the upper limit thereof, it is possible to suppress the overcorrection of the axial chromatic aberration.

$$0.2 < NRp - NRn < 0.9 \qquad ( 32 )$$

In order to obtain more favorable characteristics, it is preferable to set the lower limit of Conditional Expression (32) to 0.3 or 0.35, instead of 0.2. In addition, it is preferable to set the upper limit of Conditional Expression (32) to 0.7 or 0.6, instead of 0.9.

In a case in which the LFe lens, which is a positive lens, is disposed on a side of the front group GF closest to the image side, at least one of the object side surface or the image side surface of the LFe lens may be formed to be an aspherical surface. In the configuration in which the LFe lens is disposed on a side of the front group GF closest to the image side and at least one of the object side surface or the image side surface of the LFe lens is an aspherical surface, it is preferable that the imaging lens satisfies Conditional Expression (33). Here, a paraxial curvature radius of the object side surface of the LFe lens is denoted by RcLFef. A paraxial curvature radius of the image side surface of the LFe lens is denoted by RcLFer. A curvature radius of the object side surface of the LFe lens at the position of the maximum effective diameter is denoted by RyLFef. A curvature radius of the image side surface of the LFe lens at the position of the maximum effective diameter is denoted by RyLFer. By not allowing the corresponding values in Conditional Expression (33) to be equal to or less than the lower limit thereof, it is possible to prevent an excessively strong refractive power on an edge part side of the lens, so that there is an advantage in achieving correcting the field curvature and the distortion. By not allowing the corresponding values in Conditional Expression (33) to be equal to or greater than the upper limit thereof, it is possible to prevent the refractive power on the edge part side of the lens from being excessively weakened, so that there is an advantage in achieving the suppression of the astigmatism.

$$0.5 < ( 1 / RcLFef - 1 / RcLFer ) / ( 1 / RyLFef - 1 / RyLFer ) < 7 \qquad ( 33 )$$

In order to obtain more favorable characteristics, it is preferable to set the lower limit of Conditional Expression (33) to any of 0.7, 0.9, or 1.1, instead of 0.5. In addition, it is preferable to set the upper limit of Conditional Expression (33) to any of 5.7, 4.5, or 3.5, instead of 7.

In the configuration in which the LFe lens, which is a positive lens, is disposed on a side of the front group GF closest to the image side, it is preferable that the imaging lens satisfies Conditional Expression (34). Conditional Expression (34) defines a shape factor of the LFe lens. By not allowing the corresponding values in Conditional Expression (34) to be equal to or less than the lower limit thereof, it is easy to satisfactorily correct the astigmatism. By not allowing the corresponding values in Conditional Expression (34) to be equal to or greater than the upper limit thereof, it is easy to satisfactorily correct the spherical aberration.

$$- 4 < ( RcLFef - RcLFer ) / ( RcLFef + RcLFer ) < 10 \qquad ( 34 )$$

In order to obtain more favorable characteristics, it is preferable to set the lower limit of Conditional Expression (34) to −3.5 or −3, instead of −4. In addition, it is preferable to set the upper limit of Conditional Expression (34) to 5 or 3, instead of 10.

In the configuration in which the LFe lens, which is a positive lens, is disposed on a side of the front group GF closest to the image side, in a case in which the Abbe number of the LFe lens based on the d line is denoted by νLFe, it is preferable that the imaging lens satisfies Conditional Expression (35).

By not allowing the corresponding values in Conditional Expression (35) to be equal to or less than the lower limit thereof, it is easy to correct the chromatic aberration. By not allowing the corresponding values in Conditional Expression (35) to be equal to or greater than the upper limit thereof, a material having high availability can be used, and thus it is possible to realize favorable correction of various aberrations other than the chromatic aberration.

$$15 < vLFe < 90 \qquad ( 35 )$$

In order to obtain more favorable characteristics, it is preferable to set the lower limit of Conditional Expression (35) to 19 or 23, instead of 15. In addition, it is preferable to set the upper limit of Conditional Expression (35) to 80 or 72, instead of 90.

In a case in which a central thickness of the first lens is denoted by D1, it is preferable that the imaging lens satisfies Conditional Expression (36). As an example, FIG. 2 shows the central thickness D1. By not allowing the corresponding values in Conditional Expression (36) to be equal to or less than the lower limit thereof, the central thickness D1 of the first lens can be prevented from being excessively decreased, so that the strength of the optical system against an impact from the outside can be increased. By not allowing the corresponding values in Conditional Expression (36) to be equal to or greater than the upper limit thereof, the central thickness D1 of the first lens can be prevented from being excessively large, so that it is possible to contribute to the reduction in the weight of the optical system.

$$0.007 < D1 / TL < 0.1 \qquad ( 36 )$$

In order to obtain more favorable characteristics, it is preferable to set the lower limit of Conditional Expression (36) to 0.01 or 0.011, instead of 0.007. In addition, it is preferable to set the upper limit of Conditional Expression (36) to 0.08 or 0.06, instead of 0.1.

In a case in which a thickness of the first lens in the optical axis direction at a height of a maximum effective diameter of the image side surface of the first lens is denoted by DH1, it is preferable that the imaging lens satisfies Conditional Expression (37). The “height of the maximum effective diameter” described herein refers to a distance from the optical axis Z to the position of the maximum effective diameter. As an example, FIG. 2 shows the thickness DH1. Conditional Expression (37) is an expression relating to a wall thicknesses ratio of the first lens on the optical axis and outside the optical axis. By not allowing the corresponding values in Conditional Expression (37) to be equal to or less than the lower limit thereof, the wall thickness ratio of the first lens can be prevented from being excessively small, so that it is easy to correct the astigmatism and the distortion. By not allowing the corresponding values in Conditional Expression (37) to be equal to or greater than the upper limit thereof, the wall thickness ratio of the first lens can be prevented from being excessively large, so that the first lens is easily manufactured.

$$2 < DH 1 / D 1 < 10 \qquad ( 37 )$$

In order to obtain more favorable characteristics, it is preferable to set the lower limit of Conditional Expression (37) to 2.4, instead of 2. In addition, it is preferable to set the upper limit of Conditional Expression (37) to 9, instead of 10.

In a case in which an Abbe number of a lens of the imaging lens closest to the image side based on the d line is denoted by νLe, it is preferable that the imaging lens satisfies Conditional Expression (38). By not allowing the corresponding values in Conditional Expression (38) to be equal to or less than the lower limit thereof, it is easy to correct the chromatic aberration. By not allowing the corresponding values in Conditional Expression (38) to be equal to or greater than the upper limit thereof, a material having high availability can be used, and thus it is possible to realize favorable correction of various aberrations other than the chromatic aberration.

$$30 < vLe < 95 \qquad ( 38 )$$

In order to obtain more favorable characteristics, it is preferable to set the lower limit of Conditional Expression (38) to 40 or 45, instead of 30. In addition, it is preferable to set the upper limit of Conditional Expression (38) to 92 or 90, instead of 95.

In a case in which an effective radius of the object side surface of the first lens is denoted by EL1, it is preferable that the imaging lens satisfies Conditional Expression (39). By not allowing the corresponding values in Conditional Expression (39) to be equal to or less than the lower limit thereof, there is an advantage in ensuring a sufficient quantity of peripheral light. By not allowing the corresponding values in Conditional Expression (39) to be equal to or greater than the upper limit thereof, it is possible to suppress an increase in diameter of the first lens, so that it is possible to achieve the reduction in the size and weight of the first lens.

This can contribute to improvement of the degree of freedom of the disposition of the mechanism that holds the lens.

$$0.7 < EL 1 / ( f \times tan ω m ) < 2 \qquad ( 39 )$$

In order to obtain more favorable characteristics, it is preferable to set the lower limit of Conditional Expression (39) to 0.8 or 0.9, instead of 0.7. In addition, it is preferable to set the upper limit of Conditional Expression (39) to 1.7 or 1.5, instead of 2.

It is preferable that the imaging lens includes at least one Ls lens that satisfies Conditional Expressions (40), (41), (42), and (43) on the image side with respect to the second lens. Here, a refractive index of the Ls lens at the d line is denoted by NLs. An Abbe number of the Ls lens based on the d line is denoted by νLs. A partial dispersion ratio of the Ls lens between the g line and the F line is denoted by θgFLs. In the example of FIG. 1, the lens L13 corresponds to the Ls lens.

$$0.005 < NLs - ( 2.015 - 0.0068 \times vLs ) < 0.15 \qquad ( 40 )$$

$$49.8 < vLs < 65 \qquad ( 41 )$$

$$0.543 < θ gFLs < 0.58 \qquad ( 42 )$$

$$- 0. 11 < θ gFLs - ( 0.6418 - 0.00168 \times vLs ) < 0.0 \; 35 \qquad ( 43 )$$

By not allowing the corresponding values in Conditional Expression (40) to be equal to or less than the lower limit thereof, it is easy to correct the chromatic aberration. By not allowing the corresponding values in Conditional Expression (40) to be equal to or greater than the upper limit thereof, it is easy to satisfactorily perform correction of the spherical aberration and correction of the chromatic aberration at the same time.

In order to obtain more favorable characteristics, it is preferable to set the lower limit of Conditional Expression (40) to any of 0.015, 0.025, 0.03, or 0.035, instead of 0.005. In addition, it is preferable to set the upper limit of Conditional Expression (40) to any of 0.14, 0.13, 0.12, or 0.116, instead of 0.15.

By not allowing the corresponding values in Conditional Expression (41) to be equal to or less than the lower limit thereof, it is easy to correct the chromatic aberration. By not allowing the corresponding values in Conditional Expression (41) to be equal to or greater than the upper limit thereof, a material having high availability can be used, and thus it is possible to realize favorable correction of various aberrations other than the chromatic aberration.

In order to obtain more favorable characteristics, it is preferable to set the lower limit of Conditional Expression (41) to 50.1 or 50.2, instead of 49.8. In addition, it is preferable to set the upper limit of Conditional Expression (41) to 63 or 59, instead of 65.

By not allowing the corresponding values in Conditional Expression (42) to be equal to or less than the lower limit thereof, it is easy to correct the chromatic aberration. By not allowing the corresponding values in Conditional Expression (42) to be equal to or greater than the upper limit thereof, a material having high availability can be used, and thus it is possible to realize favorable correction of various aberrations other than the chromatic aberration.

In order to obtain more favorable characteristics, it is preferable to set the lower limit of Conditional Expression (42) to 0.544 or 0.5445, instead of 0.543. In addition, it is preferable to set the upper limit of Conditional Expression (42) to 0.57 or 0.563, instead of 0.58.

By not allowing the corresponding values in Conditional Expression (43) to be equal to or less than the lower limit thereof, it is easy to correct the chromatic aberration. By not allowing the corresponding values in Conditional Expression (43) to be equal to or greater than the upper limit thereof, a material having high availability can be used, and thus it is possible to realize favorable correction of various aberrations other than the chromatic aberration.

In order to obtain more favorable characteristics, it is preferable to set the lower limit of Conditional Expression (43) to any of −0.01, −0.009, or −0.008, instead of −0.011. In addition, it is preferable to set the upper limit of Conditional Expression (43) to any of 0.025, 0.015, or 0.005, instead of 0.035.

It should be noted that the example shown in FIG. 1 is merely an example, and various modifications can be made without departing from the gist of the technology of the present disclosure. For example, the number of lenses included in the front group GF, the rear group GR, and the focus lens group may be different from the number shown in the example of FIG. 1.

In the example of FIG. 1, the first focus lens group Gf1 and the second focus lens group Gf2 are successively disposed, but, in the imaging lens according to the present disclosure, the first focus lens group Gf1 and the second focus lens group Gf2 may be non-successively disposed.

The focus lens group may be disposed at a position different from the position shown in the example in FIG. 1. For example, the first focus lens group Gf1 may be disposed in the front group GF, and the second focus lens group Gf2 may be disposed in the rear group GR. By disposing one focus lens group in the front group GF and one focus lens group in the rear group GR, it is easy to suppress the fluctuation in the aberration during focusing, and the refractive power of each focus lens group can be increased as compared with a case in which the focus lens groups are not disposed in this manner. Accordingly, the movement amount of each focus lens group during focusing can be further suppressed, so that there is an advantage in high-speed focusing.

In the example of FIG. 1, during focusing from the infinite distance object to the closest object, one of the first focus lens group Gf1 or the second focus lens group Gf2 moves to the image side, and the other thereof moves to the object side. However, in the imaging lens according to the present disclosure, during focusing from the infinite distance object to the closest object, both the first focus lens group Gf1 and the second focus lens group Gf2 may be configured to move to the image side, or both thereof may be configured to move to the object side.

In addition, the imaging lens of the example in FIG. 1 comprises two focus lens groups, but the imaging lens according to the present disclosure may comprise only one focus lens group. In a case in which only one lens group that moves during focusing is used, the mechanism can be simplified.

In a case in which the imaging lens includes only one focus lens group, the focus lens group may be configured to be disposed in the rear group GR. By disposing the focus lens group in the rear group GR, there is an advantage in achieving the reduction in the diameter of the focus lens group.

In the configuration in which the imaging lens includes only one focus lens group and the focus lens group is disposed in the rear group GR, it is preferable that the imaging lens satisfies Conditional Expression (11). Here, a focal length of the focus lens group is denoted by ff. By not allowing the corresponding values in Conditional Expression (11) to be equal to or less than the lower limit thereof, it is possible to prevent the refractive power of the focus lens group from being excessively decreased, so that the movement amount of the focus lens group during focusing can be suppressed. By not allowing the corresponding values in Conditional Expression (11) to be equal to or greater than the upper limit thereof, it is easy to suppress the fluctuation in the aberration during focusing.

$$0.05 < \vert f / ff \vert < 0.9 \qquad ( 11 )$$

In order to obtain more favorable characteristics, it is preferable to set the lower limit of Conditional Expression (11) to any of 0.09, 0.12, or 0.15, instead of 0.05. In addition, it is preferable to set the upper limit of Conditional Expression (11) to any of 0.75, 0.65, or 0.55, instead of 0.9.

In the configuration in which imaging lens includes only one focus lens group, and the focus lens group is disposed in the rear group GR, it is preferable that the imaging lens satisfies Conditional Expression (12).

By not allowing the corresponding values in Conditional Expression (12) to be equal to or less than the lower limit thereof, it is possible to prevent the refractive power of the focus lens group from being excessively decreased, so that the movement amount of the focus lens group during focusing can be suppressed. By not allowing the corresponding values in Conditional Expression (12) to be equal to or greater than the upper limit thereof, it is easy to suppress the fluctuation in the aberration during focusing.

$$0.1 < \vert TL / ff \vert < 6 \qquad ( 12 )$$

In order to obtain more favorable characteristics, it is preferable to set the lower limit of Conditional Expression (12) to any of 0.45, 0.75, or 1, instead of 0.1. In addition, it is preferable to set the upper limit of Conditional Expression (12) to any of 4.5, 4, or 3.5, instead of 6.

In the configuration in which the imaging lens includes only one focus lens group and the focus lens group is disposed in the rear group GR, it is preferable that the imaging lens satisfies Conditional Expression (13). Here, a combined focal length of all lenses on the image side with respect to the focus lens group is denoted by ff_r. By not allowing the corresponding values in Conditional Expression (13) to be equal to or less than the lower limit thereof, the combined refractive power of all lenses on the image side with respect to the focus lens group is not excessively decreased, so that there is an advantage in correcting the lateral chromatic aberration. By not allowing the corresponding values in Conditional Expression (13) to be equal to or greater than the upper limit thereof, the combined refractive power of all lenses on the image side with respect to the focus lens group is not excessively increased, so that there is an advantage in correcting distortion and field curvature.

$$0.05 < f / ff\_r < 1.5 \qquad ( 13 )$$

In order to obtain more favorable characteristics, it is preferable to set the lower limit of Conditional Expression (13) to any of 0.08, 0.1, or 0.12, instead of 0.05. In addition, it is preferable to set the upper limit of Conditional Expression (13) to any of 1.2, 0.9, or 0.7, instead of 1.5.

In the configuration in which the imaging lens includes only one focus lens group and the focus lens group is disposed in the rear group GR, it is preferable that the imaging lens satisfies Conditional Expression (14). Here, a combined focal length of all lenses on the object side with respect to the focus lens group is denoted by ff_f. By not allowing the corresponding values in Conditional Expression (14) to be equal to or less than the lower limit thereof, the negative combined refractive power of all lenses on the object side with respect to the focus lens group is not excessively increased, so that there is an advantage in shortening the total length of the optical system, and it is easy to ensure the quantity of peripheral light. By not allowing the corresponding values in Conditional Expression (14) to be equal to or greater than the upper limit thereof, the negative combined refractive power of all lenses on the object side with respect to the focus lens group is not excessively weakened, so that there is an advantage in correcting distortion and field curvature.

$$- 3 < f / ff\_f < 0 \qquad ( 14 )$$

In order to obtain more favorable characteristics, it is preferable to set the lower limit of Conditional Expression (14) to any of −2.5, −2, or −1.5, instead of −3. In addition, it is preferable to set the upper limit of Conditional Expression (14) to any of −0.03, −0.05, or −0.07, instead of 0.

In a case in which the imaging lens includes only one focus lens group, the focus lens group may be configured to be disposed in the front group GF. By disposing the focus lens group in the front group GF, the number of lenses to be moved during focusing can be further reduced, so that there is an advantage in high-speed focusing.

Further, in the example of FIG. 1, the aperture stop St is fixed with respect to the image plane Sim during focusing, but, in the imaging lens according to the present disclosure, the focus lens group may include the aperture stop St, and the aperture stop St may be configured to move along the optical axis Z during focusing. In such a case, there is an advantage in suppressing the fluctuation in the aberration during focusing. In a case in which the focus lens group includes the aperture stop St and at least one lens, during focusing, it is preferable that all the lenses included in the focus lens group and the aperture stop St integrally move.

In such a case, the mechanism can be simplified. It should be noted that the phrase “moving integrally” means moving by the same amount in the same direction at the same time.

In the configuration in which the imaging lens includes only one focus lens group, the focus lens group includes the aperture stop St, and the aperture stop St moves along the optical axis Z during focusing, it is preferable that the imaging lens satisfies Conditional Expression (15). Here, a focal length of the focus lens group including the aperture stop St that moves during focusing is denoted by ffs. By not allowing the corresponding values in Conditional Expression (15) to be equal to or less than the lower limit thereof, the refractive power of the focus lens group including the aperture stop St that moves during focusing can be prevented from being excessively decreased, so that the movement amount of the focus lens group during focusing can be suppressed. By not allowing the corresponding values in Conditional Expression (15) to be equal to or greater than the upper limit thereof, it is easy to suppress the fluctuation in the aberration during focusing.

$$0.1 < f / ffs < 0.5 \qquad ( 15 )$$

In order to obtain more favorable characteristics, it is preferable to set the lower limit of Conditional Expression (15) to any of 0.13, 0.16, 0.18, or 0.2, instead of 0.1. In addition, it is preferable to set the upper limit of Conditional Expression (15) to any of 0.47, 0.44, 0.42, or 0.4, instead of 0.5.

The above-described preferred configurations and available configurations including the configurations related to the conditional expressions can be combined in any manner and are preferably selectively adopted, as appropriate, in accordance with required specifications.

As an example, the imaging lens according to a preferred aspect of the present disclosure consists of, in order from the object side to the image side, the front group GF, the aperture stop St, and the rear group GR, in which the front group GF includes, in successive order from a side closest to the object side to the image side, the first lens that is a negative lens having a concave surface facing the image side, and the second lens that is a negative lens having a concave surface facing the image side, two or less focus lens groups are disposed on the image side with respect to the second lens, during focusing, the two or less focus lens groups move along the optical axis Z, and lenses other than the two or less focus lens groups are fixed with respect to the image plane Sim, and Conditional Expression (1) is satisfied.

Next, examples of the imaging lens according to the present disclosure will be described with reference to the drawings. It should be noted that reference numerals provided to the lenses in the cross-sectional view of each example are independently used for each example in order to avoid complication of description and the drawings caused by an increasing number of digits of the reference numerals. Accordingly, even in a case in which a common reference numeral is provided in the drawings of different examples, the common reference numeral does not always indicate a common configuration.

### Example 1

Since a cross-sectional view of the configuration of the imaging lens according to Example 1 is shown in FIG. 1, and its showing method and configuration are the same as described above, the duplicate descriptions will be partially omitted. The imaging lens of Example 1 consists of, in order from the object side to the image side, the front group GF having a positive refractive power, the aperture stop St, and the rear group GR having a positive refractive power. The front group GF includes the first focus lens group Gf1 having a positive refractive power and the second focus lens group Gf2 having a positive refractive power.

The front group GF consists of seven lenses of the lenses L11 to L17 in order from the object side to the image side. The rear group GR consists of six lenses of the lenses L21 to L26 in order from the object side to the image side. The first focus lens group Gf1 consists of the lens L15. The second focus lens group Gf2 consists of the lens L16 and the lens L17. During focusing from the infinite distance object to the closest object, the first focus lens group Gf1 moves to the image side, the second focus lens group Gf2 moves to the object side, and the other lenses and the aperture stop St are fixed with respect to the image plane Sim.

Regarding the imaging lens of Example 1, Table 1 shows basic lens data, Table 2 shows specifications, Table 3 shows a variable surface spacing, and Table 4 shows an aspherical coefficient.

The table of the basic lens data is described as below. The column of Sn indicates surface numbers in a case in which the number is increased by one at a time toward the image side from a surface closest to the object side as a first surface. The column of R indicates a curvature radius of each surface. The column of D indicates a surface spacing on the optical axis between each surface and its adjacent surface on the image side. A column of Nd indicates a refractive index with respect to a d line for each constituent. A column of νd indicates an Abbe number of each constituent based on the d line. A column of θgF indicates a partial dispersion ratio of each constituent between a g line and an F line. A leftmost column of a row of the lenses corresponding to each focus lens group shows a reference numeral of the focus lens group. For example, “Gf1” in the left column of the ninth surface and the tenth surface of Table 1 indicates that the ninth surface to the tenth surface correspond to the first focus lens group Gf1.

In the table of the basic lens data, a sign of a curvature radius of a surface having a convex shape facing the object side is positive, and a sign of a curvature radius of a surface having a convex shape facing the image side is negative. The field of a surface number of the surface corresponding to the aperture stop St has the term of the surface number (St). A value in the lowermost field of the column D in the table indicates a spacing between a surface closest to the image side in the table and the image plane Sim. The variable surface spacing during focusing is denoted by a symbol DD, and the surface number of the surface on the object side of this spacing is added after DD in the column of the surface spacing.

Table 2 shows the focal length f, the back focus Bf, the open F-number FNo, and the maximum full angle of view 2ωm based on the d line. In the field of the maximum full angle of view, [° ] indicates that the unit is degrees. Table 2 shows a value in a state in which the infinite distance object is in focus.

Table 3 shows a variable surface spacing during focusing. In Table 3, the column of “Infinity” shows the surface spacing in a state in which the infinite distance object is in focus. An absolute value of the imaging magnification in a state in which the closest object is in focus, that is, an absolute value of the maximum imaging magnification is shown after “|P1=”, and the variable surface spacing in a state in which the closest object is in focus is shown in the column.

In the basic lens data, a reference sign * is attached to the surface number of the aspherical surface, and the numerical value of the paraxial curvature radius is written into the column of the curvature radius of the aspherical surface. In Table 4, the line Sn shows the surface number of the aspherical surface, and the lines KA and Am show numerical values of the aspherical coefficients for each aspherical surface. It should be noted that m of Am is an integer equal to or greater than 3, and varies depending on the surface. For example, in the first surface of Example 1, m=4, 6, 8, 10, 12, 14, 16, 18, and 20. In Table 4, “E±n” (n: integer) of the numerical value of the aspherical coefficient means “×10^{±n}”. KA and Am are aspherical coefficients in an aspheric equation represented by the following equation.

$$Zd = C \times {h}^{2} / \{ 1 + {( 1 - KA \times {C}^{2} \times {h}^{2} )}^{1 / 2} \} + \sum Am \times {h}^{m}$$

Here,
Zd: aspherical surface depth (distance between the plane perpendicular to the optical axis Z, which passes through the intersection of the aspherical surface and the optical axis Z, and the point on the aspherical surface at the height h),
h: height (distance from optical axis Z to lens surface),
C: reciprocal of paraxial curvature radius, and
KA, Am: aspherical coefficients,
and Σ means the sum with respect to m in aspherical surface equation.

In the data of each table, degrees are used as a unit of angles, and a millimeter (mm) is used for a unit of lengths, but, since the optical system can also be proportionally enlarged or proportionally reduced to be used, other appropriate units can also be used. In addition, numerical values rounded to predetermined digits are described in each table shown below.

TABLE 1
Example 1

| | Sn | R | D | Nd | νd | θgF |
|---|---|---|---|---|---|---|
| | *1 | 50.8105 | 2.2502 | 1.67798 | 54.89 | 0.54485 |
| | *2 | 23.1930 | 9.9714 | | | |
| | 3 | 33.7247 | 1.0002 | 1.69560 | 59.05 | 0.54348 |
| | 4 | 19.5664 | 12.7322 | | | |
| | 5 | −94.2309 | 0.8850 | 1.77893 | 51.21 | 0.54893 |
| | 6 | 107.9274 | 4.5492 | | | |
| | *7 | 66.3015 | 2.5001 | 2.00000 | 15.00 | 0.67771 |
| | *8 | 67.8192 | DD8 | | | |
| Gf1 | 9 | −40.4329 | 5.7500 | 1.79882 | 25.06 | 0.61729 |
| | 10 | −26.6854 | DD10 | | | |
| Gf2 | 11 | 44.6582 | 0.6850 | 2.00000 | 15.00 | 0.67771 |
| | 12 | 28.5459 | 5.4503 | 1.72935 | 56.25 | 0.54274 |
| | 13 | −66.4081 | DD13 | | | |
| | 14(St) | ∞ | 3.7717 | | | |
| | *15 | −18.3638 | 5.0333 | 1.43599 | 75.49 | 0.52479 |
| | *16 | −23.7052 | 1.9688 | | | |
| | 17 | −16.5111 | 0.7598 | 1.72960 | 56.24 | 0.54274 |
| | 18 | −22.2044 | 0.1200 | | | |
| | 19 | 27.8549 | 5.6591 | 1.86363 | 42.55 | 0.56461 |
| | 20 | −97.7501 | 2.6814 | | | |
| | *21 | −53.2600 | 1.2000 | 1.85400 | 40.39 | 0.56774 |
| | *22 | −55.4460 | 6.2831 | | | |
| | 23 | −131.3802 | 0.5001 | 1.99999 | 23.83 | 0.62405 |
| | 24 | 18.9914 | 11.2092 | 1.59651 | 66.38 | 0.54286 |
| | 25 | −40.4244 | 13.2047 | | | |

TABLE 2
Example 1

| | |
|---|---|
| f | 14.42 |
| Bf | 13.20 |
| FNo. | 1.80 |
| 2 ωm[°] | 118.0 |

TABLE 3
Example 1

| | Infinity | \|β\| = 0.2 |
|---|---|---|
| DD8 | 4.2975 | 7.6322 |
| DD10 | 10.2534 | 0.9629 |
| DD13 | 2.2498 | 8.2056 |

TABLE 4
Example 1

| Sn | 1 | 2 | 7 | 8 |
|---|---|---|---|---|
| KA | 1.0000000E+00 | 1.0000000E+00 | 1.0000000E+00 | 1.0000000E+00 |
| A4 | 2.4152757E−05 | 2.7368644E−05 | −2.9530383E−05 | −1.7635880E−05 |
| A6 | −7.5600978E−08 | −6.7314149E−08 | −1.2205910E−07 | −1.3365112E−07 |
| A8 | 1.5031819E−10 | 6.4296363E−11 | −3.4061236E−10 | −2.0551473E−10 |
| A10 | −1.5019009E−13 | 2.4628738E−14 | 1.1296523E−13 | 1.1805332E−12 |
| A12 | 5.5169987E−17 | 1.4089712E−16 | 4.9802945E−15 | 2.1135078E−15 |
| A14 | 4.8801502E−20 | −1.0848143E−19 | 3.6144929E−18 | −4.4642932E−18 |
| A16 | −8.3497753E−23 | 1.6698667E−21 | −1.9578473E−19 | 1.7124397E−20 |
| A18 | 4.6444591E−26 | −3.7271422E−24 | 9.2341759E−22 | −2.7958951E−22 |
| A20 | −5.6105191E−30 | −2.7510099E−27 | −1.6020906E−24 | 6.2506543E−25 |

| Sn | 15 | 16 |
|---|---|---|
| KA | 1.0000000E+00 | 1.0000000E+00 |
| A4 | 9.6710373E−05 | 2.9970972E−05 |
| A6 | −4.6471658E−07 | −4.9500126E−07 |
| A8 | 1.9848819E−09 | 1.8774237E−09 |
| A10 | −4.6044444E−12 | −5.2333649E−12 |
| Sn | 21 | 22 |
| KA | 1.4946577E−06 | 0.0000000E+00 |
| A4 | 4.9178462E−05 | 9.5999300E−05 |
| A6 | 2.9130952E−07 | 3.1239799E−07 |
| A8 | −8.7540418E−10 | 6.4707724E−10 |
| A10 | −9.1007422E−14 | −2.0982371E−11 |
| A12 | −3.4710088E−13 | −9.3191278E−14 |
| A14 | 3.7634616E−15 | 1.3648872E−15 |
| A16 | −1.5045984E−17 | −3.2983172E−18 |
| A18 | 2.1601484E−20 | −8.5836739E−22 |

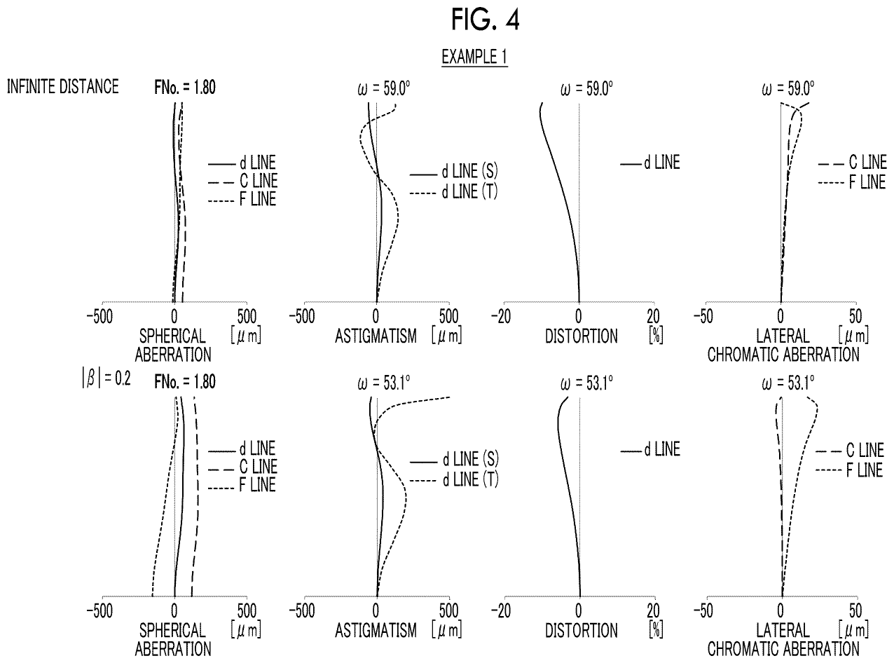

FIG. 4 shows each aberration diagram of the imaging lens of Example 1. In FIG. 4, the spherical aberration, the astigmatism, the distortion, and the lateral chromatic aberration are shown in this order from the left side. In FIG. 4, each aberration diagram in a state in which the infinite distance object is in focus is shown in an upper part labeled “INFINITE DISTANCE”, and each aberration diagram in a state in which the closest object is in focus is shown in a lower part labeled “|β|=0.2”. In the spherical aberration diagram, the aberrations at the d line, the C line, and the F line are shown by a solid line, a long broken line, and a short broken line, respectively. In the astigmatism diagram, the aberration at the d line in a sagittal direction is shown by a solid line, and the aberration at the d line in a tangential direction is shown by a short broken line. In the distortion diagram, the aberration at the d line is shown by a solid line. In the lateral chromatic aberration diagram, the aberrations on the C line and the F line are shown by a long broken line and a short broken line, respectively. In the spherical aberration diagram, a value of the open F-number is shown after “FNo.=”. In other aberration diagrams, a value of the maximum half angle of view is shown after “ω=”. FNo. and ω in the aberration diagram in the upper part correspond to FNo and om of the conditional expression described above, respectively.

Symbols, meanings, description methods, and showing methods of each data related to Example 1 are basically the same for the following examples unless otherwise noted, and thus the duplicate descriptions will be omitted below.

### Example 2

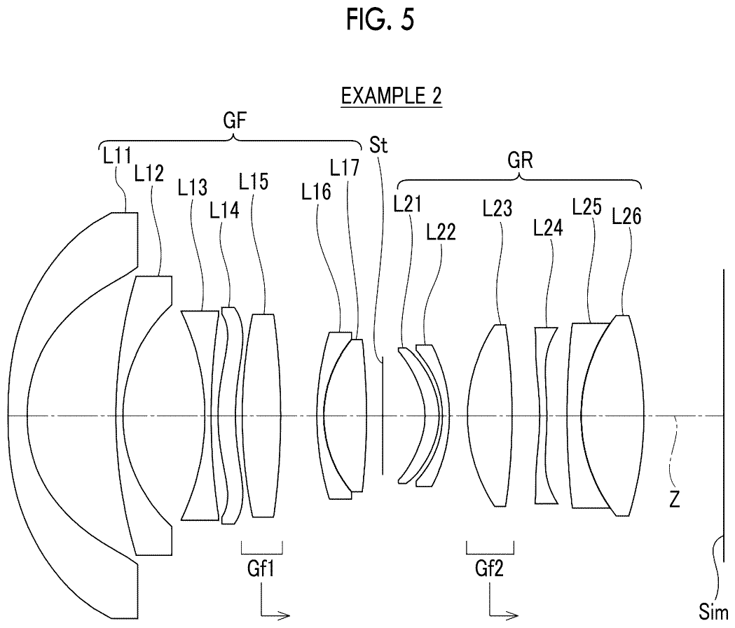

A cross-sectional view of a configuration of an imaging lens according to Example 2 is shown in FIG. 5. The imaging lens of Example 2 consists of, in order from the object side to the image side, the front group GF having a positive refractive power, the aperture stop St, and the rear group GR having a positive refractive power.

The front group GF includes the first focus lens group Gf1 having a positive refractive power, and the rear group GR includes the second focus lens group Gf2 having a positive refractive power.

The front group GF consists of seven lenses of the lenses L11 to L17 in order from the object side to the image side. The rear group GR consists of six lenses of the lenses L21 to L26 in order from the object side to the image side. The first focus lens group Gf1 consists of the lens L15. The second focus lens group Gf2 consists of the lens L23. During focusing from the infinite distance object to the closest object, the first focus lens group Gf1 moves to the image side, the second focus lens group Gf2 moves to the image side, and the other lenses and the aperture stop St are fixed with respect to the image plane Sim.

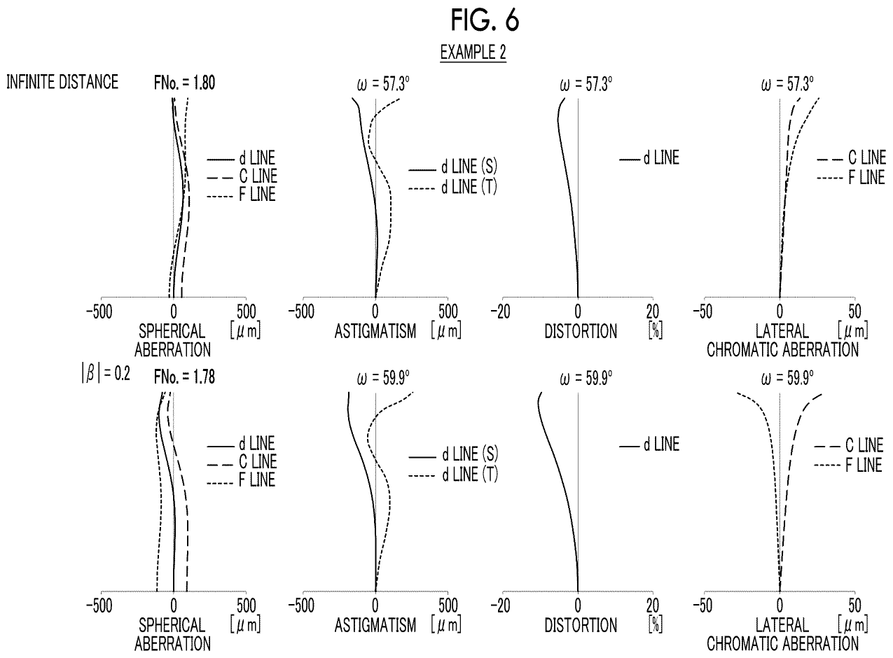

Regarding the imaging lens of Example 2, Table 5 shows basic lens data, Table 6 shows specifications, Table 7 shows a variable surface spacing, Table 8 shows an aspherical coefficient, and FIG. 6 shows each aberration diagram.

TABLE 5
Example 2

| | Sn | R | D | Nd | νd | θgF |
|---|---|---|---|---|---|---|
| | *1 | 82.4547 | 2.7495 | 1.59255 | 67.86 | 0.54402 |
| | *2 | 25.1451 | 12.7380 | | | |
| | 3.00 | 74.7126 | 1.0000 | 1.69560 | 59.05 | 0.54348 |
| | 4.00 | 22.6355 | 11.7828 | | | |
| | 5.0 | −36.2473 | 0.8848 | 1.61418 | 63.62 | 0.54388 |
| | 6 | 103.0525 | 0.9928 | | | |
| | *7 | 31.2008 | 2.4969 | 2.00000 | 15.00 | 0.67771 |
| | *8 | 38.5707 | DD8 | | | |
| Gf1 | 9 | 76.0887 | 5.5107 | 2.00000 | 20.68 | 0.64282 |
| | 10 | −111.1749 | DD10 | | | |
| | 11 | 43.1123 | 0.9998 | 1.99999 | 15.00 | 0.67771 |
| | 12 | 17.9297 | 6.1224 | 1.86567 | 42.34 | 0.56507 |
| | 13 | −105.9051 | 2.2501 | | | |
| | 14(St) | ∞ | 6.0787 | | | |
| | *15 | −10.6818 | 2.0069 | 1.43599 | 67.00 | 0.52556 |
| | *16 | −11.0704 | 0.4841 | | | |
| | 17 | −14.1896 | 0.9999 | 1.56089 | 71.88 | 0.54099 |
| | 18 | −22.7564 | DD18 | | | |
| Gf2 | 19 | 25.0998 | 6.3964 | 1.82331 | 46.67 | 0.55691 |
| | 20 | −97.7133 | DD20 | | | |
| | *21 | −41.4905 | 1.0487 | 1.85400 | 40.39 | 0.56774 |
| | *22 | −46.8120 | 2.8857 | | | |
| | 23 | 122.9801 | 2.0300 | 1.90331 | 23.75 | 0.62211 |
| | 24 | 24.3746 | 8.9933 | 1.46540 | 86.42 | 0.53432 |
| | 25 | −52.0662 | 11.4831 | | | |

TABLE 6
Example 2

| | |
|---|---|
| f | 14.42 |
| Bf | 11.48 |
| FNo. | 1.80 |
| 2 ωm[°] | 114.6 |

TABLE 7
Example 2

| | Infinity | \|β\| = 0.2 |
|---|---|---|
| DD8 | 0.9877 | 5.1374 |
| DD10 | 5.1968 | 1.0471 |
| DD18 | 2.6034 | 3.2363 |
| DD20 | 3.9552 | 3.3224 |

TABLE 8
Example 2

| Sn | 1 | 2 | 7 | 8 |
|---|---|---|---|---|
| KA | 1.0000000E+00 | 1.0000000E+00 | 1.0000000E+00 | 1.0000000E+00 |
| A4 | 3.1646429E− 05 | 3.5932668E−05 | −2.6655598E−05 | −1.9862005E−05 |
| A6 | −8.8595827E−08 | −7.3079816E−08 | −1.1078776E−07 | −1.2662827E−07 |
| A8 | 1.6321146E−10 | 5.4187486E−11 | −3.1979009E−10 | −3.0282497E−10 |
| A10 | −1.5712613E−13 | 1.9065278E−14 | −4.0676387E−13 | 8.5998462E−13 |
| A12 | 3.7117432E−17 | 1.3167523E−16 | 4.1753669E−15 | 6.6766583E−16 |
| A14 | 7.6404991E−20 | −1.4696512E−19 | 8.5627624E−18 | −1.8126455E−19 |
| A16 | −4.2453268E−23 | 1.6015330E−21 | −2.1377968E−19 | 8.2030202E−20 |
| A18 | −4.4957760E−26 | −3.6173459E−24 | 1.1673619E−21 | −5.2699369E−22 |
| A20 | 3.7983890E−29 | −1.4998163E−27 | −2.2244026E−24 | 8.0304528E−25 |

| Sn | 15 | 16 |
|---|---|---|
| KA | 1.0000000E+00 | 1.0000000E+00 |
| A4 | 2.3844112E−04 | 1.7058931E−04 |
| A6 | −1.2117480E−07 | −2.7303946E−07 |
| A8 | −1.9860437E−09 | −1.0580255E−09 |
| A10 | 4.1860847E−11 | 2.5625349E−11 |
| Sn | 21 | 22 |
| KA | 2.3198043E−01 | 0.0000000E+00 |
| A4 | 5.3914166E−05 | 1.0304474E−04 |
| A6 | 2.8341847E−07 | 3.5753773E−07 |
| A8 | −7.5976230E−10 | 5.2044626E−10 |
| A10 | −3.2631774E−14 | −2.0034296E−11 |
| A12 | −3.5075599E−13 | −7.7934422E−14 |
| A14 | 3.7351677E−15 | 1.3954054E−15 |
| A16 | −1.4719214E−17 | −4.6569127E−18 |
| A18 | 2.0880900E−20 | 3.8118023E−21 |

### Example 3

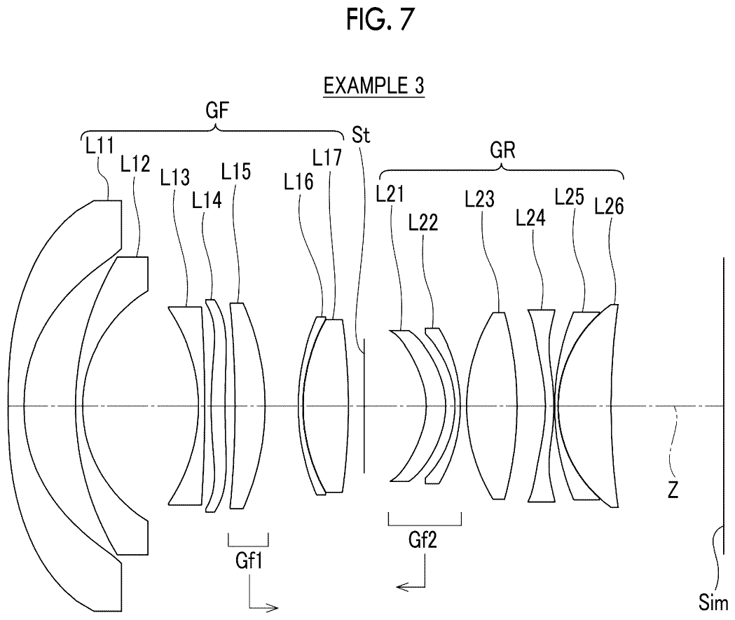

A cross-sectional view of a configuration of an imaging lens according to Example 3 is shown in FIG. 7. The imaging lens of Example 3 consists of, in order from the object side to the image side, the front group GF having a positive refractive power, the aperture stop St, and the rear group GR having a positive refractive power.

The front group GF includes the first focus lens group Gf1 having a positive refractive power, and the rear group GR includes the second focus lens group Gf2 having a negative refractive power.

The front group GF consists of seven lenses of the lenses L11 to L17 in order from the object side to the image side. The rear group GR consists of six lenses of the lenses L21 to L26 in order from the object side to the image side. The first focus lens group Gf1 consists of the lens L15. The second focus lens group Gf2 consists of the lens L21 and the lens L22. During focusing from the infinite distance object to the closest object, the first focus lens group Gf1 moves to the image side, the second focus lens group Gf2 moves to the object side, and the other lenses and the aperture stop St are fixed with respect to the image plane Sim.

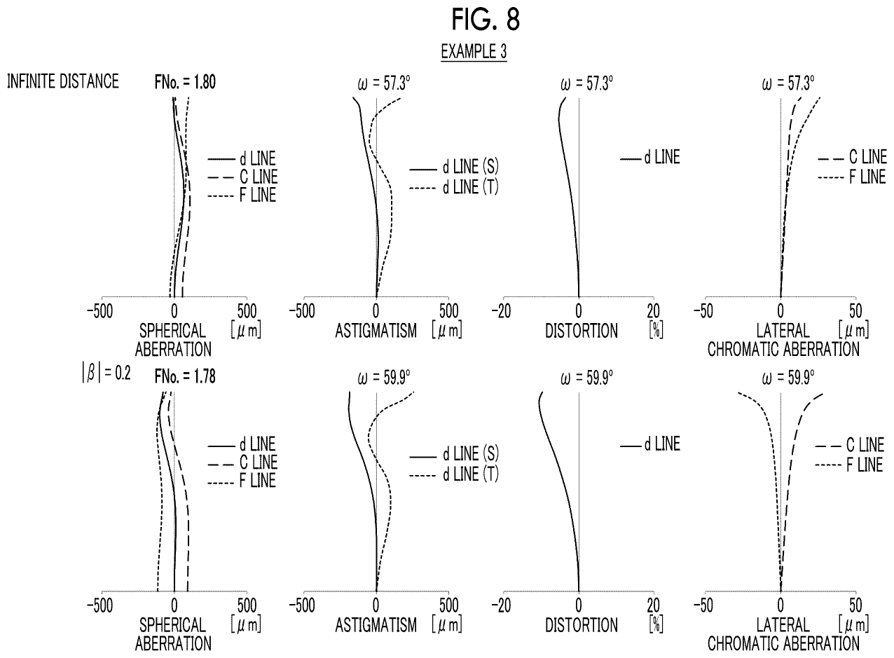

Regarding the imaging lens of Example 3, Table 9 shows basic lens data, Table 10 shows specifications, Table 11 shows a variable surface spacing, Table 12 shows an aspherical coefficient, and FIG. 8 shows each aberration diagram.

TABLE 9
Example 3

| | Sn | R | D | Nd | νd | θgF |
|---|---|---|---|---|---|---|
| | *1 | 144.7686 | 2.2499 | 1.59255 | 67.86 | 0.54402 |
| | *2 | 27.7164 | 7.3141 | | | |
| | 3.00 | 42.8794 | 0.9998 | 1.69560 | 59.05 | 0.54348 |
| | 4.00 | 19.9407 | 16.4408 | | | |
| | 5.0 | −25.8475 | 0.8848 | 1.92129 | 36.65 | 0.57868 |
| | 6 | −227.7549 | 0.9108 | | | |
| | *7 | 64.2302 | 1.9873 | 1.99999 | 15.00 | 0.67771 |
| | *8 | 157.9272 | DD8 | | | |
| Gf1 | 9 | −155.8025 | 4.2499 | 1.78536 | 50.56 | 0.54987 |
| | 10 | −37.6662 | DD10 | | | |
| | 11 | 33.8643 | 0.6850 | 1.99999 | 15.00 | 0.67771 |
| | 12 | 26.3899 | 6.4307 | 1.81794 | 47.22 | 0.55584 |
| | 13 | −94.9694 | 2.2498 | | | |
| | 14(St) | ∞ | DD14 | | | |
| Gf2 | *15 | −11.6146 | 2.7480 | 1.43600 | 67.00 | 0.52556 |
| | *16 | −12.2823 | 1.3184 | | | |
| | 17 | −15.3332 | 0.7600 | 1.95951 | 26.13 | 0.61192 |
| | 18 | −22.8348 | DD18 | | | |
| | 19 | 26.6331 | 7.1484 | 1.72949 | 56.24 | 0.54274 |
| | 20 | −52.7201 | 4.0203 | | | |
| | *21 | −24.6192 | 1.1998 | 1.85400 | 40.39 | 0.56774 |
| | *22 | −28.2638 | 0.1200 | | | |
| | 23 | 36.1989 | 0.5002 | 2.00001 | 28.60 | 0.60122 |
| | 24 | 18.3498 | 7.5049 | 1.55713 | 72.45 | 0.54079 |
| | 25 | 111.9952 | 15.9818 | | | |

TABLE 10
Example 3

| | |
|---|---|
| f | 14.41 |
| Bf | 15.98 |
| FNo. | 1.80 |
| 2 ωm[°] | 115.2 |

TABLE 11
Example 3

| | Infinity | \|β\| = 0.2 |
|---|---|---|
| DD8 | 1.4156 | 5.0988 |
| DD10 | 4.7079 | 1.0247 |
| DD14 | 8.7131 | 7.2684 |
| DD18 | 0.9109 | 2.3557 |

TABLE 12
Example 3

| Sn | 1 | 2 | 7 | 8 |
|---|---|---|---|---|
| KA | 1.0000000E+00 | 1.0000000E+00 | 1.0000000E+00 | 1.0000000E+00 |
| A4 | 2.8117609E−05 | 2.5965534E−05 | −1.6665129E−05 | −7.4674492E−06 |
| A6 | −8.2275513E−08 | −6.4762502E−08 | −1.1143228E−07 | −1.2448448E−07 |
| A8 | 1.6693106E−10 | 6.3306025E−11 | −2.9563098E−10 | −2.5297391E−10 |
| A10 | −1.7503493E−13 | 3.0830653E−15 | −3.4812635E−13 | 9.0921830E−13 |
| A12 | 3.6591253E−17 | 3.2613345E−17 | 5.5172601E−15 | −2.8163701E−16 |
| A14 | 1.0373695E−19 | −3.0854579E−19 | 1.3022955E−17 | −4.8292561E−18 |
| A16 | −4.2929045E−23 | 1.5867875E−21 | −2.4315998E−19 | 7.7860085E−20 |
| A18 | −7.6015635E−26 | −2.9435328E−24 | 8.0177100E−22 | −4.4252887E−22 |
| A20 | 5.4223817E−29 | 8.7926076E−28 | −3.9026145E−25 | 9.6100694E−25 |

| Sn | 15 | 16 |
|---|---|---|
| KA | 1.0000000E+00 | 1.0000000E+00 |
| A4 | 1.6670290E−04 | 1.1659960E−04 |
| A6 | 1.8419896E−07 | −7.5916042E−09 |
| A8 | −2.7900499E−09 | −1.6627086E−09 |
| A10 | 2.3110183E−11 | 1.0747565E−11 |
| Sn | 21 | 22 |
| KA | 4.4466604E−06 | 0.0000000E+00 |
| A4 | 5.4822834E−05 | 9.1857545E−05 |
| A6 | 2.8599048E−07 | 3.5133501E−07 |
| A8 | −6.6439018E−10 | 4.6504122E−10 |
| A10 | −2.0335410E−13 | −1.9580985E−11 |
| A12 | −3.5458181E−13 | −7.9250741E−14 |
| A14 | 3.6526351E−15 | 1.3745112E−15 |
| A16 | −1.3812464E−17 | −4.7114908E−18 |
| A18 | 1.8449356E−20 | 4.4561391E−21 |

### Example 4

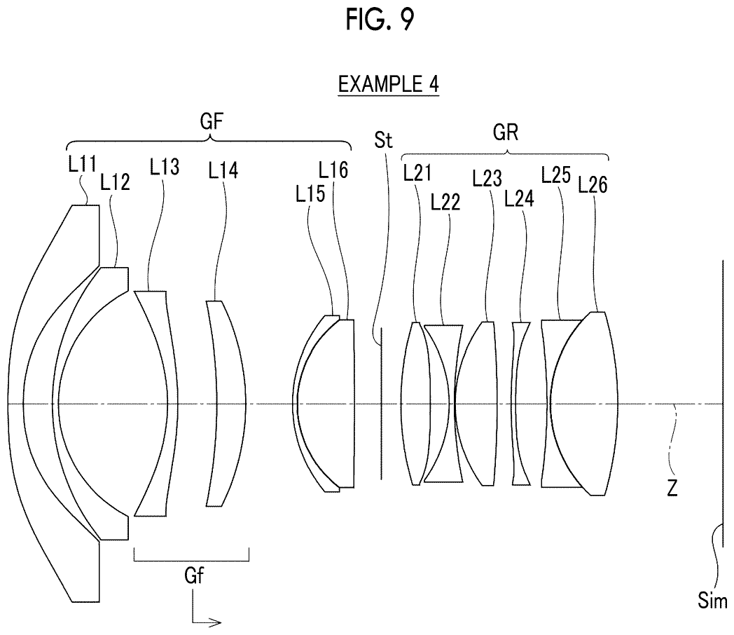

A cross-sectional view of a configuration of an imaging lens according to Example 4 is shown in FIG. 9. The imaging lens of Example 4 consists of, in order from the object side to the image side, the front group GF having a positive refractive power, the aperture stop St, and the rear group GR having a positive refractive power.

The imaging lens of Example 4 comprises only one focus lens group. Hereinafter, in the imaging lens comprising only one focus lens group, the focus lens group will be referred to as the single focus lens group Gf. The front group GF includes the single focus lens group Gf having a positive refractive power.

The front group GF consists of six lenses of the lenses L11 to L16 in order from the object side to the image side. The rear group GR consists of six lenses of the lenses L21 to L26 in order from the object side to the image side. The single focus lens group Gf consists of the lens L13 and the lens L14. During focusing from the infinite distance object to the closest object, the single focus lens group Gf moves to the image side, and the other lenses and the aperture stop St are fixed with respect to the image plane Sim.

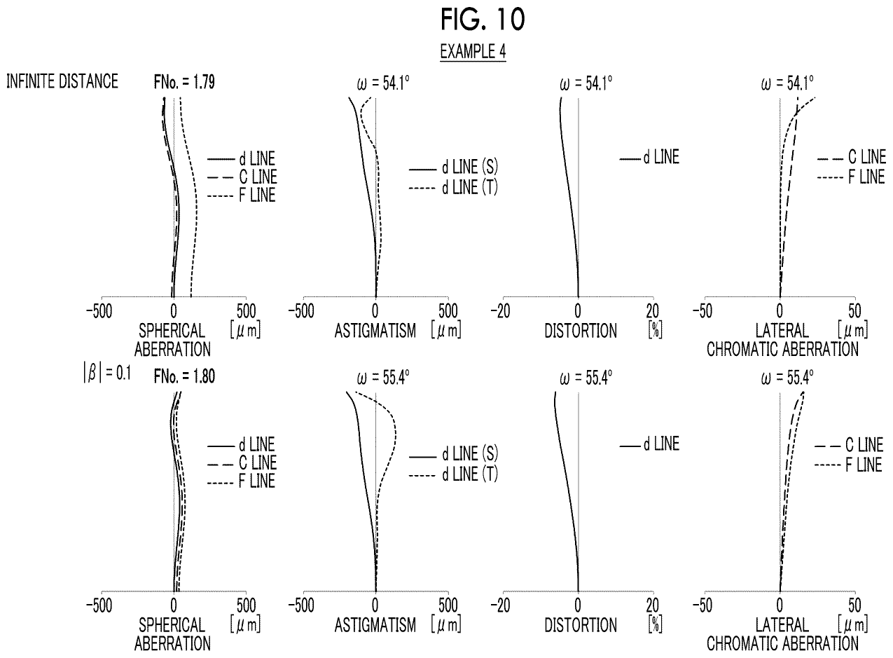

Regarding the imaging lens of Example 4, Table 13 shows basic lens data, Table 14 shows specifications, Table 15 shows a variable surface spacing, Table 16 shows an aspherical coefficient, and FIG. 10 shows each aberration diagram.

TABLE 13
Example 4

| | Sn | R | D | Nd | νd | θgF |
|---|---|---|---|---|---|---|
| | *1 | 98.2206 | 2.2501 | 1.67798 | 54.89 | 0.54485 |
| | *2 | 26.3915 | 4.2847 | | | |
| | 3.00 | 33.2570 | 0.8848 | 2.00001 | 28.60 | 0.60122 |
| | 4.00 | 19.3265 | DD4 | | | |
| Gf | *5 | −26.5631 | 1.5002 | 1.70805 | 42.56 | 0.56982 |
| | *6 | −46.1287 | 5.7286 | | | |
| | 7 | −77.8272 | 4.2502 | 1.87335 | 41.55 | 0.56682 |
| | 8 | −35.6370 | DD8 | | | |
| | 9 | 21.0436 | 0.7005 | 1.78325 | 50.77 | 0.54956 |
| | 10 | 16.0291 | 8.3855 | 1.47753 | 81.49 | 0.53398 |
| | 11 | −949.9403 | 3.8561 | | | |
| | 12(St) | ∞ | 2.8946 | | | |
| | *13 | 45.8199 | 4.3146 | 1.43798 | 90.60 | 0.53154 |
| | *14 | −233.9510 | 2.7900 | | | |
| | 15 | −20.1563 | 0.7598 | 1.43599 | 67.00 | 0.52556 |
| | 16 | 57.4245 | 0.1200 | | | |
| | 17 | 21.1621 | 6.1571 | 1.78575 | 50.52 | 0.54993 |
| | 18 | −147.7756 | 2.0610 | | | |
| | *19 | 69.7195 | 0.6748 | 1.85400 | 40.39 | 0.56774 |
| | *20 | 92.0255 | 4.6041 | | | |
| | 21 | −84.2603 | 0.5000 | 1.93157 | 19.69 | 0.64533 |
| | 22 | 19.2381 | 9.8951 | 1.69879 | 57.78 | 0.54223 |
| | 23 | −50.9245 | 15.4765 | | | |

TABLE 14
Example 4

| | |
|---|---|
| f | 16.40 |
| Bf | 15.48 |
| FNo. | 1.79 |
| 2 ωm[°] | 108.2 |

TABLE 15
Example 4

| | Infinity | \|β\| = 0.1 |
|---|---|---|
| DD4 | 16.0445 | 5.8623 |
| DD8 | 6.8881 | 1.0258 |

TABLE 16
Example 4

| Sn | | 2 | 5 | 6 |
|---|---|---|---|---|
| KA | 1.0000000E+00 | 1.0000000E+00 | 1.0000000E+00 | 1.0000000E+00 |
| A4 | 2.6876880E−05 | 2.5908960E−05 | 1.1840490E−05 | 1.6429270E−05 |
| A6 | −6.5155548E−08 | −4.0573072E−08 | 1.1181613E−08 | 1.9043996E−09 |
| A8 | 1.1849851E−10 | 3.9612045E−11 | −4.4193150E−11 | −2.9408529E−11 |
| A10 | −1.4541015E−13 | −1.2590808E−13 | −4.1336304E−14 | 3.9183753E−14 |
| A12 | 6.7878186E−17 | −7.5531238E−17 | 5.4577349E−16 | 3.0617433E−16 |
| A14 | 6.1263280E−20 | −2.6135743E−19 | 2.5988180E−18 | 8.3406839E−19 |
| A16 | −7.7380637E−23 | 1.7710601E−21 | 2.0684417E−21 | 1.3862713E−21 |
| A18 | −5.7191273E−27 | −2.6849596E−24 | −5.2584297E−23 | −1.6895665E−23 |
| A20 | 2.5007618E−29 | 1.6872976E−27 | 6.4903390E−26 | 3.4627595E−27 |

| Sn | 13 | 14 |
|---|---|---|
| KA | 1.0000000E+00 | 1.0000000E+00 |
| A4 | 3.1383832E−06 | −4.7970614E−05 |
| A6 | 1.8623269E−08 | −1.0256115E−07 |
| A8 | −2.1163508E−10 | 2.7723141E−10 |
| A10 | 2.8032775E−13 | −7.3923764E−13 |

| Sn | 19 | 20 |
|---|---|---|
| KA | 2.5883859E−04 | 0.0000000E+00 |
| A4 | −2.9623949E−05 | 5.0365146E−05 |
| A6 | 9.5351570E−08 | 2.3752922E−07 |
| A8 | −6.8160371E−10 | 2.7782660E−10 |
| A10 | 5.4673972E−12 | −1.3772999E−11 |
| A12 | −3.1903467E−13 | −4.6508853E−14 |
| A14 | 3.6107333E−15 | 1.4081180E−15 |
| A16 | −1.7182393E−17 | −1.0674847E−17 |
| A18 | 3.2671924E−20 | 2.9946632E−20 |

### Example 5

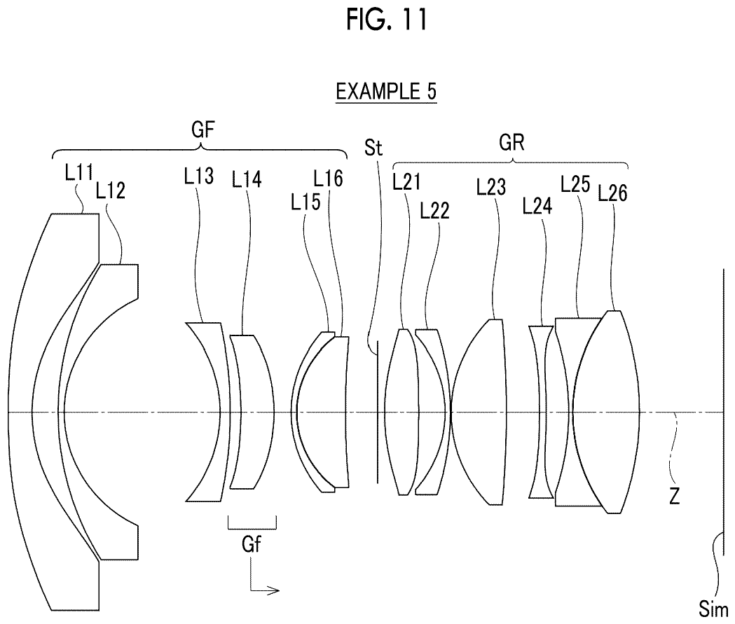

A cross-sectional view of a configuration of an imaging lens of Example 5 is shown in FIG. 11. The imaging lens of Example 5 consists of, in order from the object side to the image side, the front group GF having a negative refractive power, the aperture stop St, and the rear group GR having a positive refractive power. The front group GF includes the single focus lens group Gf having a positive refractive power.

The front group GF consists of six lenses of the lenses L11 to L16 in order from the object side to the image side. The rear group GR consists of six lenses of the lenses L21 to L26 in order from the object side to the image side. The single focus lens group Gf consists of the lens L14. During focusing from the infinite distance object to the closest object, the single focus lens group Gf moves to the image side, and the other lenses and the aperture stop St are fixed with respect to the image plane Sim.

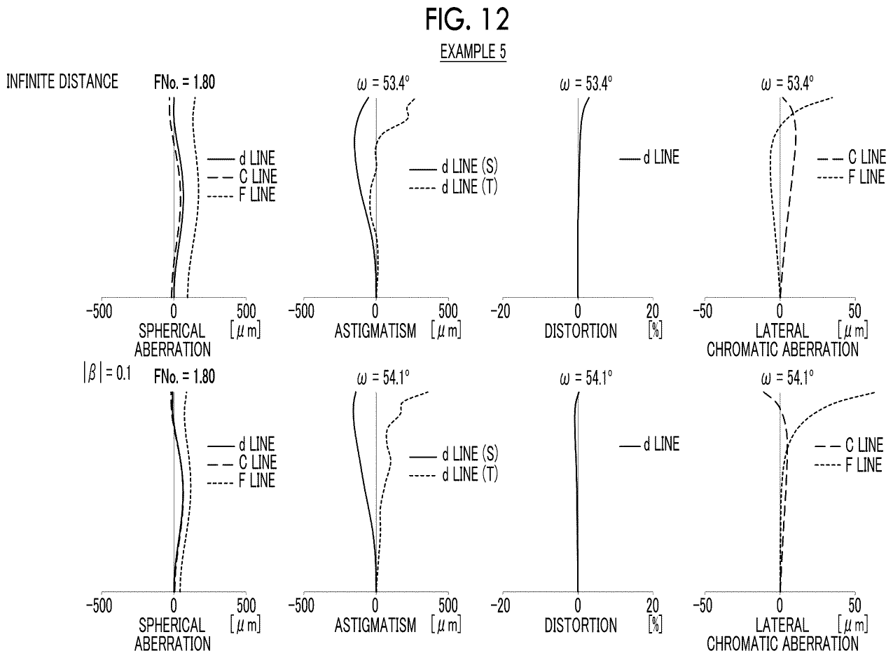

Regarding the imaging lens of Example 5, Table 17 shows basic lens data, Table 18 shows specifications, Table 19 shows a variable surface spacing, Table 20 shows an aspherical coefficient, and FIG. 12 shows each aberration diagram.

TABLE 17
Example 5

| | Sn | R | D | Nd | νd | θgF |
|---|---|---|---|---|---|---|
| | *1 | 148.1892 | 3.4987 | 1.59245 | 66.92 | 0.53588 |
| | *2 | 25.3478 | 3.8255 | | | |
| | 3.00 | 42.6961 | 0.8852 | 1.43708 | 90.73 | 0.53145 |
| | 4.00 | 19.0709 | 22.9008 | | | |
| | 5.0 | −20.6374 | 1.5002 | 1.70838 | 44.61 | 0.56544 |
| | 6 | −64.1255 | DD6 | | | |
| Gf | *7 | −55.4753 | 4.8619 | 1.74388 | 54.80 | 0.54382 |
| | *8 | −26.1223 | DD8 | | | |
| | 9 | 18.5219 | 0.8352 | 1.86697 | 42.21 | 0.56537 |
| | 10 | 14.4407 | 7.1602 | 1.44864 | 88.97 | 0.53262 |
| | 11 | 130.5186 | 4.6273 | | | |
| | 12(St) | ∞ | 1.0256 | | | |
| | *13 | 34.3642 | 5.0130 | 1.43603 | 90.89 | 0.53134 |
| | *14 | −212.3448 | 3.8812 | | | |
| | 15 | −17.9245 | 0.7600 | 1.45656 | 64.05 | 0.53030 |
| | 16 | −40.8768 | 0.1200 | | | |
| | 17 | 20.3351 | 8.1076 | 1.61007 | 64.27 | 0.54363 |
| | 18 | −164.9074 | 4.8570 | | | |
| | *19 | −123.4221 | 1.0137 | 1.85400 | 40.39 | 0.56774 |
| | *20 | −74.4221 | 3.2925 | | | |
| | 21 | −39.0215 | 0.6000 | 1.83174 | 23.41 | 0.62283 |
| | 22 | 25.5281 | 9.7892 | 1.71464 | 56.99 | 0.54249 |
| | 23 | −43.4014 | 12.3775 | | | |

TABLE 18
Example 5

| | |
|---|---|
| f | 15.60 |
| Bf | 12.38 |
| FNo. | 1.80 |
| 2 ωm[°] | 106.8 |

TABLE 19
Example 5

| | Infinity | \|β\| = 0.1 |
|---|---|---|
| DD6 | 1.5600 | 3.0519 |
| DD8 | 2.5152 | 1.0233 |

TABLE 20
Example 5

| Sn | 1 | 2 | 7 | 8 |
|---|---|---|---|---|
| KA | 1.0000000E+00 | 1.0000000E+00 | 1.0000000E+00 | 1.0000000E+00 |
| A4 | 1.9993455E−05 | 1.2574885E−05 | −1.8386035E−05 | −8.7585753E−06 |
| A6 | −6.2129387E−08 | −7.4389332E−08 | −7.0533279E−08 | −5.9871153E−08 |
| A8 | 1.2334559E−10 | 5.8950066E−11 | 3.8406279E−10 | 2.8597529E−10 |
| A10 | −1.4249333E−13 | −3.7266929E−14 | −1.8051937E−12 | −1.7918046E−12 |
| A12 | 5.9565033E−17 | 2.7180283E−17 | −1.3027240E−14 | −6.0898737E−15 |
| A14 | 5.2360489E−20 | −2.7640377E−19 | 9.0327176E−17 | 7.5914744E−17 |
| A16 | −5.7281327E−23 | 1.4654631E−21 | −3.3995350E−19 | −1.0214852E−19 |
| A18 | −3.4866334E−27 | −3.2278012E−24 | 2.7986735E−21 | −1.2611226E−21 |
| A20 | 1.3966383E−29 | 2.2378639E−27 | −1.3865938E−23 | 3.1783713E−24 |

| Sn | 13 | 14 |
|---|---|---|
| KA | 1.0000000E+00 | 1.0000000E+00 |
| A4 | 3.1407441E−06 | −1.7315088E−05 |
| A6 | −2.5625577E−08 | −1.5086698E−07 |
| A8 | −3.3191617E−10 | −4.0883393E−10 |
| A10 | −2.1912461E−13 | −1.5497653E−13 |

| Sn | 19 | 20 |
|---|---|---|
| KA | 2.2799995E+00 | 0.0000000E+00 |
| A4 | −3.5983481E−05 | 4.1309171E−05 |
| A6 | 1.2677135E−07 | 2.8366614E−07 |
| A8 | −4.6317329E−10 | 6.5276464E−10 |
| A10 | 5.5512850E−12 | −1.1260438E−11 |
| A12 | −3.0855454E−13 | −5.2177690E−14 |
| A14 | 3.7143107E−15 | 1.3860832E−15 |
| A16 | −1.7413909E−17 | −7.9578153E−18 |
| A18 | 2.9427483E−20 | 1.5104091E−20 |

### Example 6

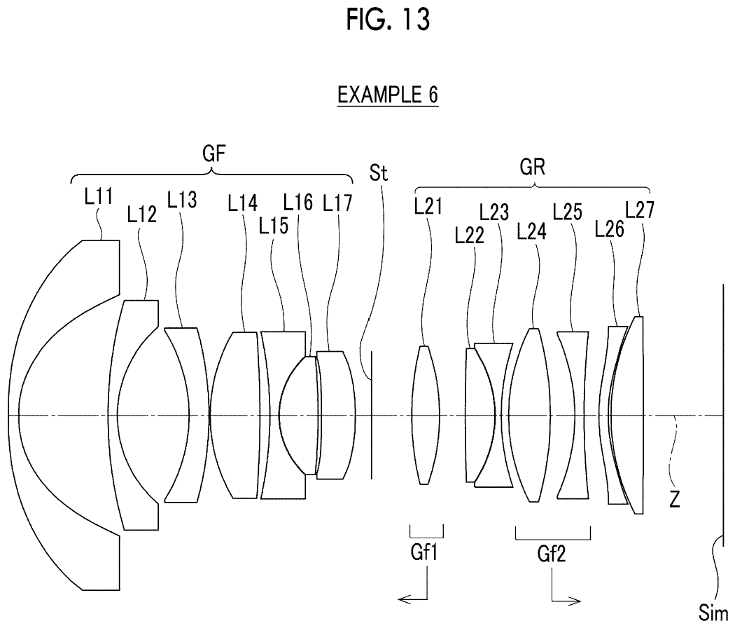

A cross-sectional view of a configuration of an imaging lens of Example 6 is shown in FIG. 13. The imaging lens of Example 6 consists of, in order from the object side to the image side, the front group GF having a negative refractive power, the aperture stop St, and the rear group GR having a positive refractive power. The rear group GR includes the first focus lens group Gf1 having a positive refractive power and the second focus lens group Gf2 having a positive refractive power.

The front group GF consists of seven lenses of the lenses L11 to L17 in order from the object side to the image side. The rear group GR consists of seven lenses of the lenses L21 to L27 in order from the object side to the image side. The first focus lens group Gf1 consists of the lens L21. The second focus lens group Gf2 consists of the lens L24 and the lens L25. During focusing from the infinite distance object to the closest object, the first focus lens group Gf1 moves to the object side, the second focus lens group Gf2 moves to the image side, and the other lenses and the aperture stop St are fixed with respect to the image plane Sim.

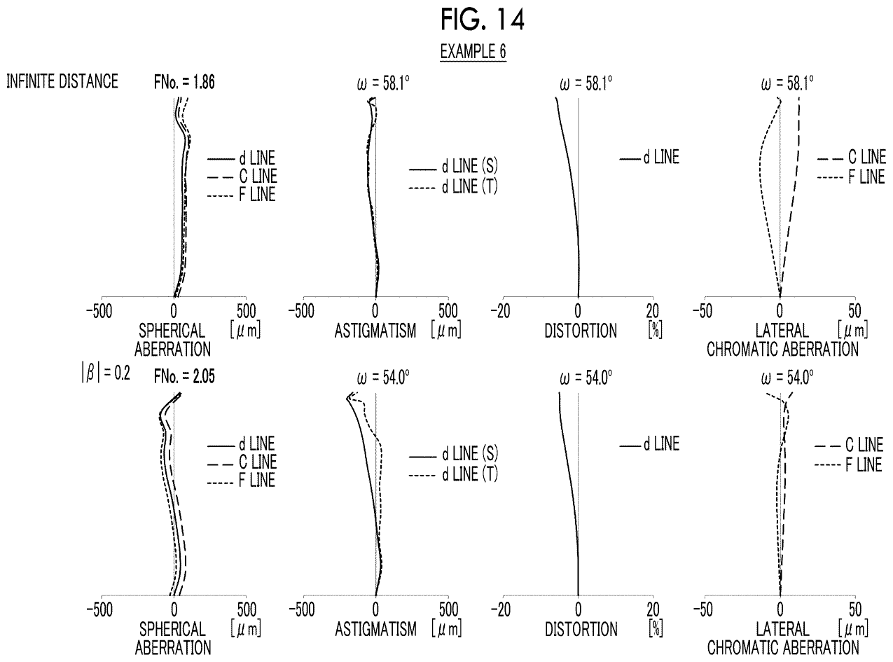

Regarding the imaging lens of Example 6, Table 21 shows basic lens data, Table 22 shows specifications, Table 23 shows a variable surface spacing, Table 24 shows an aspherical coefficient, and FIG. 14 shows each aberration diagram.

TABLE 21
Example 6

| | Sn | R | D | Nd | νd | θgF |
|---|---|---|---|---|---|---|
| | *1 | 253.0860 | 1.6441 | 1.59255 | 67.86 | 0.54402 |
| | *2 | 22.9148 | 14.3684 | | | |
| | 3.00 | 69.6374 | 1.5001 | 1.49782 | 82.57 | 0.53862 |
| | 4.00 | 19.5747 | 11.5451 | | | |
| | 5.0 | −26.8332 | 3.1944 | 2.00069 | 25.46 | 0.61402 |
| | 6 | −54.5934 | 0.2000 | | | |
| | 7 | 27.4609 | 8.0002 | 1.95906 | 17.47 | 0.65993 |
| | 8 | −184.0848 | 1.5970 | | | |
| | 9 | −66.2120 | 1.4998 | 2.00272 | 19.32 | 0.64514 |
| | 10 | 13.5139 | 6.2572 | 1.78472 | 25.72 | 0.61575 |
| | 11 | −104.7822 | 0.5364 | | | |
| | *12 | −367.6471 | 5.4487 | 1.69350 | 53.20 | 0.54661 |
| | *13 | −39.8323 | 2.4998 | | | |
| | 14(St) | ∞ | DD14 | | | |
| Gf1 | 15 | 48.6873 | 4.4790 | 1.49782 | 82.57 | 0.53862 |
| | 16 | −35.6699 | DD16 | | | |
| | 17 | 404.9254 | 4.7739 | 1.75500 | 52.32 | 0.54758 |
| | 18 | −20.1470 | 0.9998 | 1.80519 | 25.47 | 0.61013 |
| | 19 | 38.3794 | DD19 | | | |
| Gf2 | 20 | 32.1582 | 6.7169 | 1.95906 | 17.47 | 0.65993 |
| | 21 | −54.2385 | 3.9309 | | | |
| | 22 | −33.0812 | 1.5000 | 1.94595 | 17.98 | 0.65460 |
| | 23 | 138.0945 | DD23 | | | |
| | *24 | 33.4709 | 1.4998 | 2.00178 | 19.32 | 0.64480 |
| | *25 | 29.4136 | 0.4377 | | | |
| | 26 | 36.2857 | 5.1992 | 1.49700 | 81.61 | 0.53887 |
| | 27 | −2502.2529 | 12.8911 | | | |

TABLE 22
Example 6

| | |
|---|---|
| f | 14.33 |
| Bf | 12.89 |
| FNo. | 1.86 |
| 2 ωm[°] | 116.2 |

TABLE 23
Example 6

| | Infinity | \|β\| = 0.2 |
|---|---|---|
| DD14 | 6.4852 | 0.9998 |
| DD16 | 4.1539 | 9.6393 |
| DD19 | 1.1826 | 2.3352 |
| DD23 | 2.3749 | 1.2224 |

TABLE 24
Example 6

| Sn | 1 | 2 | 12 | 13 |
|---|---|---|---|---|
| KA | 1.0000000E+00 | 4.0600000E−01 | 1.0000000E+00 | 1.0000000E+00 |
| A3 | 1.1130668E−03 | 1.2355283E−03 | 5.4426952E−06 | 1.9495327E−05 |
| A4 | −6.2587431E−05 | −8.6403921E−05 | −6.4900732E−05 | −4.7043410E−05 |
| A5 | 1.6420705E−06 | 5.0168904E−06 | 3.1258788E−06 | 2.2934277E−06 |
| A6 | 8.0545594E−09 | −5.3468296E−08 | −3.7323113E−07 | −1.1450915E−07 |
| A7 | −4.4379146E−10 | −7.3606539E−09 | −3.3572361E−08 | −3.0010602E−08 |
| A8 | −2.1185776E−11 | 1.3697219E−10 | 1.7899206E−09 | −4.1505449E−10 |
| A9 | −1.8619370E−13 | 1.0363163E−11 | 4.7911870E−10 | 2.1419421E−10 |
| A10 | 9.7165205E−15 | 4.1664157E−13 | 2.7880129E−12 | 2.3350095E−11 |
| A11 | 4.4566405E−16 | 3.6693552E−14 | −2.3630100E−12 | −5.2240307E−14 |
| A12 | 9.7695746E−18 | −2.4111329E−15 | −2.0579060E−13 | −1.5291380E−13 |
| A13 | 3.9029560E−19 | −6.7763851E−17 | −2.2199812E−14 | −1.5392586E−14 |
| A14 | −4.6853534E−21 | −5.1863163E−18 | −1.2108694E−17 | −8.7851057E−16 |
| A15 | −5.3246923E−22 | −1.5674241E−19 | 8.8196010E−17 | 4.6836703E−17 |
| A16 | −1.7559303E−23 | 1.0634566E−20 | 9.1150678E−18 | −2.1079173E−18 |
| A17 | 3.1028116E−26 | 8.7449991E−22 | 2.1984064E−18 | 1.7600108E−18 |
| A18 | 5.2139237E−27 | 3.8306770E−23 | 9.3088443E−20 | 1.5191194E−20 |
| A19 | 2.7109218E−28 | 5.6327679E−25 | −3.1785582E−21 | −6.0163279E−22 |
| A20 | 1.9039970E−30 | −1.4766374E−25 | −1.8615683E−21 | −5.5510394E−22 |

| Sn | 24 | 25 |
|---|---|---|
| KA | 1.0000000E+00 | 1.0000000E+00 |
| A3 | 2.1066405E−04 | 2.5555599E−04 |
| A4 | −2.0376113E−05 | −9.2662367E−06 |
| A5 | −3.6939741E−06 | −2.5309496E−06 |
| A6 | −6.2465311E−08 | −3.9899943E−08 |
| A7 | 9.0613569E−09 | −2.1221607E−08 |
| A8 | 4.5558989E−11 | 2.6643082E−09 |
| A9 | −9.6130056E−12 | 7.3982213E−11 |
| A10 | −1.4168502E−12 | −1.7758617E−11 |
| A11 | 7.1490824E−14 | 2.8448624E−13 |
| A12 | 8.7965864E−15 | 4.8141043E−14 |
| A13 | 4.1777386E−16 | −3.1801329E−16 |
| A14 | 4.6122217E−17 | −5.0713331E−18 |
| A15 | 9.3573610E−20 | −5.8929155E−18 |
| A16 | −1.4334552E−19 | −1.7749326E−19 |
| A17 | −2.3616664E−20 | −1.4187355E−22 |
| A18 | −1.1890302E−21 | 2.4768075E−22 |
| A19 | −3.7672214E−23 | 1.8836036E−23 |
| A20 | 9.7211149E−24 | 1.1689402E−24 |

### Example 7

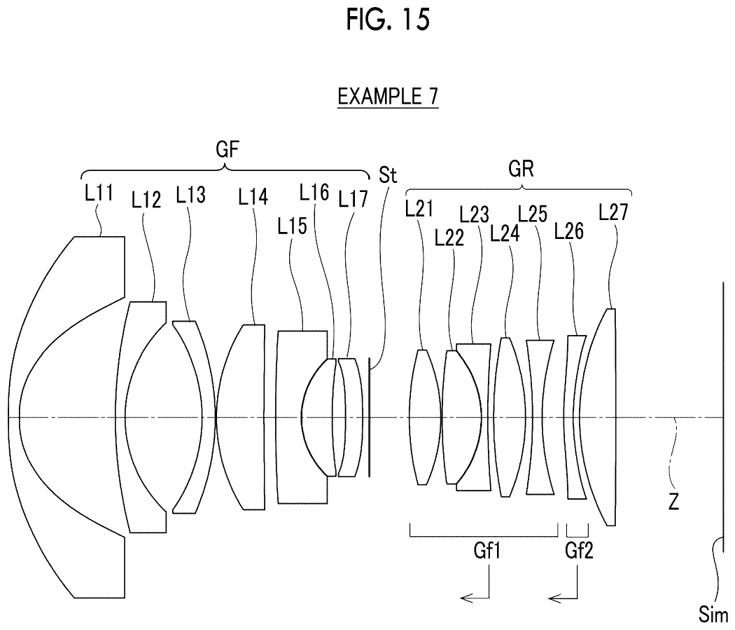

A cross-sectional view of a configuration of an imaging lens of Example 7 is shown in FIG. 15. The imaging lens of Example 7 consists of, in order from the object side to the image side, the front group GF having a negative refractive power, the aperture stop St, and the rear group GR having a positive refractive power. The rear group GR includes the first focus lens group Gf1 having a positive refractive power and the second focus lens group Gf2 having a negative refractive power.

The front group GF consists of seven lenses of the lenses L11 to L17 in order from the object side to the image side. The rear group GR consists of seven lenses of the lenses L21 to L27 in order from the object side to the image side. The first focus lens group Gf1 consists of five lenses of the lenses L21 to L25. The second focus lens group Gf2 consists of the lens L26. During focusing from the infinite distance object to the closest object, the first focus lens group Gf1 moves to the object side, the second focus lens group Gf2 moves to the object side, and the other lenses and the aperture stop St are fixed with respect to the image plane Sim.

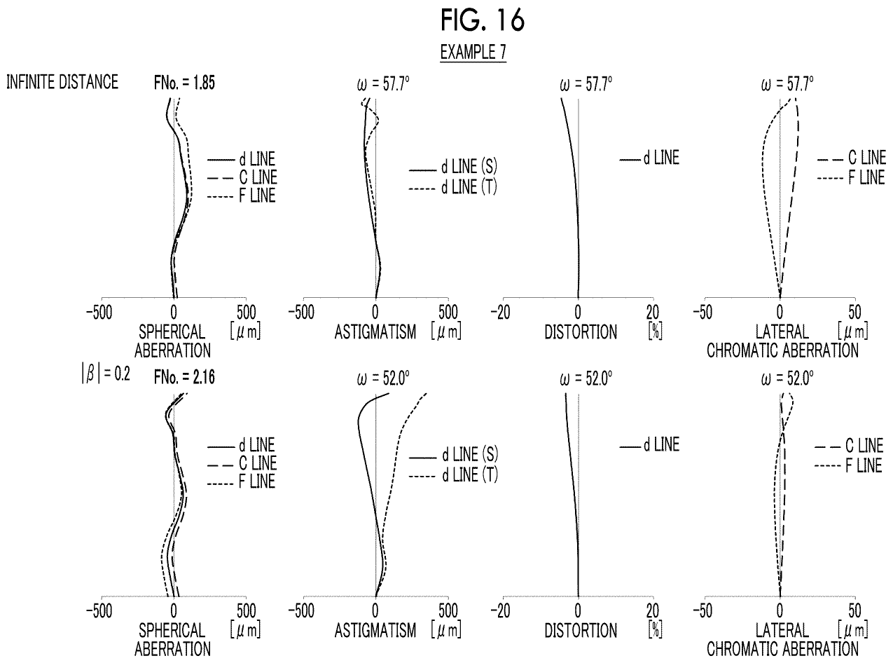

Regarding the imaging lens of Example 7, Table 25 shows basic lens data, Table 26 shows specifications, Table 27 shows a variable surface spacing, Table 28 shows an aspherical coefficient, and FIG. 16 shows each aberration diagram.

TABLE 25
Example 7

| | Sn | R | D | Nd | νd | θgF |
|---|---|---|---|---|---|---|
| | *1 | −3174.4914 | 1.6894 | 1.59255 | 67.86 | 0.54402 |
| | *2 | 21.7916 | 15.0001 | | | |
| | 3.00 | 75.3141 | 1.4998 | 1.55032 | 75.50 | 0.54001 |
| | 4.00 | 21.1391 | 12.0298 | | | |
| | 5.0 | −26.3054 | 2.0431 | 1.96300 | 24.11 | 0.62126 |
| | 6 | −39.5668 | 0.1998 | | | |
| | 7 | 28.3348 | 7.4097 | 2.00100 | 29.12 | 0.59962 |
| | 8 | 845.5264 | 1.8120 | | | |
| | 9 | 242.1418 | 4.0457 | 1.95000 | 29.37 | 0.60018 |
| | 10 | 13.0410 | 4.7915 | 1.90366 | 31.31 | 0.59481 |
| | 11 | 66.9878 | 2.0730 | | | |
| | *12 | −116.7635 | 2.6829 | 2.00178 | 19.32 | 0.64480 |
| | *13 | −73.5638 | 1.0002 | | | |
| | 14(St) | ∞ | DD14 | | | |
| Gf1 | 15 | 43.5445 | 4.9187 | 1.49700 | 81.54 | 0.53748 |
| | 16 | −27.0599 | 0.2001 | | | |
| | 17 | 77.3867 | 6.1332 | 1.59319 | 67.90 | 0.54402 |
| | 18 | −16.5585 | 0.9998 | 1.89286 | 20.36 | 0.63944 |
| | 19 | 142.5675 | 0.9147 | | | |
| | 20 | 68.7180 | 4.9735 | 1.98613 | 16.48 | 0.66558 |
| | 21 | −33.7976 | 1.0921 | | | |
| | 22 | −77.8112 | 1.5000 | 1.75520 | 27.54 | 0.60916 |
| | 23 | 41.6592 | DD23 | | | |
| Gf2 | *24 | 46.3820 | 1.4998 | 2.00178 | 19.32 | 0.64480 |
| | *25 | 34.3031 | DD25 | | | |
| | 26 | 37.5013 | 5.6326 | 1.51741 | 52.16 | 0.56212 |
| | 27 | −2502.2502 | 16.8043 | | | |

TABLE 26
Example 7

| | |
|---|---|
| f | 14.32 |
| Bf | 16.80 |
| FNo. | 1.85 |
| 2 ωm[°] | 115.4 |

TABLE 27
Example 7

| | Infinity | \|β\| = 0.2 |
|---|---|---|
| DD14 | 6.1826 | 1.0000 |
| DD23 | 3.3508 | 6.3233 |
| DD25 | 1.0002 | 3.2104 |

TABLE 28
Example 7

| Sn | 1 | 2 | 12 | 13 |
|---|---|---|---|---|
| KA | 1.0000000E+00 | 4.0600000E−01 | 1.0000000E+00 | 1.0000000E+00 |
| A3 | 1.4563389E−03 | 1.6008774E−03 | −1.4599114E−05 | −2.2404316E−05 |
| A4 | −6.9947357E−05 | −9.1708750E−05 | −8.7310910E−05 | −7.0097779E−05 |
| A5 | 1.2168197E−06 | 5.3874617E−06 | −4.2061533E−06 | 5.6728352E−07 |
| A6 | 6.8181833E−09 | −1.0978214E−07 | 2.1374328E−07 | −2.2242780E−07 |
| A7 | −3.6153583E−11 | −4.9388725E−09 | 2.9826892E−09 | 2.0723585E−09 |
| A8 | −7.1433582E−12 | 1.6577604E−10 | −8.0949140E−11 | −3.7955800E−10 |
| A9 | −1.1746748E−13 | 5.1098055E−12 | 6.7385417E−12 | 1.1219073E−10 |
| A10 | −7.9226931E−16 | 1.1871981E−13 | −2.5193629E−11 | 2.5956705E−11 |
| A11 | −3.2027709E−17 | 2.3059248E−14 | −2.7171998E−12 | −1.6004919E−12 |
| A12 | −1.5454775E−18 | −7.9306601E−16 | 5.4064605E−14 | 6.0387446E−14 |
| A13 | 2.1148757E−19 | −2.9466919E−17 | 2.6222856E−14 | −2.0435544E−14 |
| A14 | 9.3924198E−21 | −2.6166184E−18 | 4.7464588E−15 | −1.3225203E−15 |
| A15 | −2.6128168E−23 | −5.9878467E−20 | 2.0183063E−16 | −3.4496975E−17 |
| A16 | −4.1274720E−24 | −1.3351742E−21 | −1.8782731E−17 | 2.1906678E−17 |
| A17 | −1.3695846E−25 | 4.9862404E−22 | −1.2524000E−18 | 1.0867489E−18 |
| A18 | −5.7439281E−27 | 1.4794166E−23 | −5.4006682E−19 | 1.0470313E−20 |
| A19 | −2.0651520E−29 | 5.8534049E−25 | −1.7126952E−20 | 2.1519045E−21 |
| A20 | 6.5777134E−30 | −7.5648251E−26 | 4.7552657E−21 | −1.1615399E−21 |

| Sn | 24 | 25 |
|---|---|---|
| KA | 1.0000000E+00 | 1.0000000E+00 |
| A3 | −1.0009845E−05 | 6.6405444E−06 |
| A4 | −6.9989291E−05 | −6.2161635E−05 |
| A5 | 1.1868054E−07 | 1.5665398E−06 |
| A6 | 1.2834279E−07 | 1.5607171E−07 |
| A7 | 8.0814696E−09 | −1.6495471E−08 |
| A8 | 6.9716325E−11 | 2.4323067E−09 |
| A9 | −1.1672544E−11 | 3.7747028E−11 |
| A10 | −3.0045845E−12 | −1.8904887E−11 |
| A11 | −1.5910189E−14 | 2.0535199E−13 |
| A12 | 5.5310605E−16 | 4.9533539E−14 |
| A13 | 5.7007644E−16 | −1.3977011E−16 |
| A14 | 3.3720303E−17 | 1.6062079E−17 |
| A15 | 1.9725817E−18 | −7.0853184E−18 |
| A16 | 3.4079027E−19 | −2.0082047E−19 |
| A17 | −6.5202762E−20 | 2.1461368E−21 |
| A18 | −1.8661772E−21 | −3.5099980E−22 |
| A19 | −5.1655794E−23 | 6.0433112E−23 |
| A20 | 1.9095233E−23 | 2.2607772E−24 |

### Example 8

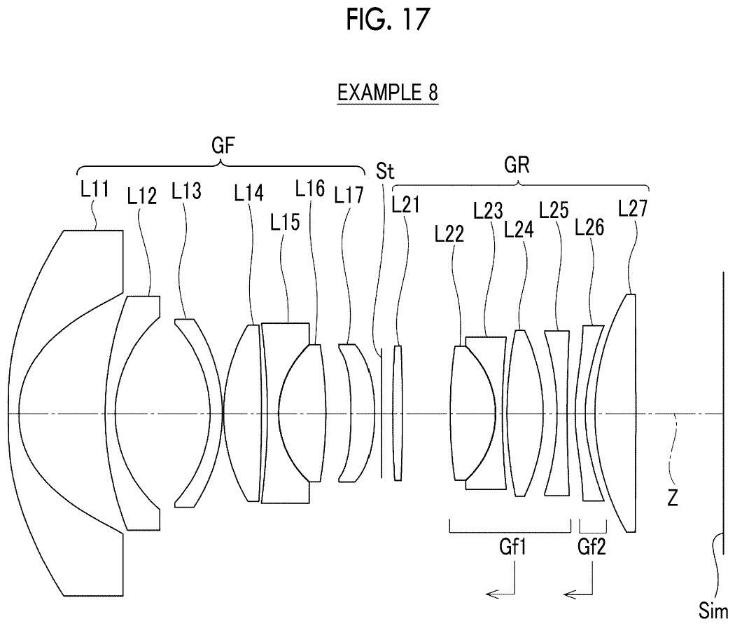

A cross-sectional view of a configuration of an imaging lens of Example 8 is shown in FIG. 17. The imaging lens of Example 8 consists of, in order from the object side to the image side, the front group GF having a positive refractive power, the aperture stop St, and the rear group GR having a positive refractive power. The rear group GR includes the first focus lens group Gf1 having a positive refractive power and the second focus lens group Gf2 having a negative refractive power.

The front group GF consists of seven lenses of the lenses L11 to L17 in order from the object side to the image side. The rear group GR consists of seven lenses of the lenses L21 to L27 in order from the object side to the image side. The first focus lens group Gf1 consists of four lenses of the lenses L22 to L25. The second focus lens group Gf2 consists of the lens L26. During focusing from the infinite distance object to the closest object, the first focus lens group Gf1 moves to the object side, the second focus lens group Gf2 moves to the object side, and the other lenses and the aperture stop St are fixed with respect to the image plane Sim.

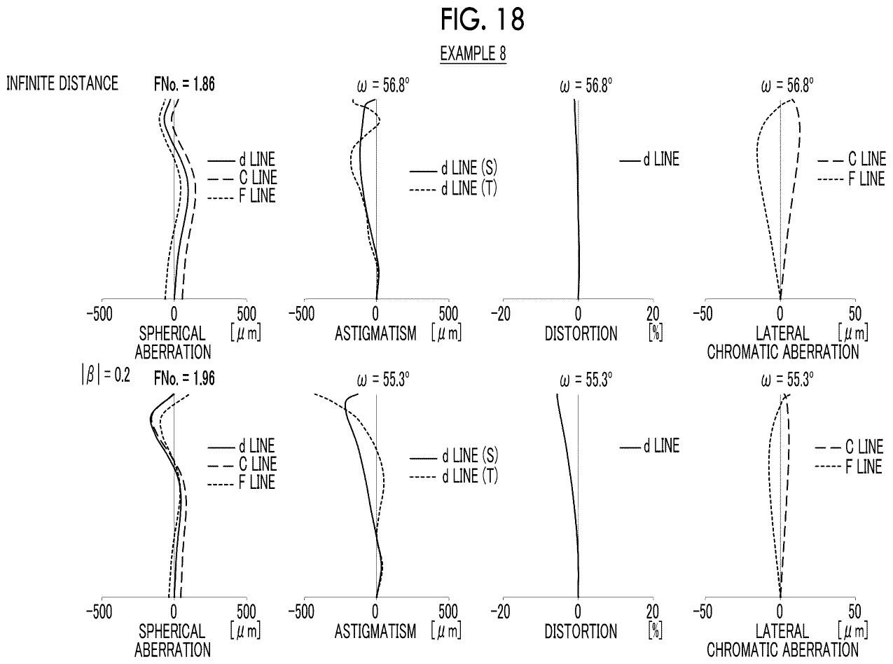

Regarding the imaging lens of Example 8, Table 29 shows basic lens data, Table 30 shows specifications, Table 31 shows a variable surface spacing, Table 32 shows an aspherical coefficient, and FIG. 18 shows each aberration diagram.

TABLE 29
Example 8

| | Sn | R | D | Nd | νd | θgF |
|---|---|---|---|---|---|---|
| | *1 | −204.8326 | 1.5643 | 1.59245 | 66.92 | 0.53588 |
| | *2 | 20.9468 | 12.8861 | | | |
| | 3.00 | 50.1972 | 1.5001 | 1.53775 | 74.70 | 0.53936 |
| | 4.00 | 19.6970 | 14.1597 | | | |
| | 5.0 | −20.5021 | 1.8200 | 1.95906 | 17.47 | 0.65993 |
| | 6 | −26.6408 | 0.2046 | | | |
| | 7 | 27.0619 | 5.6502 | 2.00272 | 19.32 | 0.64514 |
| | 8 | −229.0228 | 0.8665 | | | |
| | 9 | −109.1147 | 1.6951 | 2.00171 | 20.66 | 0.63472 |
| | 10 | 14.3882 | 7.0439 | 1.79504 | 28.69 | 0.60656 |
| | 11 | −65.7418 | 3.7498 | | | |
| | *12 | −73.2229 | 3.4536 | 1.63860 | 63.43 | 0.54267 |
| | *13 | −32.2769 | 0.9998 | | | |
| | 14(St) | ∞ | 1.6959 | | | |
| | 15 | 181.2799 | 1.4362 | 1.49700 | 81.55 | 0.53837 |
| | 16 | −305.8085 | DD16 | | | |
| Gf1 | 17 | 74.9138 | 6.7740 | 1.74099 | 52.71 | 0.54828 |
| | 18 | −14.0868 | 1.0000 | 1.90682 | 21.17 | 0.63332 |
| | 19 | 111.5231 | 0.6998 | | | |
| | 20 | 64.1741 | 5.4060 | 1.98613 | 16.48 | 0.66558 |
| | 20 | −30.3433 | 2.0725 | | | |
| | 22 | −41.9258 | 1.5018 | 2.00680 | 26.19 | 0.61034 |
| | 23 | 246.7622 | DD23 | | | |
| Gf2 | *24 | 30.8587 | 1.4998 | 2.00178 | 19.32 | 0.64480 |
| | *25 | 24.0078 | DD25 | | | |
| | 26 | 37.6745 | 6.1007 | 1.49710 | 81.56 | 0.53848 |
| | 27 | −2500.4530 | 13.0901 | | | |

TABLE 30
Example 8

| | |
|---|---|
| f | 14.33 |
| Bf | 13.09 |
| FNo. | 1.86 |
| 2 ωm[°] | 113.6 |

TABLE 31
Example 8

| | Infinity | \|β\| = 0.2 |
|---|---|---|
| DD16 | 7.1426 | 1.0798 |
| DD23 | 1.2009 | 4.7625 |
| DD25 | 1.4455 | 3.9467 |

TABLE 32
Example 8

| Sn | 1 | 2 | 12 | 13 |
|---|---|---|---|---|
| KA | 1.0000000E+00 | 4.0600000E−01 | 1.0000000E+00 | 1.0000000E+00 |
| A3 | 1.5044687E−03 | 1.6081235E−03 | −1.7640046E−05 | −2.5520752E−05 |
| A4 | −6.0576478E−05 | −7.9112763E−05 | −6.5268221E−05 | −5.0505602E−05 |
| A5 | 6.9751108E−07 | 5.0059544E−06 | −2.6967134E−06 | −1.4764539E−06 |
| A6 | 4.1814259E−09 | −6.6975551E−08 | 5.7533126E−08 | −6.1887626E−08 |
| A7 | 1.8527978E−10 | −6.0533816E−09 | −1.2846159E−08 | −3.5520413E−09 |
| A8 | −1.4535789E−12 | 4.6332939E−11 | −5.7255052E−10 | −1.5741549E−10 |
| A9 | −1.7102833E−14 | 5.3784519E−12 | 8.2329345E−11 | −4.5134372E−11 |
| A10 | −6.5810610E−15 | 5.8400260E−14 | −6.6264522E−12 | 1.4347703E−12 |
| A11 | 2.9472381E−18 | 2.4874264E−14 | −6.4285488E−14 | −9.2611065E−14 |
| A12 | −6.4089527E−18 | −3.4486617E−16 | 6.7921826E−15 | 4.6762694E−14 |
| A13 | 1.9824580E−19 | −4.8310785E−17 | −1.1460733E−14 | −5.3010879E−15 |
| A14 | 6.5099419E−21 | −1.9393760E−18 | 8.1484393E−16 | 1.1867052E−16 |
| A15 | 3.9348857E−23 | −8.1019554E−21 | −2.7941110E−17 | 2.2170850E−17 |
| A16 | −1.1860135E−24 | 3.2433331E−21 | −5.0637487E−18 | −5.8770524E−18 |
| A17 | −2.4146505E−26 | 3.0522459E−22 | 9.3564553E−19 | 8.0662016E−19 |
| A18 | −5.3874387E−27 | 1.4764503E−23 | −2.8165811E−20 | −7.6034462E−20 |
| A19 | −5.3090227E−29 | 2.2998455E−26 | 3.2264667E−21 | −2.9652175E−22 |
| A20 | 3.7120679E−30 | −8.5816190E−26 | −6.0711217E−22 | 2.1114696E−22 |

| Sn | 24 | 25 |
|---|---|---|
| KA | 1.0000000E+00 | 1.0000000E+00 |
| A3 | −7.1438812E−05 | −4.8369974E−05 |
| A4 | −6.9026933E−05 | −6.8048213E−05 |
| A5 | −1.4996373E−06 | 7.6267858E−07 |
| A6 | 1.5912017E−07 | 1.0872940E−07 |
| A7 | 8.0102885E−09 | −1.4955092E−08 |
| A8 | 3.3871384E−11 | 2.5405486E−09 |
| A9 | −1.3283033E−11 | 5.0008904E−11 |
| A10 | −9.2870055E−13 | −1.8572239E−11 |
| A11 | −2.5498514E−14 | 1.4280146E−13 |
| A12 | −2.1515520E−16 | 4.3960302E−14 |
| A13 | 6.9513946E−17 | −4.1708494E−16 |
| A14 | 1.0192396E−17 | 2.6872017E−18 |
| A15 | 1.5102577E−19 | −4.8558048E−18 |
| A16 | −8.2001206E−20 | −1.0490368E−19 |
| A17 | −9.8363016E−21 | 3.6267694E−21 |
| A18 | −8.6236872E−22 | 4.9802507E−22 |
| A19 | 2.1488100E−23 | −1.4380110E−24 |
| A20 | 6.4185642E−24 | 1.3447606E−24 |

### Example 9

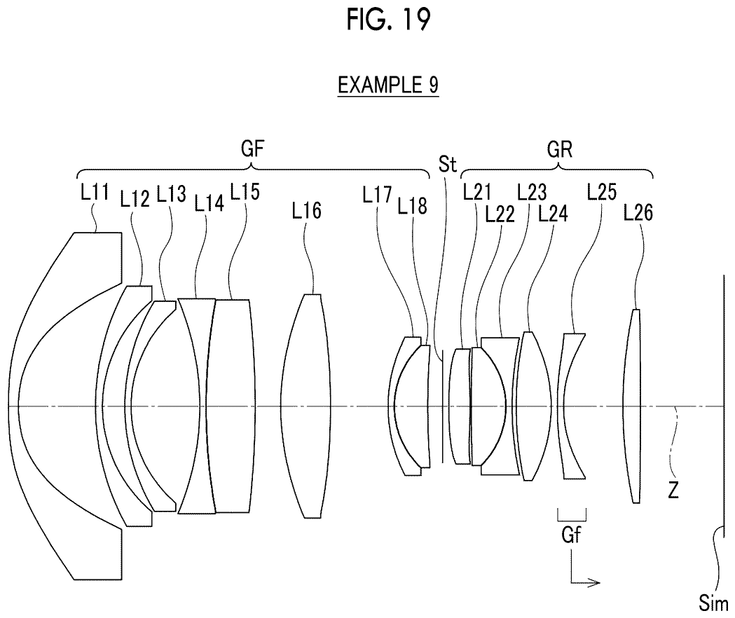

A cross-sectional view of a configuration of an imaging lens of Example 9 is shown in FIG. 19. The imaging lens of Example 9 consists of, in order from the object side to the image side, the front group GF having a positive refractive power, the aperture stop St, and the rear group GR having a positive refractive power. The rear group GR includes a single focus lens group Gf having a negative refractive power.

The front group GF consists of eight lenses of the lenses L11 to L18 in order from the object side to the image side.

The rear group GR consists of six lenses of the lenses L21 to L26 in order from the object side to the image side. The single focus lens group Gf consists of the lens L25. During focusing from the infinite distance object to the closest object, the single focus lens group Gf moves to the image side, and the other lenses and the aperture stop St are fixed with respect to the image plane Sim.

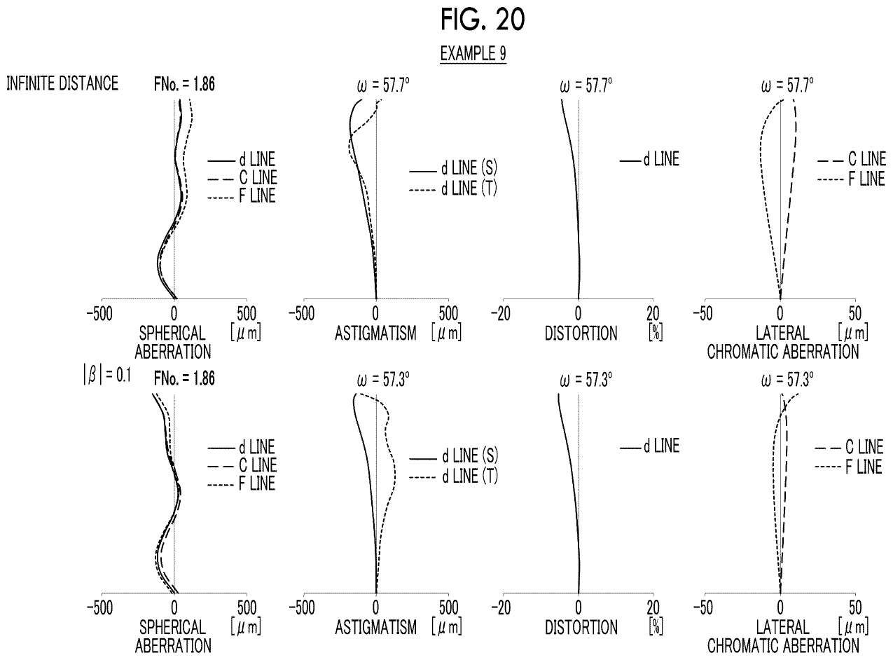

Regarding the imaging lens of Example 9, Table 33 shows basic lens data, Table 34 shows specifications, Table 35 shows a variable surface spacing, Table 36 shows an aspherical coefficient, and FIG. 20 shows each aberration diagram.

TABLE 33
Example 9

| | Sn | R | D | Nd | νd | θgF |
|---|---|---|---|---|---|---|
| | *1 | 125.9915 | 1.6003 | 1.67798 | 54.89 | 0.54485 |
| | *2 | 23.9400 | 12.3837 | | | |
| | 3.00 | 41.8754 | 1.1133 | 1.75500 | 52.32 | 0.54758 |
| | 4.00 | 23.1419 | 3.6031 | | | |
| | 5.0 | 34.0051 | 1.0001 | 1.75500 | 52.32 | 0.54757 |
| | 6 | 21.4619 | 11.0474 | | | |
| | 7 | −46.4461 | 1.0102 | 1.49782 | 82.57 | 0.53862 |
| | 8 | 99.6689 | 7.8755 | 1.92286 | 18.90 | 0.64960 |
| | 9 | −158.0246 | 4.1086 | | | |
| | *10 | 43.2303 | 8.0000 | 1.88660 | 34.95 | 0.58238 |
| | *11 | −115.9832 | 9.1672 | | | |
| | 12 | 25.4254 | 1.0002 | 1.95906 | 17.47 | 0.65993 |
| | 13 | 14.1263 | 5.3734 | 1.49700 | 81.60 | 0.53774 |
| | 14 | 133.7387 | 2.3811 | | | |
| | 15(St) | ∞ | 1.0001 | | | |
| | *16 | 74.1547 | 3.4239 | 1.72963 | 54.07 | 0.54444 |
| | *17 | −77.9419 | 0.2000 | | | |
| | 18 | 402.3090 | 5.5490 | 1.60300 | 65.44 | 0.53901 |
| | 19 | −13.9992 | 1.0000 | 1.84666 | 23.78 | 0.62054 |
| | 20 | 54.5654 | 0.6585 | | | |
| | 21 | 60.3171 | 5.6118 | 1.95906 | 17.47 | 0.65993 |
| | 22 | −26.0218 | DD22 | | | |
| Gf | *23 | 58.5199 | 1.0002 | 1.88202 | 37.22 | 0.57699 |
| | *24 | 21.8012 | DD24 | | | |
| | 25 | 78.2562 | 2.8101 | 1.49710 | 81.56 | 0.53848 |
| | 26 | −955.4712 | 13.4455 | | | |

TABLE 34
Example 9

| | |
|---|---|
| f | 14.32 |
| Bf | 13.45 |
| FNo. | 1.86 |
| 2 ωm[°] | 115.4 |

TABLE 35
Example 9

| | Infinity | \|β\| = 0.1 |
|---|---|---|
| DD22 | 1.0000 | 2.0437 |
| DD24 | 9.5386 | 8.4949 |

TABLE 36
Example 9

| Sn | 1 | 2 | 10 | 11 |
|---|---|---|---|---|
| KA | 1.0000000E+00 | 1.0000000E+00 | 1.0000000E+00 | 1.0000000E+00 |
| A3 | 5.8243364E−04 | 5.6296992E−04 | −1.1597039E−05 | −2.2244300E−06 |
| A4 | 6.8406989E−06 | 1.7177135E−05 | −8.5158524E−07 | −1.5976539E−06 |
| A5 | −3.5263439E−07 | −8.8391527E−07 | −1.5301126E−07 | −1.6877820E−08 |
| A6 | −3.6796717E−08 | 5.6980418E−08 | −2.4278588E−10 | −1.3767010E−09 |
| A7 | 2.8956325E−10 | 7.4818749E−10 | 1.2631336E−10 | −8.8628408E−12 |
| A8 | 3.6012519E−11 | −2.2712726E−10 | 5.2319118E−12 | 2.1193378E−12 |
| A9 | 2.8202647E−13 | 4.9845163E−13 | 9.4124109E−14 | 1.2635048E−13 |
| A10 | 2.6390132E−15 | 2.8937199E−14 | −2.6779354E−15 | 4.1336709E−15 |
| A11 | −4.3632820E−16 | −2.2930969E−15 | −3.4596045E−16 | 6.1797205E−17 |
| A12 | −3.2569955E−17 | 6.6386207E−16 | −1.8032082E−17 | −2.0663461E−18 |
| A13 | −3.0917492E−19 | −5.4104560E−18 | −6.2728858E−19 | −1.7215046E−19 |
| A14 | −1.1611878E−21 | 3.3402545E−19 | −7.8237225E−21 | −8.8464827E−21 |
| A15 | 9.8642854E−22 | −3.0182838E−21 | 9.4568627E−22 | −2.5477575E−22 |
| A16 | 1.0264474E−23 | 5.5820531E−22 | 1.0828108E−22 | 1.9687167E−24 |
| A17 | 1.1124620E−24 | 1.9346167E−23 | 7.1723824E−24 | 1.0085214E−24 |
| A18 | 2.0843602E−26 | −1.0166546E−23 | 3.6109703E−25 | 1.3436712E−25 |
| A19 | −4.5993706E−27 | 1.0032321E−25 | 1.1350025E−26 | 1.2033175E−26 |
| A20 | 7.9672639E−29 | 5.4716231E−27 | −1.7266041E−28 | 1.0885826E−27 |

| Sn | 16 | 17 | 23 | 24 |
|---|---|---|---|---|
| KA | 1.0000000E+00 | 1.0000000E+00 | 1.0000000E+00 | 1.0000000E+00 |
| A3 | 9.1804611E−05 | 3.0390417E−05 | 1.4294705E−04 | 1.4302981E−04 |
| A4 | 1.3646433E−05 | 3.6170671E−05 | 2.1702862E−05 | 3.6011878E−05 |
| A5 | 1.6547977E−06 | 6.4788016E−06 | −2.6461004E−06 | −2.9607187E−06 |
| A6 | 2.5005463E−07 | −4.9968438E−07 | −5.7752956E−08 | −1.5321073E−07 |
| A7 | 8.3309977E−09 | −3.4780827E−08 | −8.2189277E−09 | −6.7527960E−09 |
| A8 | −7.3335615E−10 | 3.5958354E−09 | −2.9945976E−10 | 1.2739858E−09 |
| A9 | −1.1251316E−10 | 4.8602806E−10 | 8.1569145E−11 | 9.3705590E−11 |
| A10 | −5.0899075E−12 | 2.8421117E−11 | 1.2383812E−11 | −7.2168253E−12 |
| A11 | 6.4408943E−13 | −7.2184845E−13 | 4.1273585E−13 | −1.7078377E−15 |
| A12 | 8.6990091E−14 | −3.8174580E−13 | −3.1728148E−13 | −9.2864783E−14 |
| A13 | 9.1760639E−15 | −4.1860961E−14 | −3.1176326E−15 | −2.5635002E−15 |
| A14 | 2.1818308E−16 | −3.1396625E−15 | 3.4197575E−15 | 1.3736879E−15 |
| A15 | −6.5084741E−17 | −3.0095963E−17 | −2.8600608E−17 | 3.6292380E−18 |
| A16 | −1.0233760E−17 | 6.6536581E−17 | −1.8752197E−17 | −6.5661086E−18 |
| A17 | −1.3077558E−19 | 5.6307543E−18 | 1.1594651E−19 | 4.9135708E−20 |
| A18 | 8.5083057E−20 | −4.7814112E−19 | 6.2677146E−20 | 1.3264835E−20 |
| A19 | 2.3139214E−21 | 2.9462918E−20 | 6.0639339E−22 | −2.7749446E−22 |
| A20 | −1.9245210E−22 | −3.3205792E−21 | −1.4060995E−22 | 2.2862951E−24 |

### Example 10

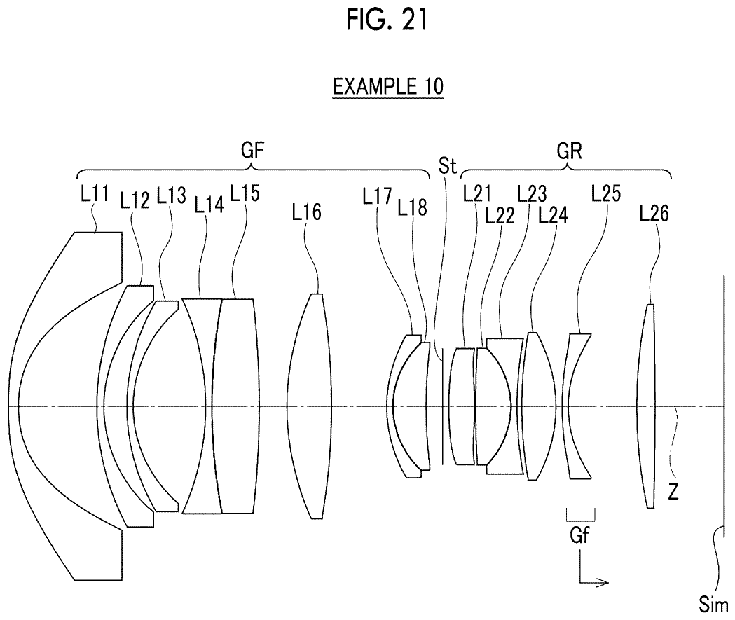

A cross-sectional view of a configuration of an imaging lens of Example 10 is shown in FIG. 21. The imaging lens of Example 10 consists of, in order from the object side to the image side, the front group GF having a positive refractive power, the aperture stop St, and the rear group GR having a positive refractive power. The rear group GR includes a single focus lens group Gf having a negative refractive power.

The front group GF consists of eight lenses of the lenses L11 to L18 in order from the object side to the image side. The rear group GR consists of six lenses of the lenses L21 to L26 in order from the object side to the image side. The single focus lens group Gf consists of the lens L25. During focusing from the infinite distance object to the closest object, the single focus lens group Gf moves to the image side, and the other lenses and the aperture stop St are fixed with respect to the image plane Sim.

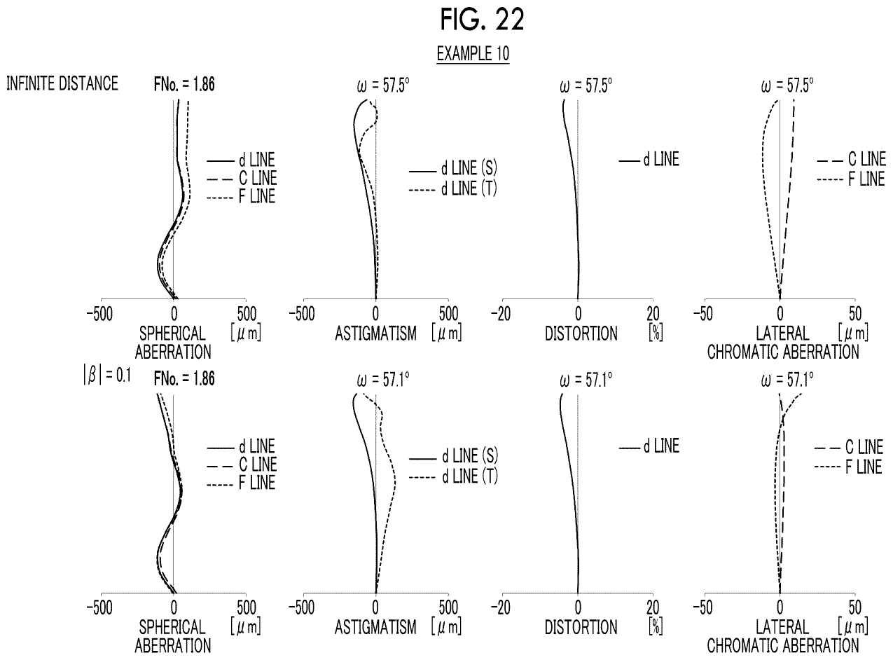

Regarding the imaging lens of Example 10, Table 37 shows basic lens data, Table 38 shows specifications, Table 39 shows a variable surface spacing, Table 40 shows an aspherical coefficient, and FIG. 22 shows each aberration diagram.

TABLE 37
Example 10

| | Sn | R | D | Nd | νd | θgF |
|---|---|---|---|---|---|---|
| | *1 | 111.3655 | 1.6050 | 1.69343 | 53.30 | 0.54756 |
| | *2 | 23.7870 | 12.6010 | | | |
| | 3.00 | 43.3986 | 1.1193 | 1.74100 | 52.77 | 0.54714 |
| | 4.00 | 23.1748 | 3.7057 | | | |
| | 5.0 | 34.5849 | 1.0002 | 1.72916 | 54.66 | 0.54352 |
| | 6 | 21.3824 | 11.6494 | | | |
| | 7 | −43.6376 | 1.0102 | 1.49782 | 82.57 | 0.53862 |
| | 8 | 97.0214 | 7.6021 | 1.92286 | 20.88 | 0.63900 |
| | 9 | −156.5978 | 4.4445 | | | |
| | *10 | 43.6664 | 7.1615 | 1.88259 | 37.18 | 0.57775 |
| | *11 | −121.3563 | 8.7933 | | | |
| | 12 | 23.5671 | 1.0001 | 2.00272 | 19.32 | 0.64514 |
| | 13 | 14.5439 | 5.3248 | 1.52841 | 76.45 | 0.53954 |
| | 14 | 83.3686 | 2.6599 | | | |
| | 15(St) | ∞ | 1.0001 | | | |
| | *16 | 69.9954 | 4.0985 | 1.69560 | 59.05 | 0.54348 |
| | *17 | −70.6428 | 0.2000 | | | |
| | 18 | 172.3749 | 5.6533 | 1.56907 | 71.30 | 0.54432 |
| | 19 | −14.0470 | 1.0001 | 1.90682 | 21.17 | 0.63332 |
| | 20 | 63.3997 | 0.7666 | | | |
| | 21 | 73.7499 | 5.4739 | 1.98613 | 16.48 | 0.66558 |
| | 22 | −25.2477 | DD22 | | | |
| Gf | *23 | 53.6125 | 1.0002 | 1.88202 | 37.22 | 0.57699 |
| | *24 | 21.3215 | DD24 | | | |
| | 25 | 85.2563 | 2.9047 | 1.49710 | 81.56 | 0.53848 |
| | 26 | −735.8034 | 11.1138 | | | |

TABLE 38
Example 10

| | |
|---|---|
| f | 14.32 |
| Bf | 11.11 |
| FNo. | 1.86 |
| 2 ωm[°] | 115.0 |

TABLE 39
Example 10

| | Infinity | \|β\| = 0.1 |
|---|---|---|
| DD22 | 1.0001 | 2.0987 |
| DD24 | 11.0119 | 9.9132 |

TABLE 40
Example 10

| Sn | 1 | 2 | 10 | 11 |
|---|---|---|---|---|
| KA | 1.0000000E+00 | 1.0000000E+00 | 1.0000000E+00 | 1.0000000E+00 |
| A3 | 5.9741947E−04 | 5.8061925E−04 | −1.1755086E−05 | −1.8831625E−07 |
| A4 | 5.8517422E−06 | 1.6696533E−05 | −1.9518821E−07 | −1.2026814E−06 |
| A5 | −3.9121645E−07 | −9.1924162E−07 | −1.2951732E−07 | 7.4554151E−09 |
| A6 | −3.7034533E−08 | 5.4415332E−08 | 4.2344846E−10 | −1.0116660E−09 |
| A7 | 2.9907080E−10 | 6.2855061E−10 | 1.1213765E−10 | −6.1144247E−12 |
| A8 | 3.7071703E−11 | −2.3079272E−10 | 3.2196208E−12 | 1.7083422E−12 |
| A9 | 3.2199609E−13 | 4.3106478E−13 | −5.1751774E−15 | 9.1008211E−14 |
| A10 | 2.3327173E−15 | 2.9870577E−14 | −4.3504626E−15 | 1.8651248E−15 |
| A11 | −4.6989768E−16 | −2.1472521E−15 | −2.5150624E−16 | −5.6217683E−17 |
| A12 | −3.2747286E−17 | 6.7283351E−16 | −9.1527535E−18 | −8.5607170E−18 |
| A13 | −3.1173451E−19 | −4.9857278E−18 | −1.6945845E−19 | −4.9865532E−19 |
| A14 | 1.9571835E−22 | 3.5166243E−19 | 4.5133991E−21 | −1.5630630E−20 |
| A15 | 9.8590532E−22 | −2.3393764E−21 | 6.5631355E−22 | 1.2271482E−22 |
| A16 | 1.0911914E−23 | 5.8290961E−22 | 4.4858560E−23 | 6.4222292E−23 |
| A17 | 1.0651778E−24 | 2.0177059E−23 | 2.4954715E−24 | 5.6893582E−24 |
| A18 | 1.8665115E−26 | −1.0146023E−23 | 1.4143340E−25 | 3.2964477E−25 |
| A19 | −4.5526703E−27 | 1.0022311E−25 | 9.5075179E−27 | 1.1992643E−26 |
| A20 | 8.0404154E−29 | 5.3989851E−27 | 7.4237952E−28 | −1.5343357E−28 |
| Sn | 16 | 17 | 23 | 24 |
| KA | 1.0000000E+00 | 1.0000000E+00 | 1.0000000E+00 | 1.0000000E+00 |
| A3 | 9.2211529E−05 | 2.3922460E−05 | 1.7489946E−04 | 1.7707726E−04 |
| A4 | 1.2846787E−05 | 4.0298551E−05 | 2.2058410E−05 | 3.7341240E−05 |
| A5 | 1.8693900E−06 | 6.6963212E−06 | −2.5999009E−06 | −3.0272553E−06 |
| A6 | 2.4220050E−07 | −5.2049457E−07 | −5.6720629E−08 | −1.5577651E−07 |
| A7 | 6.2706947E−09 | −3.6489364E−08 | −8.4685705E−09 | −5.9762461E−09 |
| A8 | −8.6246911E−10 | 3.6144266E−09 | −3.2342542E−10 | 1.3399900E−09 |
| A9 | −1.0826186E−10 | 4.9965159E−10 | 8.1499710E−11 | 9.3225830E−11 |
| A10 | −3.5792389E−12 | 2.9835245E−11 | 1.2479586E−11 | −7.6723208E−12 |
| A11 | 8.1410064E−13 | −6.4313346E−13 | 4.2078109E−13 | −4.6689323E−14 |
| A12 | 9.7236806E−14 | −3.8236297E−13 | −3.1694054E−13 | −9.5097709E−14 |
| A13 | 9.0925040E−15 | −4.2341163E−14 | −3.0967683E−15 | −2.5298332E−15 |
| A14 | 1.2755204E−16 | −3.2397823E−15 | 3.4246529E−15 | 1.3942967E−15 |
| A15 | −7.6911044E−17 | −3.4383975E−17 | −2.7968491E−17 | 6.1879826E−18 |
| A16 | −1.0300505E−17 | 6.8549678E−17 | −1.8727436E−17 | −6.3560858E−18 |
| A17 | −1.7789735E−19 | 6.0637000E−18 | 1.2593530E−19 | 6.1895649E−20 |
| A18 | 8.8301693E−20 | −4.9640523E−19 | 6.3264658E−20 | 1.2963465E−20 |
| A19 | 1.4817734E−21 | 2.1710366E−20 | 5.6363129E−22 | −3.2976395E−22 |
| A20 | −1.4771485E−22 | −2.9082882E−21 | −1.4833368E−22 | −9.6173902E−24 |

### Example 11

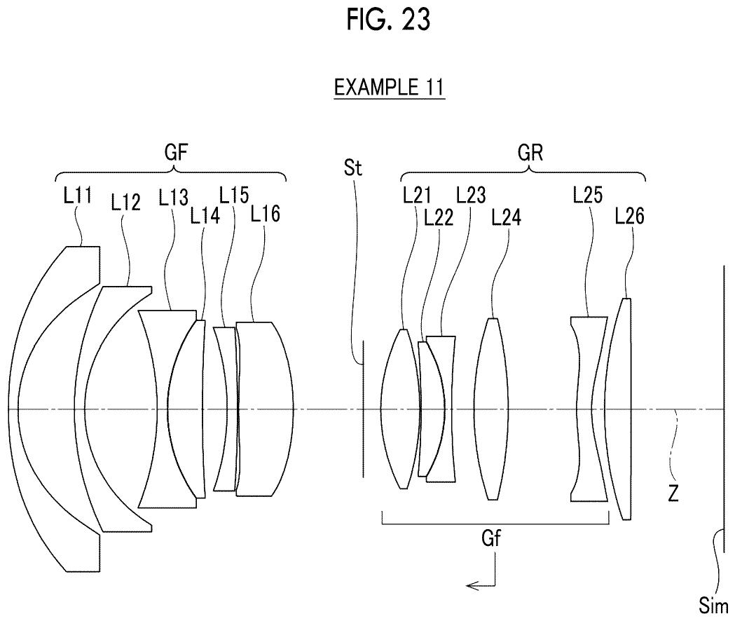

A cross-sectional view of a configuration of an imaging lens of Example 11 is shown in FIG. 23. The imaging lens of Example 11 consists of, in order from the object side to the image side, the front group GF having a negative refractive power, the aperture stop St, and the rear group GR having a positive refractive power. The rear group GR includes a single focus lens group Gf having a positive refractive power.

The front group GF consists of six lenses of the lenses L11 to L16 in order from the object side to the image side. The rear group GR consists of six lenses of the lenses L21 to L26 in order from the object side to the image side. The single focus lens group Gf consists of five lenses of the lenses L21 to L25. During focusing from the infinite distance object to the closest object, the single focus lens group Gf moves to the object side, and the other lenses and the aperture stop St are fixed with respect to the image plane Sim.

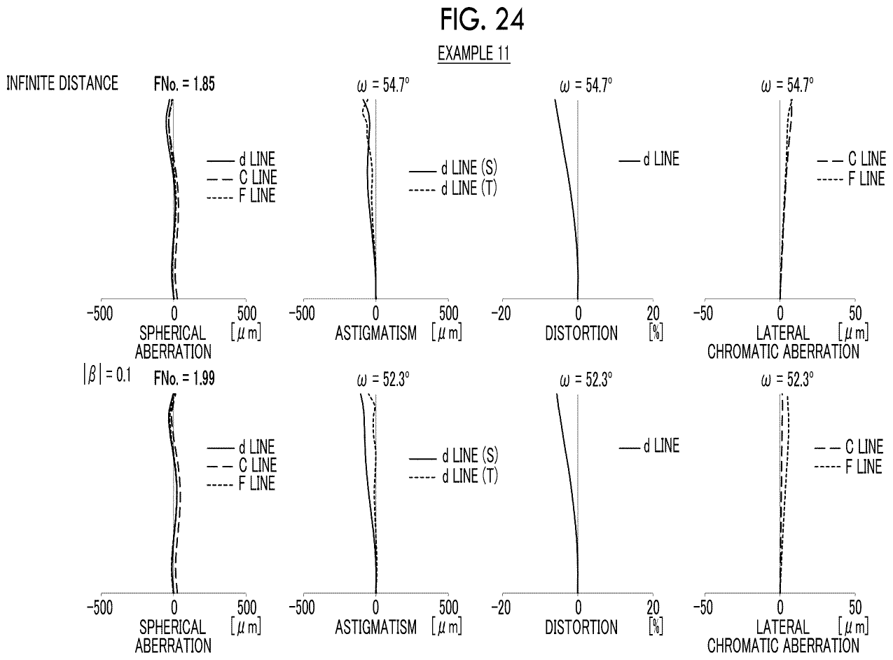

Regarding the imaging lens of Example 11, Table 41 shows basic lens data, Table 42 shows specifications, Table 43 shows a variable surface spacing, Table 44 shows an aspherical coefficient, and FIG. 24 shows each aberration diagram.

TABLE 41
Example 11

| | Sn | R | D | Nd | νd | θgF |
|---|---|---|---|---|---|---|
| | *1 | 67.8810 | 1.4102 | 1.80604 | 40.74 | 0.56899 |
| | *2 | 22.3236 | 8.2667 | | | |
| | 3.00 | 42.8878 | 1.4998 | 1.49782 | 82.57 | 0.53862 |
| | 4.00 | 20.4920 | 10.6540 | | | |
| | 5.0 | −40.5876 | 1.5098 | 1.49700 | 81.64 | 0.53714 |
| | 6 | 23.4968 | 5.1148 | 2.00272 | 19.32 | 0.64514 |
| | 7 | 219.1028 | 3.6299 | | | |
| | 8 | −38.5157 | 1.4998 | 1.98613 | 16.48 | 0.66558 |
| | 9 | −194.9700 | 0.1998 | | | |
| | *10 | 107.4602 | 8.0002 | 1.77200 | 49.98 | 0.55475 |
| | *11 | −35.6259 | 10.2596 | | | |
| | 12(St) | ∞ | DD12 | | | |
| Gf | 13 | 26.8408 | 5.7094 | 1.49782 | 82.57 | 0.53862 |
| | 14 | −39.5643 | 0.1998 | | | |
| | 15 | −114.7686 | 3.4737 | 1.57144 | 71.61 | 0.54193 |
| | 16 | −20.3801 | 0.9998 | 1.94595 | 17.98 | 0.65460 |
| | 17 | 108.8245 | 3.2766 | | | |
| | 18 | 45.2356 | 5.0316 | 1.95906 | 17.47 | 0.65993 |
| | 19 | −59.1295 | 10.0387 | | | |
| | *20 | 31.7124 | 2.1861 | 1.88660 | 34.95 | 0.58238 |
| | *21 | 18.6179 | DD21 | | | |
| | 22 | 53.5392 | 3.8851 | 1.49782 | 82.57 | 0.53862 |
| | 23 | −2502.2520 | 13.6473 | | | |

TABLE 42
Example 11

| | |
|---|---|
| f | 16.32 |
| Bf | 13.65 |
| FNo. | 1.85 |
| 2 ωm[°] | 109.4 |

TABLE 43
Example 11

| | Infinity | \|β\| = 0.1 |
|---|---|---|
| DD12 | 2.5002 | 0.1463 |
| DD21 | 1.9092 | 4.2631 |

TABLE 44
Example 11

| Sn | 1 | 2 | 10 | 11 |
|---|---|---|---|---|
| KA | 1.0000000E+00 | 4.0600000E−01 | 1.0000000E+00 | 1.0000000E+00 |
| A3 | 4.3969473E−04 | 4.6895452E−04 | −4.7898378E−06 | −1.8036328E−05 |
| A4 | −1.3082554E−05 | −1.3924997E−05 | −2.7756373E−05 | −6.2834745E−06 |
| A5 | 9.1091353E−08 | 7.6963560E−07 | −7.6514921E−07 | −2.5299739E−07 |
| A6 | 1.3414426E−09 | 5.4515691E−09 | 3.9831251E−08 | −7.7178228E−08 |
| A7 | 2.1894310E−10 | −2.9680840E−09 | −3.9820685E−09 | 2.7477170E−09 |
| A8 | 9.3647117E−12 | 1.5713646E−10 | −2.0962791E−10 | 9.7965258E−12 |
| A9 | −1.8813333E−13 | −3.6521000E−13 | −1.1227654E−11 | −6.1546052E−12 |
| A10 | −1.1255228E−14 | 9.5855066E−14 | −4.7319549E−13 | −1.4800355E−13 |
| A11 | −1.3356777E−16 | 3.4549322E−15 | −3.5827886E−14 | −1.5192364E−13 |
| A12 | 1.4258719E−18 | −4.3471812E−16 | 5.4467209E−15 | 8.6771151E−15 |
| A13 | 1.5639491E−19 | −9.3646743E−18 | −4.8502167E−17 | −7.7745523E−17 |
| A14 | 8.6156315E−22 | −2.4288844E−19 | 4.1016731E−18 | 1.4876706E−17 |
| A15 | 4.2848552E−22 | −4.0236340E−21 | 1.0234036E−17 | −8.8174928E−19 |
| A16 | 3.7687315E−24 | 8.4275321E−22 | −1.9589146E−19 | 1.3835539E−19 |
| A17 | 9.3996431E−27 | 1.2901333E−22 | −7.1491976E−20 | 1.2555679E−20 |
| A18 | −2.5048230E−26 | 7.6982379E−24 | −6.2998892E−21 | −3.5708424E−21 |
| A19 | −2.1254150E−28 | −1.9403331E−25 | 7.3416388E−22 | 1.3642413E−22 |
| A20 | 1.1592535E−29 | −2.6640315E−26 | −1.2632461E−23 | 1.0968607E−25 |

| Sn | 20 | 21 |
|---|---|---|
| KA | 1.0000000E+00 | 1.0000000E+00 |
| A3 | −9.4700613E−05 | −9.0762753E−05 |
| A4 | −1.4556393E−04 | −1.4152999E−04 |
| A5 | −9.1588158E−07 | −2.1058444E−06 |
| A6 | 9.7254012E−08 | 3.8537899E−07 |
| A7 | −7.7556718E−09 | −2.1407061E−09 |
| A8 | 2.7876710E−09 | 2.0804518E−09 |
| A9 | 3.6904647E−11 | −1.4343878E−11 |
| A10 | −2.2000626E−11 | −1.9861973E−11 |
| A11 | 3.2184876E−13 | 2.7878988E−13 |
| A12 | 5.7262599E−14 | 5.3994670E−14 |
| A13 | −2.3587219E−16 | −3.5086583E−16 |
| A14 | −1.8127331E−16 | 4.0686737E−17 |
| A15 | −2.8371665E−18 | 1.2910113E−17 |
| A16 | −1.5196594E−19 | −4.8220166E−18 |
| A17 | −1.2919810E−20 | 6.9704674E−20 |
| A18 | 4.1166223E−21 | 4.4320791E−20 |
| A19 | 5.8014139E−22 | −3.2773064E−21 |
| A20 | −4.2307814E−23 | 6.9317114E−23 |

### Example 12

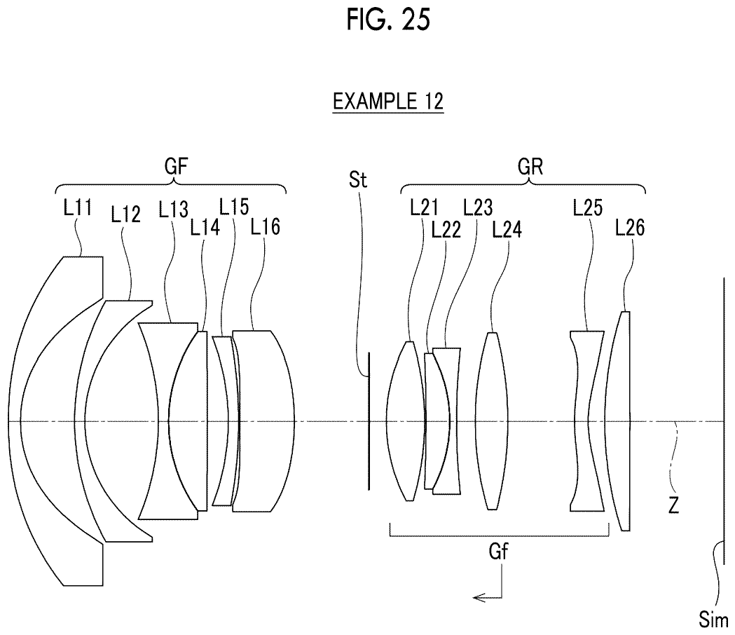

A cross-sectional view of a configuration of an imaging lens of Example 12 is shown in FIG. 25. The imaging lens of Example 12 consists of, in order from the object side to the image side, the front group GF having a negative refractive power, the aperture stop St, and the rear group GR having a positive refractive power. The rear group GR includes a single focus lens group Gf having a positive refractive power.

The front group GF consists of six lenses of the lenses L11 to L16 in order from the object side to the image side. The rear group GR consists of six lenses of the lenses L21 to L26 in order from the object side to the image side. The single focus lens group Gf consists of five lenses of the lenses L21 to L25. During focusing from the infinite distance object to the closest object, the single focus lens group Gf moves to the object side, and the other lenses and the aperture stop St are fixed with respect to the image plane Sim.

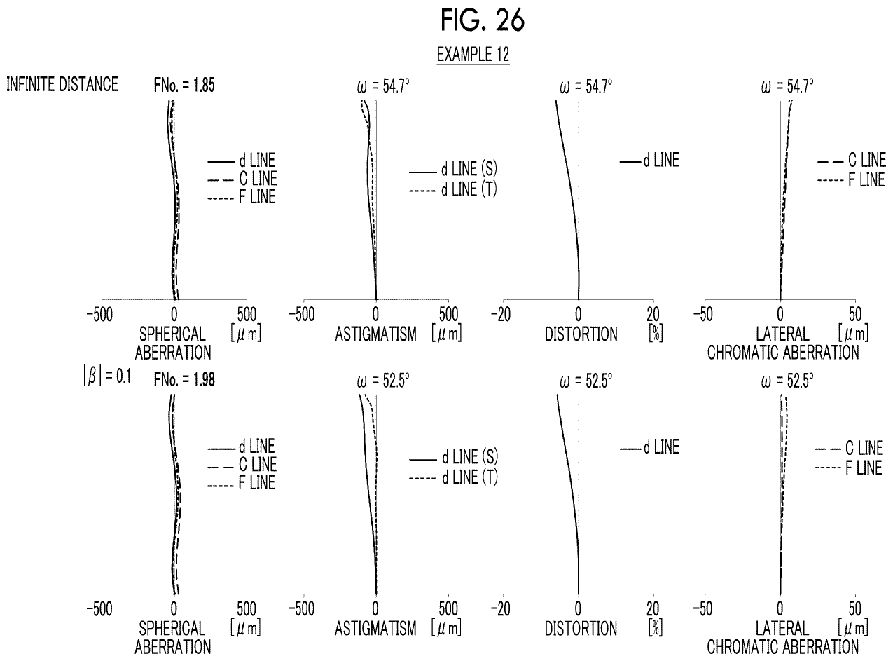

Regarding the imaging lens of Example 12, Table 45 shows basic lens data, Table 46 shows specifications, Table 47 shows a variable surface spacing, Table 48 shows an aspherical coefficient, and FIG. 26 shows each aberration diagram.

TABLE 45
Example 12

| | Sn | R | D | Nd | νd | θgF |
|---|---|---|---|---|---|---|
| | *1 | 73.5188 | 1.7713 | 1.77387 | 47.25 | 0.55571 |
| | *2 | 21.0573 | 7.9354 | | | |
| | 3.00 | 38.3484 | 1.4998 | 1.49782 | 82.57 | 0.53862 |
| | 4.00 | 20.4391 | 10.7800 | | | |
| | 5.0 | −38.6324 | 1.5101 | 1.52841 | 76.45 | 0.53954 |
| | 6 | 23.6449 | 5.6620 | 1.96300 | 24.11 | 0.62126 |
| | 7 | −2100.4150 | 3.0752 | | | |
| | 8 | −35.8355 | 1.5096 | 1.98613 | 16.48 | 0.66558 |
| | 9 | −72.2307 | 0.2002 | | | |
| | *10 | 928.9101 | 8.0002 | 1.77200 | 49.98 | 0.55475 |
| | *11 | −35.9547 | 10.9087 | | | |
| | 12(St) | ∞ | DD12 | | | |
| Gf | 13 | 26.1629 | 5.6149 | 1.49782 | 82.57 | 0.53862 |
| | 14 | −43.5041 | 0.1998 | | | |
| | 15 | −241.7517 | 3.4854 | 1.49700 | 81.14 | 0.53812 |
| | 16 | −22.2582 | 0.9998 | 1.98613 | 16.48 | 0.66558 |
| | 17 | 107.6102 | 2.7434 | | | |
| | 18 | 49.1697 | 4.7843 | 1.98613 | 16.48 | 0.66558 |
| | 19 | −54.6091 | 9.7847 | | | |
| | *20 | 29.4437 | 2.0005 | 1.88660 | 34.95 | 0.58238 |
| | *21 | 18.2399 | DD21 | | | |
| | 22 | 56.2556 | 3.6948 | 1.49782 | 82.57 | 0.53862 |
| | 23 | −2502.2521 | 13.8188 | | | |

TABLE 46
Example 12

| | |
|---|---|
| f | 16.32 |
| Bf | 13.82 |
| FNo. | 1.85 |
| 2 ωm[°] | 109.4 |

TABLE 47
Example 12

| | Infinity | \|β\| = 0.1 |
|---|---|---|
| DD12 | 2.4998 | 0.0124 |
| DD21 | 2.4221 | 3.4871 |

TABLE 48
Example 12

| Sn | 1 | 2 | 10 | 11 |
|---|---|---|---|---|
| KA | 1.0000000E+00 | 4.0600000E−01 | 1.0000000E+00 | 1.0000000E+00 |
| A3 | 4.5232350E−04 | 4.8807605E−04 | −1.6333698E−05 | −2.3990220E−05 |
| A4 | −1.1505587E−05 | −1.0910981E−05 | −2.3944015E−05 | −6.8637933E−06 |
| A5 | 8.9741596E−09 | 7.5199156E−07 | −8.3199939E−07 | −3.1585063E−07 |
| A6 | −2.3501012E−09 | 1.7615702E−09 | 2.0655408E−08 | −7.1801835E−08 |
| A7 | 2.7283474E−10 | −2.7306000E−09 | −2.5288936E−09 | 2.9033867E−09 |
| A8 | 1.0146514E−11 | 1.4859706E−10 | −1.7740277E−10 | 8.2705340E−11 |
| A9 | −4.6394309E−14 | −8.0693345E−13 | −2.7549009E−12 | −2.8518606E−12 |
| A10 | −1.5773352E−14 | 2.0275962E−14 | −7.7343520E−13 | −5.2793685E−13 |
| A11 | −1.5293005E−16 | 5.8125941E−15 | 5.0896736E−15 | −1.2602974E−13 |
| A12 | 8.3984797E−19 | −1.5034560E−17 | 2.8069244E−15 | 7.5091702E−15 |
| A13 | 1.0630012E−19 | −3.3960491E−17 | −5.2242331E−16 | −1.9280424E−16 |
| A14 | 1.0137667E−20 | −2.3074784E−19 | 6.6688281E−17 | 2.4470643E−17 |
| A15 | 1.9266033E−22 | 1.7617927E−20 | 4.7656940E−18 | −8.7463844E−19 |
| A16 | 4.3960134E−24 | 1.0880713E−21 | −1.9800256E−19 | 1.1145318E−19 |
| A17 | −1.8230574E−25 | 1.1177665E−22 | −4.5129052E−20 | 1.2646710E−20 |
| A18 | −1.1832001E−26 | 1.1132354E−23 | −5.1165304E−21 | −3.2387893E−21 |
| A19 | −4.8057536E−28 | −6.3848685E−25 | 7.2216178E−22 | 1.4604767E−22 |
| A20 | 1.6906452E−29 | −1.9681913E−26 | −1.9238815E−23 | −1.3488175E−24 |

| Sn | 20 | 21 |
|---|---|---|
| KA | 1.0000000E+00 | 1.0000000E+00 |
| A3 | −7.6025872E−05 | −8.5475570E−05 |
| A4 | −1.5813327E−04 | −1.5074950E−04 |
| A5 | 4.9909617E−08 | −1.8798278E−06 |
| A6 | 7.1748522E−08 | 4.2114308E−07 |
| A7 | −6.8913602E−09 | −2.6615111E−09 |
| A8 | 3.0054963E−09 | 2.0070691E−09 |
| A9 | 1.7890383E−11 | −2.0228420E−11 |
| A10 | −2.2585619E−11 | −1.9623695E−11 |
| A11 | 3.0899085E−13 | 2.4071797E−13 |
| A12 | 6.1890995E−14 | 5.8834618E−14 |
| A13 | −4.1303888E−16 | −4.7371825E−16 |
| A14 | −1.3489412E−16 | 4.0815959E−17 |
| A15 | −5.1078032E−18 | 1.4349849E−17 |
| A16 | −1.5998196E−19 | −4.9200511E−18 |
| A17 | −1.9007015E−20 | 6.3611453E−20 |
| A18 | 4.4535045E−21 | 4.4318403E−20 |
| A19 | 6.0011630E−22 | −3.2103953E−21 |
| A20 | −4.3635055E−23 | 6.6624691E−23 |

### Example 13

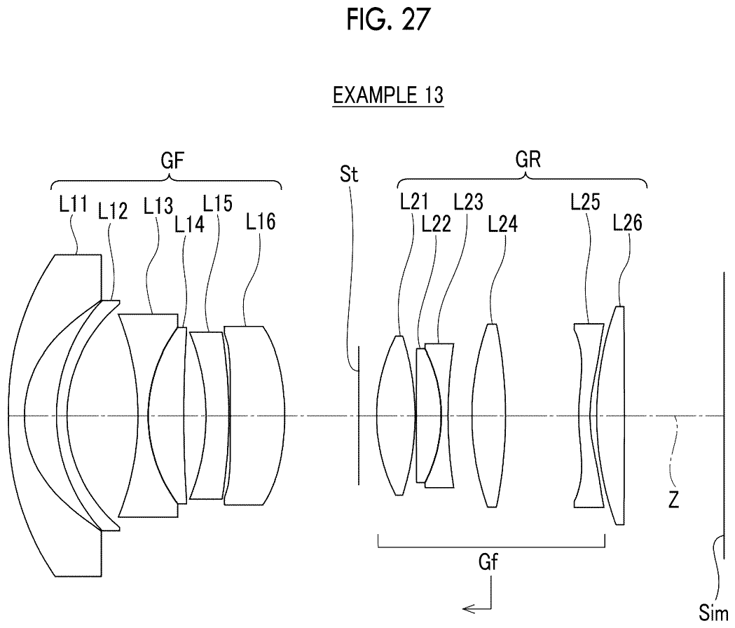

A cross-sectional view of a configuration of an imaging lens of Example 13 is shown in FIG. 27. The imaging lens of Example 13 consists of, in order from the object side to the image side, the front group GF having a negative refractive power, the aperture stop St, and the rear group GR having a positive refractive power. The rear group GR includes a single focus lens group Gf having a positive refractive power.

The front group GF consists of six lenses of the lenses L11 to L16 in order from the object side to the image side. The rear group GR consists of six lenses of the lenses L21 to L26 in order from the object side to the image side. The single focus lens group Gf consists of five lenses of the lenses L21 to L25. During focusing from the infinite distance object to the closest object, the single focus lens group Gf moves to the object side, and the other lenses and the aperture stop St are fixed with respect to the image plane Sim.

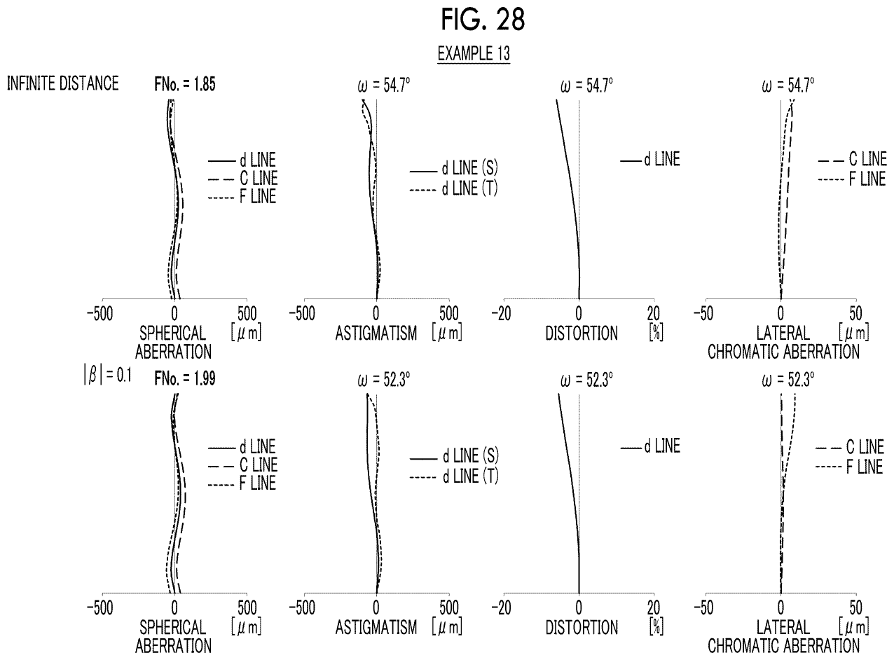

Regarding the imaging lens of Example 13, Table 49 shows basic lens data, Table 50 shows specifications, Table 51 shows a variable surface spacing, Table 52 shows an aspherical coefficient, and FIG. 28 shows each aberration diagram.

TABLE 49
Example 13

| | Sn | R | D | Nd | νd | θgF |
|---|---|---|---|---|---|---|
| | *1 | 114.2846 | 2.3567 | 1.79526 | 45.25 | 0.55894 |
| | *2 | 19.8672 | 4.7036 | | | |
| | 3.00 | 25.9588 | 1.5379 | 1.98613 | 16.48 | 0.66558 |
| | 4.00 | 22.3177 | 10.4128 | | | |
| | 5.0 | −42.0682 | 1.5098 | 1.49700 | 81.54 | 0.53748 |
| | 6 | 22.6843 | 5.2062 | 1.96300 | 24.11 | 0.62126 |
| | 7 | 199.7652 | 3.2556 | | | |
| | 8 | −34.1140 | 3.3417 | 2.00272 | 19.32 | 0.64514 |
| | 9 | −80.5608 | 0.1998 | | | |
| | *10 | 313.9689 | 8.0002 | 1.83441 | 37.28 | 0.57732 |
| | *11 | −38.5801 | 10.8932 | | | |
| | 12(St) | ∞ | DD12 | | | |
| Gf | 13 | 27.0782 | 5.6431 | 1.49700 | 81.54 | 0.53748 |
| | 14 | −40.3446 | 0.1998 | | | |
| | 15 | 1844.7722 | 3.6437 | 1.49782 | 82.57 | 0.53862 |
| | 16 | −22.6106 | 0.9998 | 1.94595 | 17.98 | 0.65460 |
| | 17 | 70.5735 | 3.5032 | | | |
| | 18 | 42.4903 | 4.9322 | 1.98613 | 16.48 | 0.66558 |
| | 19 | −71.8026 | 10.7345 | | | |
| | *20 | 30.1131 | 1.6470 | 2.00178 | 19.32 | 0.64480 |
| | *21 | 19.6887 | DD21 | | | |
| | 22 | 49.7307 | 4.0447 | 1.49700 | 81.54 | 0.53748 |
| | 23 | −2499.9650 | 14.6347 | | | |

TABLE 50
Example 13

| | |
|---|---|
| f | 16.32 |
| Bf | 14.63 |
| FNo. | 1.85 |
| 2 ωm[°] | 109.4 |

TABLE 51
Example 13

| | Infinity | \|β\| = 0.1 |
|---|---|---|
| DD12 | 2.4998 | 0.0124 |
| DD21 | 0.9998 | 3.4871 |

TABLE 52
Example 13

| Sn | 1 | 2 | 10 | 11 |
|---|---|---|---|---|
| KA | 1.0000000E+00 | 4.0600000E−01 | 1.0000000E+00 | 1.0000000E+00 |
| A3 | 6.0192899E−04 | 6.8940099E−04 | −5.5038664E−06 | −3.2159631E−05 |
| A4 | −1.4588781E−05 | −1.7716805E−05 | −2.7652004E−05 | −4.8675134E−06 |
| A5 | −9.9997227E−08 | 1.0432595E−06 | −4.9459591E−07 | −5.2646102E−07 |
| A6 | −2.1530404E−09 | 1.0804153E−08 | 1.1713143E−08 | −7.7699212E−08 |
| A7 | 3.7314161E−10 | −3.6266840E−09 | −4.0871132E−09 | 4.0614874E−09 |
| A8 | 1.1559300E−11 | 1.2379685E−10 | −2.3209944E−10 | 1.0000855E−10 |
| A9 | 3.4413025E−14 | 1.4071265E−13 | −1.9645632E−12 | −1.4662928E−11 |
| A10 | −1.6525556E−14 | −8.5985927E−14 | 1.0684085E−12 | −5.6527118E−14 |
| A11 | −2.4637386E−16 | 6.6477238E−15 | −1.1959443E−13 | −1.2149859E−13 |
| A12 | −6.8396282E−18 | 2.8419221E−18 | 4.3205725E−15 | 9.3531715E−15 |
| A13 | −3.0337044E−20 | 1.4924379E−17 | −5.4741691E−16 | −3.0653895E−16 |
| A14 | 9.2749959E−21 | −2.7774564E−20 | 8.3774367E−18 | 4.5988409E−18 |
| A15 | 5.0709486E−22 | −3.0234931E−20 | 9.5556470E−18 | 3.8132633E−19 |
| A16 | 1.3673423E−23 | −4.4210455E−21 | −9.7902912E−20 | 1.6351115E−19 |
| A17 | 6.9250594E−26 | 1.2680044E−22 | −5.1955667E−20 | 9.7020719E−21 |
| A18 | −1.9747462E−26 | −2.0164112E−24 | −5.9008609E−21 | −3.5670432E−21 |
| A19 | −2.9531686E−28 | −4.7947023E−25 | 7.6511916E−22 | 1.8021407E−22 |
| A20 | 5.3384565E−31 | −3.0406963E−26 | −2.0532528E−23 | −2.4125994E−24 |

| Sn | 20 | 21 |
|---|---|---|
| KA | 1.0000000E+00 | 1.0000000E+00 |
| A3 | −2.7037171E−04 | −2.8998906E−04 |
| A4 | −1.3534581E−04 | −1.2478663E−04 |
| A5 | −1.4810726E−07 | −2.2703423E−06 |
| A6 | 4.7066131E−08 | 4.0326531E−07 |
| A7 | −6.2317351E−09 | −2.4916314E−09 |
| A8 | 3.1002213E−09 | 2.1591277E−09 |
| A9 | 3.6997325E−11 | −5.7560460E−12 |
| A10 | −2.1543373E−11 | −1.9680972E−11 |
| A11 | 2.9414135E−13 | 2.4998682E−13 |
| A12 | 5.8414727E−14 | 5.3051485E−14 |
| A13 | −7.4398209E−16 | −7.1805999E−16 |
| A14 | −2.0743254E−16 | 4.0604524E−17 |
| A15 | −7.2016010E−18 | 1.3021754E−17 |
| A16 | 7.9547945E−20 | −4.7687364E−18 |
| A17 | −1.0403490E−21 | 7.2598517E−20 |
| A18 | 5.4679231E−21 | 4.4134603E−20 |
| A19 | 6.2165732E−22 | −3.2073406E−21 |
| A20 | −5.0447895E−23 | 6.5211684E−23 |

### Example 14

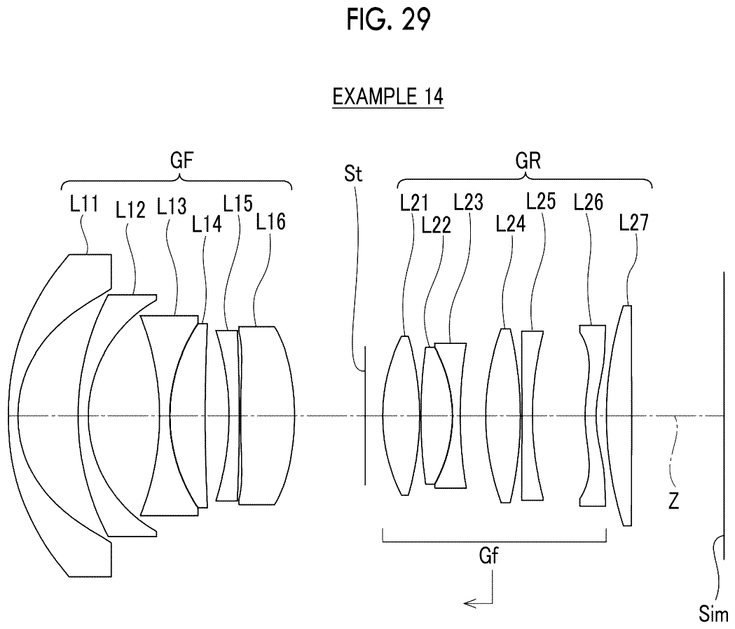

A cross-sectional view of a configuration of an imaging lens of Example 14 is shown in FIG. 29. The imaging lens of Example 14 consists of, in order from the object side to the image side, the front group GF having a negative refractive power, the aperture stop St, and the rear group GR having a positive refractive power. The rear group GR includes a single focus lens group Gf having a positive refractive power.

The front group GF consists of six lenses of the lenses L11 to L16 in order from the object side to the image side. The rear group GR consists of seven lenses of the lenses L21 to L27 in order from the object side to the image side. The single focus lens group Gf consists of six lenses of the lenses L21 to L26. During focusing from the infinite distance object to the closest object, the single focus lens group Gf moves to the object side, and the other lenses and the aperture stop St are fixed with respect to the image plane Sim.

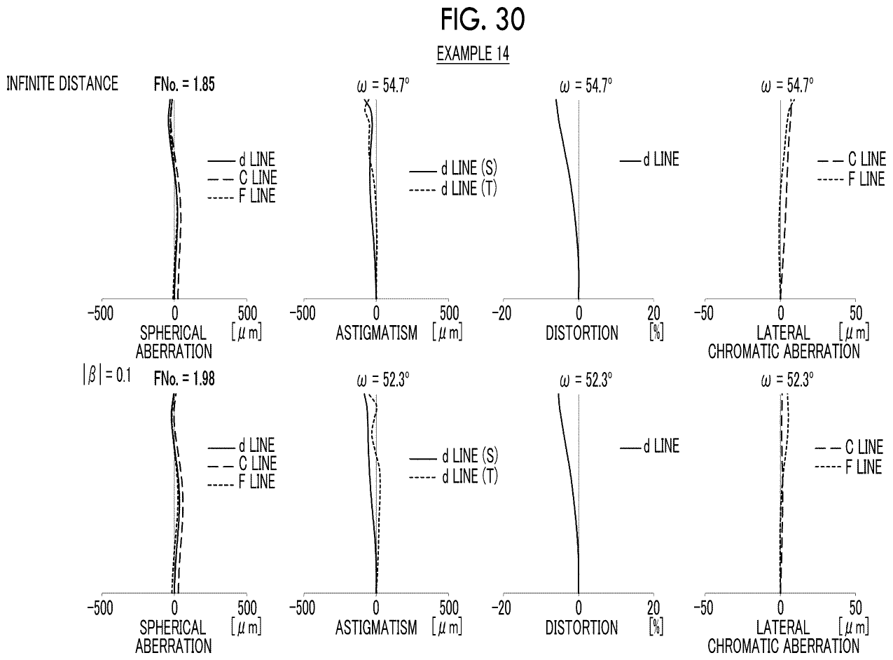

Regarding the imaging lens of Example 14, Table 53 shows basic lens data, Table 54 shows specifications, Table 55 shows a variable surface spacing, Table 56 shows an aspherical coefficient, and FIG. 30 shows each aberration diagram.

TABLE 53
Example 14

| | Sn | R | D | Nd | νd | θgF |
|---|---|---|---|---|---|---|
| | *1 | 59.4500 | 1.3882 | 1.80604 | 40.74 | 0.56899 |
| | *2 | 21.0718 | 8.8221 | | | |
| | 3.00 | 39.9429 | 1.4998 | 1.57144 | 71.61 | 0.54193 |
| | 4.00 | 20.3011 | 10.4602 | | | |
| | 5.0 | −41.5553 | 1.5102 | 1.49700 | 81.61 | 0.53887 |
| | 6 | 25.5284 | 5.1799 | 2.01960 | 21.45 | 0.63675 |
| | 7 | 289.0844 | 3.4909 | | | |
| | 8 | −43.9448 | 1.5110 | 1.94595 | 17.98 | 0.65460 |
| | 9 | −276.3662 | 0.1998 | | | |
| | *10 | 122.7936 | 7.8963 | 1.80139 | 45.45 | 0.55814 |
| | *11 | −39.5525 | 10.3565 | | | |
| | 12(St) | ∞ | DD12 | | | |
| Gf | 13 | 27.5347 | 5.4121 | 1.49782 | 82.57 | 0.53862 |
| | 14 | −44.4728 | 0.2002 | | | |
| | 15 | 78.6625 | 4.6180 | 1.55032 | 75.50 | 0.54001 |
| | 16 | −21.8038 | 1.1365 | 1.89286 | 20.36 | 0.63944 |
| | 17 | 66.5374 | 3.7582 | | | |
| | 18 | 39.3157 | 5.0619 | 1.98613 | 16.48 | 0.66558 |
| | 19 | −58.5992 | 0.2441 | | | |
| | 20 | −1968.3156 | 1.5408 | 1.92286 | 18.90 | 0.64960 |
| | 21 | 49.9463 | 7.7289 | | | |
| | *22 | 23.5685 | 1.6040 | 1.88660 | 34.95 | 0.58238 |
| | *23 | 18.3254 | DD23 | | | |
| | 24 | 57.0425 | 3.6873 | 1.49782 | 82.57 | 0.53862 |
| | 25 | −2502.2520 | 13.5673 | | | |

TABLE 54
Example 14

| | |
|---|---|
| f | 16.32 |
| Bf | 13.57 |
| FNo. | 1.85 |
| 2 ωm[°] | 109.4 |

TABLE 55
Example 14

| | Infinity | \|β\| = 0.1 |
|---|---|---|
| DD12 | 2.4998 | 0.1866 |
| DD23 | 1.5264 | 3.8396 |

TABLE 56
Example 14

| Sn | 1 | 2 | 10 | 11 |
|---|---|---|---|---|
| KA | 1.0000000E+00 | 4.0600000E−01 | 1.0000000E+00 | 1.0000000E+00 |
| A3 | 4.7684322E−04 | 4.9787964E−04 | −2.6681643E−05 | −1.6231088E−05 |
| A4 | −7.9470781E−06 | −2.7773731E−06 | −1.4818741E−05 | −4.2962041E−06 |
| A5 | −2.4144877E−07 | 2.3785703E−07 | −1.0561681E−06 | −1.3596209E−07 |
| A6 | −1.8479289E−09 | 1.9551733E−08 | 3.4244577E−08 | −7.7712682E−08 |
| A7 | 2.7243704E−10 | −2.6884188E−09 | −1.5038680E−09 | 2.7900995E−09 |
| A8 | 1.4911698E−11 | 1.3582503E−10 | −2.3323683E−10 | 1.0299671E−10 |
| A9 | 1.2254642E−13 | −5.9728746E−13 | −7.2754880E−12 | −4.2473979E−12 |
| A10 | −1.2478837E−14 | −1.2836901E−14 | 2.8280673E−13 | −4.7832049E−13 |
| A11 | −2.9514773E−16 | 4.2582725E−15 | 1.7734089E−14 | −1.2116950E−13 |
| A12 | −5.5410546E−18 | −1.0618901E−16 | 1.2461776E−15 | 5.8746775E−15 |
| A13 | −1.8913251E−19 | 6.5536432E−19 | −6.0232282E−16 | −9.8680586E−17 |
| A14 | 4.9967010E−21 | −3.2743558E−19 | 1.5141365E−17 | 1.6660649E−17 |
| A15 | 1.9248874E−22 | 4.7503534E−21 | 7.3614356E−18 | 4.4970748E−19 |
| A16 | 1.8089945E−24 | 1.2648963E−21 | −1.5137873E−19 | −9.5858010E−21 |
| A17 | 5.9552446E−25 | 1.1863209E−22 | −5.2745172E−20 | 1.1603316E−20 |
| A18 | −3.4043737E−27 | 7.8822311E−24 | −3.2995122E−21 | −2.4217908E−21 |
| A19 | −4.0868625E−28 | −4.3548903E−25 | 6.5249173E−22 | 1.1265901E−22 |
| A20 | −9.3277096E−30 | −3.3928512E−26 | −2.0331686E−23 | −1.3216017E−24 |

| Sn | 22 | 23 |
|---|---|---|
| KA | 1.0000000E+00 | 1.0000000E+00 |
| A3 | 2.6556343E−05 | 2.2391567E−05 |
| A4 | −1.9333813E−04 | −1.8554098E−04 |
| A5 | −2.5688216E−06 | −4.3523553E−06 |
| A6 | 5.8647007E−08 | 4.0214564E−07 |
| A7 | −2.8449668E−09 | 3.2021529E−09 |
| A8 | 3.4158234E−09 | 2.6880653E−09 |
| A9 | 2.9074208E−11 | 2.5235082E−11 |
| A10 | −2.3547915E−11 | −1.9807165E−11 |
| A11 | 2.8544137E−13 | 3.1056410E−14 |
| A12 | 6.9433976E−14 | 4.4056488E−14 |
| A13 | −2.1651289E−16 | −1.6730377E−16 |
| A14 | −1.0492692E−16 | 3.7272017E−17 |
| A15 | −3.7984684E−19 | −3.2660425E−18 |
| A16 | 1.9442472E−19 | −1.4999772E−19 |
| A17 | −7.8277737E−20 | 3.8054601E−22 |
| A18 | −2.8648139E−22 | 3.2201142E−22 |
| A19 | 5.4854045E−22 | −1.9270422E−23 |
| A20 | −1.9621774E−23 | 9.4483060E−25 |

### Example 15

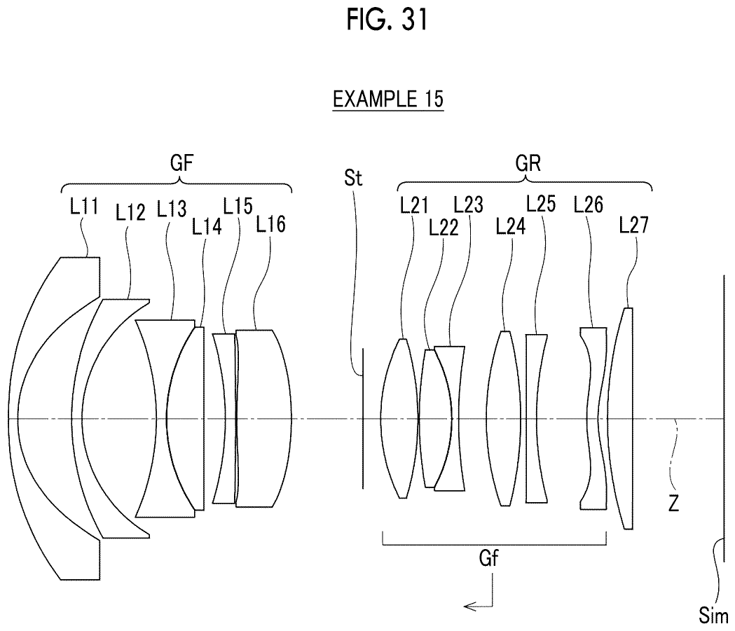

A cross-sectional view of a configuration of an imaging lens of Example 15 is shown in FIG. 31. The imaging lens of Example 15 consists of, in order from the object side to the image side, the front group GF having a negative refractive power, the aperture stop St, and the rear group GR having a positive refractive power. The rear group GR includes a single focus lens group Gf having a positive refractive power.

The front group GF consists of six lenses of the lenses L11 to L16 in order from the object side to the image side. The rear group GR consists of seven lenses of the lenses L21 to L27 in order from the object side to the image side. The single focus lens group Gf consists of six lenses of the lenses L21 to L26. During focusing from the infinite distance object to the closest object, the single focus lens group Gf moves to the object side, and the other lenses and the aperture stop St are fixed with respect to the image plane Sim.

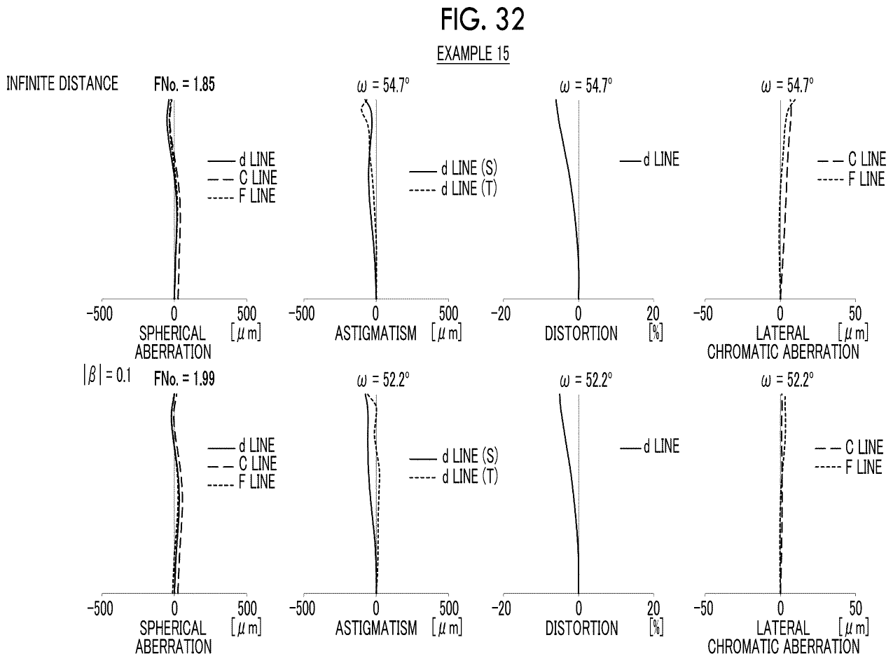

Regarding the imaging lens of Example 15, Table 57 shows basic lens data, Table 58 shows specifications, Table 59 shows a variable surface spacing, Table 60 shows an aspherical coefficient, and FIG. 32 shows each aberration diagram.

TABLE 57
Example 15

| | Sn | R | D | Nd | νd | θgF |
|---|---|---|---|---|---|---|
| Gf | *1 | 73.3393 | 1.3610 | 1.77387 | 47.25 | 0.55571 |
| | *2 | 20.8621 | 7.9152 | | | |
| | 3.00 | 37.6867 | 1.4998 | 1.49782 | 82.57 | 0.53862 |
| | 4.00 | 20.4336 | 10.9123 | | | |
| | 5.0 | −37.4399 | 1.5099 | 1.49700 | 81.54 | 0.53748 |
| | 6 | 25.0075 | 5.4670 | 1.96300 | 24.11 | 0.62126 |
| | 7 | 8117.7745 | 3.1433 | | | |
| | 8 | −44.5151 | 1.5001 | 2.00171 | 20.66 | 0.63472 |
| | 9 | −615.2567 | 0.1998 | | | |
| | *10 | 103.6701 | 8.0002 | 1.80139 | 45.45 | 0.55814 |
| | *11 | −40.3689 | 10.5137 | | | |
| | 12(St) | ∞ | DD12 | | | |
| | 13 | 27.5093 | 5.4595 | 1.49700 | 81.54 | 0.53748 |
| | 14 | −43.3622 | 0.1998 | | | |
| | 15 | 60.8075 | 4.7762 | 1.52841 | 76.45 | 0.53954 |
| | 16 | −22.2685 | 1.0002 | 1.90682 | 21.17 | 0.63332 |
| | 17 | 66.2034 | 4.0560 | | | |
| | 18 | 41.4358 | 5.0409 | 1.95906 | 17.47 | 0.65993 |
| | 19 | −55.2721 | 0.8146 | | | |
| | 20 | −3388.6980 | 1.5002 | 1.86966 | 20.02 | 0.64349 |
| | 21 | 48.9121 | 7.3890 | | | |
| | *22 | 23.8767 | 1.6379 | 1.88202 | 37.22 | 0.57699 |
| | *23 | 18.3823 | DD23 | | | |
| | 24 | 57.1946 | 3.7009 | 1.49700 | 81.54 | 0.53748 |
| | 25 | −2499.9424 | 13.3977 | | | |

TABLE 58
Example 15

| | |
|---|---|
| f | 16.32 |
| Bf | 13.40 |
| FNo. | 1.85 |
| 2 ωm[°] | 109.4 |

TABLE 59
Example 15

| | Infinity | \|β\| = 0.1 |
|---|---|---|
| DD12 | 2.4998 | 0.1629 |
| DD23 | 1.4058 | 3.7426 |

TABLE 60
Example 15

| Sn | 1 | 2 | 10 | 11 |
|---|---|---|---|---|
| KA | 1.0000000E+00 | 4.0600000E−01 | 1.0000000E+00 | 1.0000000E+00 |
| A3 | 4.8723836E−04 | 5.0353743E−04 | −2.6467214E−05 | −1.5903084E−05 |
| A4 | −1.2750284E−05 | −9.1959133E−06 | −1.4372871E−05 | −3.6606693E−06 |
| A5 | −7.8232607E−09 | 4.8281644E−07 | −1.2144489E−06 | −1.1666677E−07 |
| A6 | −3.1300233E−09 | 1.5197672E−08 | 4.0308307E−08 | −7.4102360E−08 |
| A7 | 2.6120536E−10 | −2.8674437E−09 | −8.9764096E−10 | 2.4915507E−09 |
| A8 | 1.0663564E−11 | 1.4670695E−10 | −1.1989362E−10 | 4.4393605E−11 |
| A9 | 5.2598770E−14 | −1.6041942E−12 | −1.9105583E−11 | 2.5006887E−12 |
| A10 | −1.1357059E−14 | 2.6138562E−14 | −2.1515201E−13 | −5.4695096E−13 |
| A11 | −1.6665716E−16 | 1.1674319E−15 | 3.2731476E−14 | −1.2579414E−13 |
| A12 | −4.4708879E−18 | −6.6580771E−17 | 1.2746344E−15 | 6.0551472E−15 |
| A13 | −5.0995604E−20 | 2.8582317E−18 | −5.8350131E−16 | −1.3456805E−16 |
| A14 | 2.9980942E−21 | 2.3899478E−20 | 4.8967940E−17 | 2.0304170E−17 |
| A15 | 1.8656226E−22 | −1.3030730E−20 | 7.9529683E−18 | 3.6646253E−19 |
| A16 | 3.0881343E−24 | 1.0837184E−21 | −2.0076489E−19 | −6.2991865E−20 |
| A17 | 3.3105225E−25 | 7.8926959E−23 | −5.4019890E−20 | 1.6162201E−20 |
| A18 | −2.1597925E−27 | 6.4301239E−24 | −4.8609688E−21 | −2.4796721E−21 |
| A19 | −5.0857879E−28 | −5.7455853E−25 | 6.7197675E−22 | 1.1328299E−22 |
| A20 | 7.3007446E−31 | −1.6895561E−26 | −1.5928188E−23 | −1.4657078E−24 |

| Sn | 22 | 23 |
|---|---|---|
| KA | 1.0000000E+00 | 1.0000000E+00 |
| A3 | −1.7006477E−05 | −2.8054293E−05 |
| A4 | −1.9289139E−04 | −1.8332140E−04 |
| A5 | −2.4762768E−06 | −4.6083063E−06 |
| A6 | 2.4293443E−08 | 4.0644276E−07 |
| A7 | −2.3889458E−09 | 3.2962588E−09 |
| A8 | 3.3414468E−09 | 2.8418715E−09 |
| A9 | 6.0974643E−11 | 2.2181172E−11 |
| A10 | −2.4737766E−11 | −2.1388165E−11 |
| A11 | 2.1250747E−13 | 7.3417597E−14 |
| A12 | 6.1767428E−14 | 4.4786168E−14 |
| A13 | 3.0510452E−16 | −1.7040574E−18 |
| A14 | −9.1824663E−17 | 4.0230947E−17 |
| A15 | −1.6621526E−19 | −3.4230016E−18 |
| A16 | 4.9524080E−20 | −1.4762148E−19 |
| A17 | −5.5776289E−20 | 8.2622551E−22 |
| A18 | 4.3859948E−22 | −1.2278556E−22 |
| A19 | 4.1596921E−22 | 9.0836099E−24 |
| A20 | −1.8737113E−23 | 4.2184521E−25 |

### Example 16

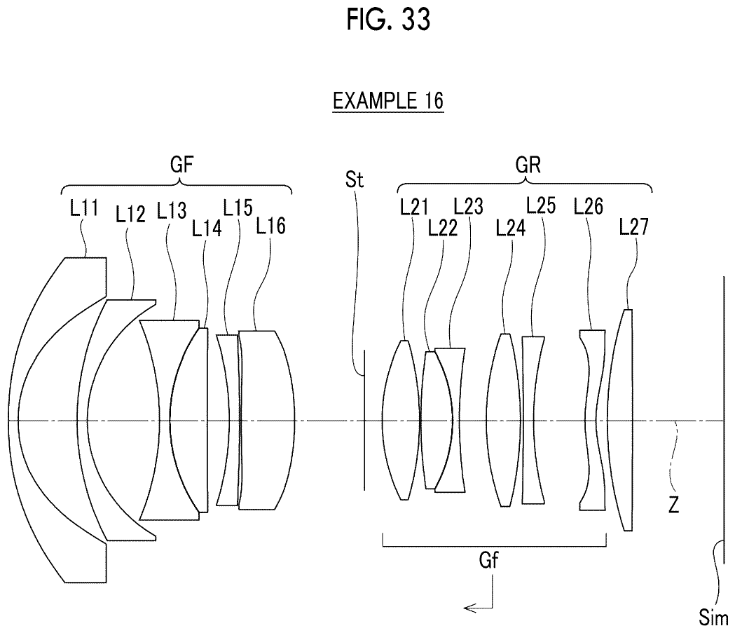

A cross-sectional view of a configuration of an imaging lens of Example 16 is shown in FIG. 33. The imaging lens of Example 16 consists of, in order from the object side to the image side, the front group GF having a negative refractive power, the aperture stop St, and the rear group GR having a positive refractive power. The rear group GR includes a single focus lens group Gf having a positive refractive power.

The front group GF consists of six lenses of the lenses L11 to L16 in order from the object side to the image side. The rear group GR consists of seven lenses of the lenses L21 to L27 in order from the object side to the image side. The single focus lens group Gf consists of six lenses of the lenses L21 to L26. During focusing from the infinite distance object to the closest object, the single focus lens group Gf moves to the object side, and the other lenses and the aperture stop St are fixed with respect to the image plane Sim.

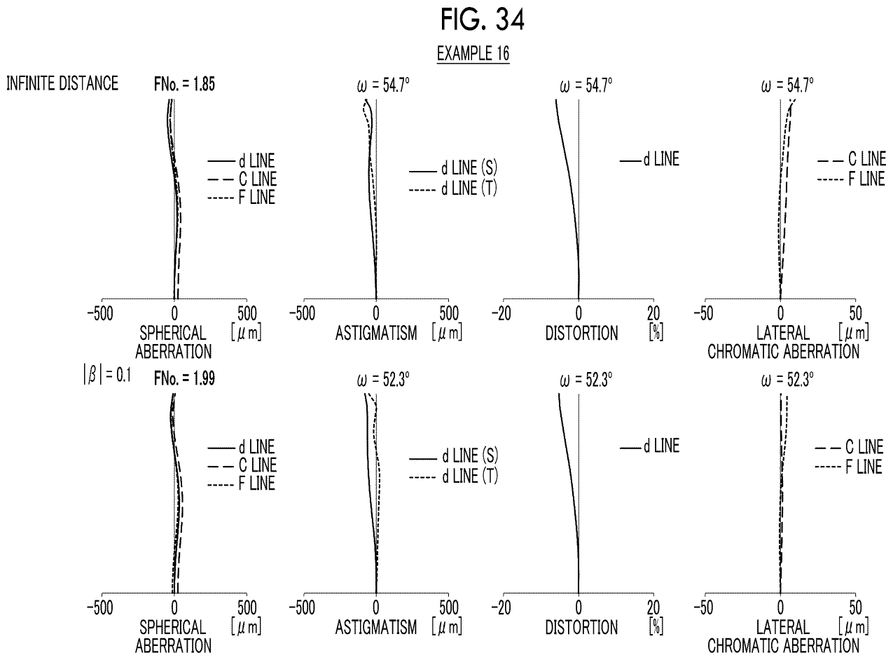

Regarding the imaging lens of Example 16, Table 61 shows basic lens data, Table 62 shows specifications, Table 63 shows a variable surface spacing, Table 64 shows an aspherical coefficient, and FIG. 34 shows each aberration diagram.

TABLE 16
Example 16

| | Sn | R | D | Nd | νd | θgF |
|---|---|---|---|---|---|---|
| Gf | *1 | 66.6799 | 1.4208 | 1.79526 | 45.25 | 0.55894 |
| | *2 | 20.7709 | 8.6499 | | | |
| | 3.00 | 39.6881 | 1.4998 | 1.49700 | 81.61 | 0.53887 |
| | 4.00 | 20.2665 | 10.5983 | | | |
| | 5.0 | −39.7959 | 1.5098 | 1.49700 | 81.64 | 0.53714 |
| | 6 | 24.7313 | 5.4961 | 1.96300 | 24.11 | 0.62126 |
| | 7 | 1751.3612 | 3.2277 | | | |
| | 8 | −44.3524 | 1.5002 | 2.00272 | 19.32 | 0.64514 |
| | 9 | −252.7208 | 0.2296 | | | |
| | *10 | 139.8467 | 7.8459 | 1.80139 | 45.45 | 0.55814 |
| | *11 | −39.7019 | 10.2515 | | | |
| | 12(St) | ∞ | DD12 | | | |
| | 13 | 27.5675 | 5.4884 | 1.49782 | 82.57 | 0.53862 |
| | 14 | −43.8085 | 0.1998 | | | |
| | 15 | 72.3294 | 4.6501 | 1.55032 | 75.50 | 0.54001 |
| | 16 | −21.9130 | 0.9998 | 1.90460 | 21.49 | 0.63238 |
| | 17 | 72.5006 | 3.9396 | | | |
| | 18 | 40.2199 | 5.0031 | 1.95906 | 17.47 | 0.65993 |
| | 19 | −56.0266 | 0.4296 | | | |
| | 20 | −542.5139 | 1.5001 | 1.86966 | 20.02 | 0.64349 |
| | 21 | 48.0320 | 7.5513 | | | |
| | *22 | 23.3232 | 1.6127 | 1.88259 | 37.18 | 0.57775 |
| | *23 | 18.2398 | DD23 | | | |
| | 24 | 57.4352 | 3.6803 | 1.49782 | 82.57 | 0.53862 |
| | 25 | −2501.9839 | 13.4484 | | | |

TABLE 62
Example 16

| | |
|---|---|
| f | 16.32 |
| Bf | 13.45 |
| FNo. | 1.85 |
| 2 ωm[°] | 109.4 |

TABLE 63
Example 16

| | Infinity | \|β\| = 0.1 |
|---|---|---|
| DD12 | 2.4999 | 0.1887 |
| DD23 | 1.6673 | 3.9785 |

TABLE 64
Example 16

| Sn | 1 | 2 | 10 | 11 |
|---|---|---|---|---|
| KA | 1.0000000E+00 | 4.0600000E−01 | 1.0000000E+00 | 1.0000000E+00 |
| A3 | 4.8178902E−04 | 5.0358084E−04 | −2.4368695E−05 | −1.7313228E−05 |
| A4 | −8.2195019E−06 | −3.8560620E−06 | −1.5128595E−05 | −3.9668194E−06 |
| A5 | −2.2977486E−07 | 3.9603030E−07 | −1.0387449E−06 | −1.6063178E−07 |
| A6 | −3.2449230E−09 | 1.4825315E−08 | 3.6243845E−08 | −7.8947174E−08 |
| A7 | 2.8060426E−10 | −3.2468386E−09 | −1.6294220E−09 | 3.0458403E−09 |
| A8 | 1.4502183E−11 | 1.6789122E−10 | −2.4264244E−10 | 1.0565471E−10 |
| A9 | 1.2471334E−13 | −4.1133959E−13 | −8.1952462E−12 | −3.7604158E−12 |
| A10 | −1.2656947E−14 | −7.8201123E−14 | 4.9144451E−13 | −4.6574350E−13 |
| A11 | −2.5192004E−16 | 2.0389109E−15 | 2.7123768E−14 | −1.2678234E−13 |
| A12 | −6.7886351E−18 | 2.2935836E−17 | 6.7987897E−16 | 5.4290550E−15 |
| A13 | −1.8812068E−19 | 2.9267556E−18 | −6.1486712E−16 | −4.6233710E−17 |
| A14 | 4.6549511E−21 | −1.8297264E−19 | 1.0264578E−17 | 1.6871566E−17 |
| A15 | 2.3942899E−22 | 4.2657952E−22 | 7.5395651E−18 | 4.9935237E−19 |
| A16 | 7.5056272E−24 | 1.0076554E−21 | −1.5077655E−19 | −1.1470052E−20 |
| A17 | 5.9660107E−25 | 1.0513073E−22 | −5.0515498E−20 | 1.1353184E−20 |
| A18 | −1.3356802E−26 | 7.0170601E−24 | −3.3668419E−21 | −2.4438741E−21 |
| A19 | −3.2336444E−28 | −6.1681868E−25 | 6.5711731E−22 | 1.1475791E−22 |
| A20 | −6.0769944E−30 | −2.2154890E−26 | −2.0628500E−23 | −1.3513760E−24 |

| Sn | 22 | 23 |
|---|---|---|
| KA | 1.0000000E+00 | 1.0000000E+00 |
| A3 | −1.7586299E−05 | −2.3954262E−05 |
| A4 | −1.8678763E−04 | −1.7919540E−04 |
| A5 | −3.0294125E−06 | −4.6565704E−06 |
| A6 | 5.6351004E−08 | 3.7859039E−07 |
| A7 | −2.6617580E−09 | 3.6716085E−09 |
| A8 | 3.3502732E−09 | 2.7414651E−09 |
| A9 | 2.9486229E−11 | 2.6868793E−11 |
| A10 | −2.3376235E−11 | −1.9864852E−11 |
| A11 | 2.8653558E−13 | 3.4341384E−14 |
| A12 | 7.1045987E−14 | 4.3749885E−14 |
| A13 | −1.5471132E−16 | −1.4926763E−16 |
| A14 | −1.0182286E−16 | 3.4003334E−17 |
| A15 | −5.6637796E−19 | −3.0558168E−18 |
| A16 | 1.2589173E−19 | −1.4127206E−19 |
| A17 | −7.8246208E−20 | −1.7394097E−22 |
| A18 | −4.5831365E−22 | 2.4951609E−22 |
| A19 | 5.6925563E−22 | −1.8428377E−23 |
| A20 | −1.9633374E−23 | 1.1040589E−24 |

### Example 17

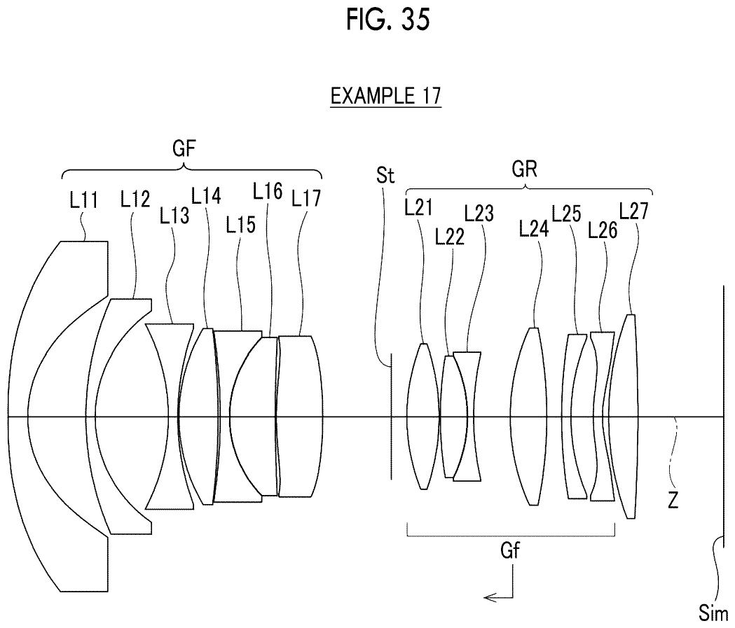

A cross-sectional view of a configuration of an imaging lens of Example 17 is shown in FIG. 35. The imaging lens of Example 17 consists of, in order from the object side to the image side, the front group GF having a negative refractive power, the aperture stop St, and the rear group GR having a positive refractive power. The rear group GR includes a single focus lens group Gf having a positive refractive power.

The front group GF consists of seven lenses of the lenses L11 to L17 in order from the object side to the image side. The rear group GR consists of seven lenses of the lenses L21 to L27 in order from the object side to the image side. The single focus lens group Gf consists of six lenses of the lenses L21 to L26. During focusing from the infinite distance object to the closest object, the single focus lens group Gf moves to the object side, and the other lenses and the aperture stop St are fixed with respect to the image plane Sim.

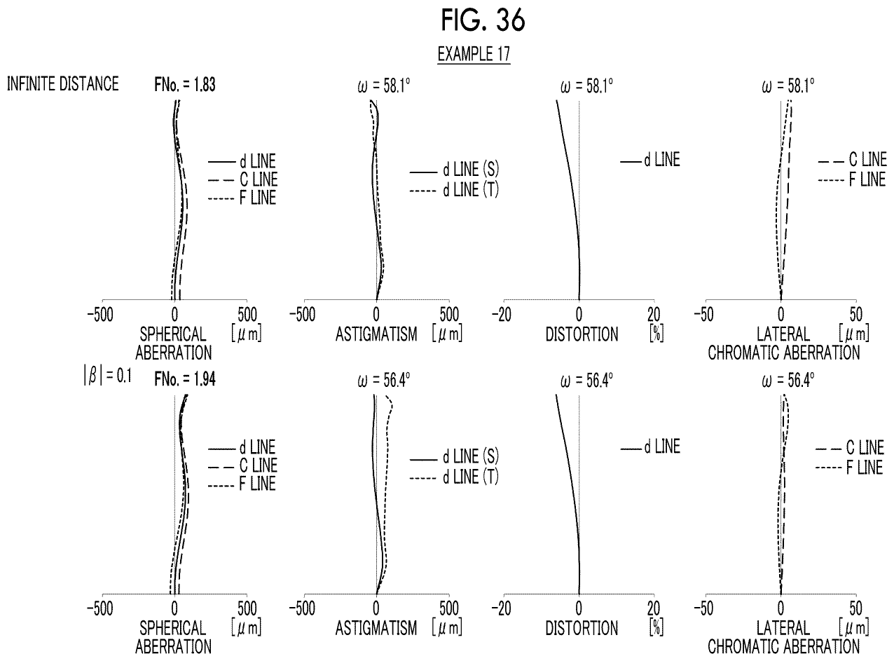

Regarding the imaging lens of Example 17, Table 65 shows basic lens data, Table 66 shows specifications, Table 67 shows a variable surface spacing, Table 68 shows an aspherical coefficient, and FIG. 36 shows each aberration diagram.

TABLE 65
Example 17

| | Sn | R | D | Nd | νd | θgF |
|---|---|---|---|---|---|---|
| Gf | *1 | 172.3838 | 3.1796 | 1.67798 | 54.89 | 0.54485 |
| | *2 | 22.5803 | 9.3247 | | | |
| | 3.00 | 48.9701 | 1.5000 | 1.59282 | 68.62 | 0.54414 |
| | 4.00 | 21.4484 | 11.7565 | | | |
| | 5.0 | −33.3433 | 1.4998 | 1.55200 | 70.70 | 0.54219 |
| | 6 | 42.7872 | 0.1998 | | | |
| | 7 | 29.1981 | 6.2791 | 1.85478 | 24.80 | 0.61232 |
| | 8 | −122.5017 | 0.3512 | | | |
| | 9 | −94.7119 | 1.5002 | 2.00272 | 19.32 | 0.64514 |
| | 10 | 19.1435 | 7.3380 | 1.92286 | 18.90 | 0.64990 |
| | 11 | 250.7819 | 0.1999 | | | |
| | *12 | 56.6610 | 7.4358 | 1.83461 | 37.29 | 0.57639 |
| | *13 | −73.8299 | 10.9235 | | | |
| | 14(St) | ∞ | DD14 | | | |
| | 15 | 33.3802 | 5.1784 | 1.49782 | 82.57 | 0.53862 |
| | 16 | −38.0823 | 0.1998 | | | |
| | 17 | 63.4253 | 4.3630 | 1.56907 | 71.30 | 0.54432 |
| | 18 | −23.7802 | 1.0002 | 1.90682 | 21.17 | 0.63332 |
| | 19 | 48.7614 | 5.8690 | | | |
| | 20 | 36.1727 | 5.8737 | 1.95906 | 17.47 | 0.65993 |
| | 21 | −77.0160 | 2.3889 | | | |
| | 22 | 85.8639 | 1.4998 | 1.90460 | 21.49 | 0.63238 |
| | 23 | 34.4375 | 3.5629 | | | |
| | *24 | 25.0360 | 1.4999 | 2.00178 | 19.32 | 0.64480 |
| | *25 | 18.8948 | DD25 | | | |
| | 26 | 49.5295 | 4.6900 | 1.51741 | 52.16 | 0.56212 |
| | 27 | −281.1394 | 13.7968 | | | |

TABLE 66
Example 17

| | |
|---|---|
| f | 14.32 |
| Bf | 13.80 |
| FNo. | 1.83 |
| 2 ωm[°] | 116.2 |

TABLE 67
Example 17

| | Infinity | \|β\| = 0.1 |
|---|---|---|
| DD14 | 2.5000 | 0.2093 |
| DD25 | 0.9998 | 3.2905 |

TABLE 68
Example 17

| Sn | 1 | 2 | 12 | 13 |
|---|---|---|---|---|
| KA | 1.0000000E+00 | 4.0600000E−01 | 1.0000000E+00 | 1.0000000E+00 |
| A3 | 4.1262266E−04 | 4.9988012E−04 | −2.3265838E−05 | −3.1694256E−05 |
| A4 | −7.1419475E−06 | −2.0379692E−05 | −1.7330369E−05 | −3.0035647E−06 |
| A5 | −4.3269763E−09 | 1.6278755E−06 | −1.0661802E−06 | −5.8495160E−07 |
| A6 | −5.0099856E−09 | −1.8336032E−08 | 2.4034190E−08 | −7.7086063E−08 |
| A7 | 1.5157390E−10 | −4.4814384E−09 | −1.0907473E−09 | 3.5509362E−09 |
| A8 | 8.2997571E−12 | 1.5880790E−10 | −3.0296019E−10 | 4.6347777E−11 |
| A9 | 7.1856122E−14 | 1.1530196E−12 | −1.0637347E−11 | −3.8515601E−12 |
| A10 | −9.5575777E−15 | 5.9358362E−14 | 5.0479010E−13 | −3.8368169E−13 |
| A11 | −5.1796272E−17 | 4.3294018E−15 | 1.1005562E−14 | −1.1818262E−13 |
| A12 | −1.4576481E−18 | −1.9285238E−16 | 2.7663894E−15 | 5.0983119E−15 |
| A13 | −2.3063451E−20 | −5.3966555E−18 | −5.2758884E−16 | 6.8147996E−18 |
| A14 | 2.6692392E−21 | −8.0693491E−19 | 1.8723428E−17 | 2.3658203E−17 |
| A15 | 1.5601354E−22 | −2.7735972E−20 | 7.7010503E−18 | 1.4473892E−18 |
| A16 | 2.2303957E−24 | 3.9859311E−22 | −1.5610213E−19 | −8.8467156E−20 |
| A17 | −1.5241235E−26 | 9.7468103E−23 | −5.5244481E−20 | 5.2268944E−21 |
| A18 | −4.1548416E−27 | 7.4068816E−24 | −3.5692666E−21 | −2.2930371E−21 |
| A19 | −1.2199570E−28 | −1.7429863E−25 | 6.7057028E−22 | 1.2397676E−22 |
| A20 | 3.6672277E−30 | −1.0898692E−26 | −1.9421536E−23 | −1.0361141E−24 |

| Sn | 24 | 25 |
|---|---|---|
| KA | 1.0000000E+00 | 1.0000000E+00 |
| A3 | −9.2874503E−05 | −6.7559343E−05 |
| A4 | −1.5045275E−04 | −1.5234700E−04 |
| A5 | −2.9745516E−06 | −3.5530059E−06 |
| A6 | 7.2533638E−08 | 3.3076416E−07 |
| A7 | 9.5071513E−10 | 4.7206791E−09 |
| A8 | 3.5313721E−09 | 2.7840047E−09 |
| A9 | 4.3013061E−11 | 2.2634473E−11 |
| A10 | −2.4948328E−11 | −2.0974307E−11 |
| A11 | 1.5581054E−13 | 4.8632274E−15 |
| A12 | 6.6860168E−14 | 4.2658444E−14 |
| A13 | −4.9872354E−16 | −1.0578259E−16 |
| A14 | −1.1219734E−16 | 3.2677364E−17 |
| A15 | −1.4423039E−18 | −2.9369533E−18 |
| A16 | 2.6129255E−19 | −5.9557022E−20 |
| A17 | −5.6226812E−20 | 4.1737927E−21 |
| A18 | 8.5665911E−22 | 1.5999524E−23 |
| A19 | 5.3123900E−22 | −2.4809304E−23 |
| A20 | −2.4874019E−23 | 9.7239769E−25 |

### Example 18

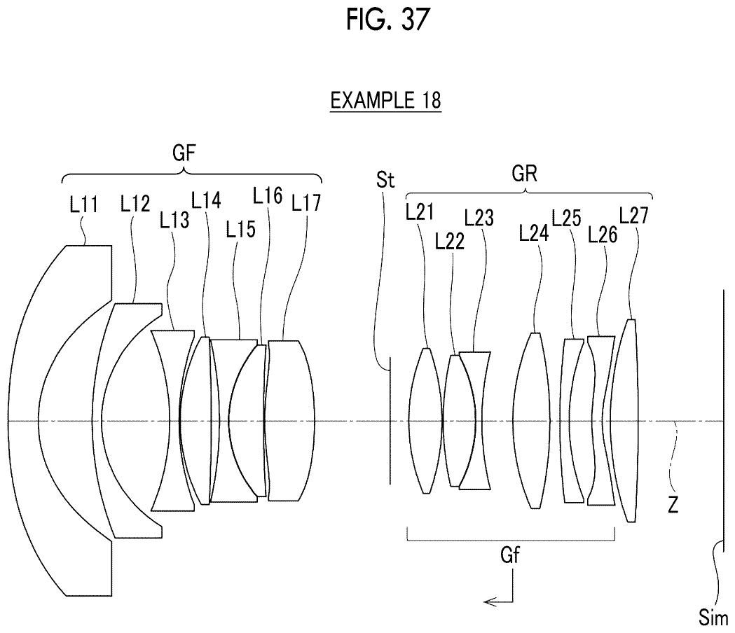

A cross-sectional view of a configuration of an imaging lens of Example 18 is shown in FIG. 37. The imaging lens of Example 18 consists of, in order from the object side to the image side, the front group GF having a negative refractive power, the aperture stop St, and the rear group GR having a positive refractive power. The rear group GR includes a single focus lens group Gf having a positive refractive power.

The front group GF consists of seven lenses of the lenses L11 to L17 in order from the object side to the image side. The rear group GR consists of seven lenses of the lenses L21 to L27 in order from the object side to the image side. The single focus lens group Gf consists of six lenses of the lenses L21 to L26. During focusing from the infinite distance object to the closest object, the single focus lens group Gf moves to the object side, and the other lenses and the aperture stop St are fixed with respect to the image plane Sim.

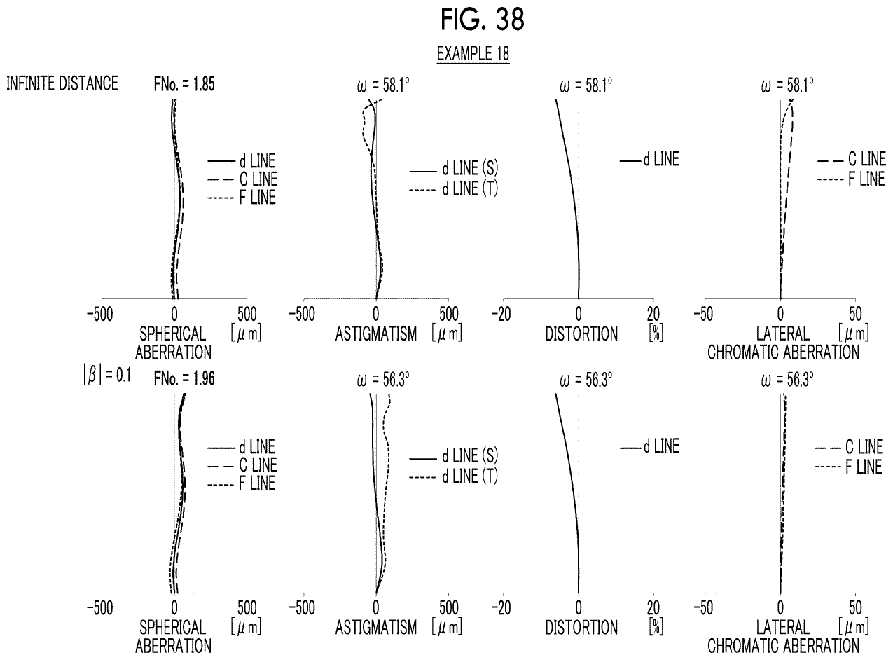

Regarding the imaging lens of Example 18, Table 69 shows basic lens data, Table 70 shows specifications, Table 71 shows a variable surface spacing, Table 72 shows an aspherical coefficient, and FIG. 38 shows each aberration diagram.

TABLE 69
Example 18

| | Sn | R | D | Nd | νd | θgF |
|---|---|---|---|---|---|---|
| Gf | *1 | 88.9714 | 4.8512 | 1.80604 | 40.74 | 0.56899 |
| | *2 | 22.5807 | 8.6595 | | | |
| | 3.00 | 53.0107 | 1.5001 | 1.55032 | 75.50 | 0.54001 |
| | 4.00 | 20.6386 | 10.9562 | | | |
| | 5.0 | −38.4167 | 1.4998 | 1.57144 | 71.61 | 0.54193 |
| | 6 | 40.8766 | 0.1998 | | | |
| | 7 | 30.1958 | 4.9903 | 1.94595 | 17.98 | 0.65460 |
| | 8 | −285.1049 | 1.3092 | | | |
| | 9 | −62.9394 | 1.5001 | 2.01960 | 21.45 | 0.63675 |
| | 10 | 19.5153 | 5.5841 | 1.90460 | 21.49 | 0.63238 |
| | 11 | 215.6265 | 0.2002 | | | |
| | *12 | 46.5888 | 8.0002 | 1.76544 | 46.75 | 0.55655 |
| | *13 | −47.0900 | 12.0521 | | | |
| | 14(St) | ∞ | DD14 | | | |
| | 15 | 32.0817 | 5.3364 | 1.49782 | 82.57 | 0.53862 |
| | 16 | −37.0214 | 0.1998 | | | |
| | 17 | 50.0539 | 5.2085 | 1.52841 | 76.45 | 0.53954 |
| | 18 | −23.4365 | 0.9999 | 1.89286 | 20.36 | 0.63944 |
| | 19 | 47.8737 | 4.9766 | | | |
| | 20 | 37.2249 | 5.9556 | 1.95906 | 17.47 | 0.65993 |
| | 21 | −65.4257 | 1.5957 | | | |
| | 22 | 117.5178 | 1.4998 | 1.92119 | 23.96 | 0.62025 |
| | 23 | 37.0576 | 3.6425 | | | |
| | *24 | 27.3019 | 1.6694 | 1.88259 | 37.18 | 0.57775 |
| | *25 | 19.3097 | DD25 | | | |
| | 26 | 51.9176 | 4.4729 | 1.49700 | 81.54 | 0.53748 |
| | 27 | −286.9739 | 13.7541 | | | |

TABLE 70
Example 18

| | |
|---|---|
| f | 14.32 |
| Bf | 13.75 |
| FNo. | 1.85 |
| 2 ωm[°] | 116.2 |

TABLE 71
Example 18

| | Infinity | \|β\| = 0.1 |
|---|---|---|
| DD14 | 2.9956 | 0.7697 |
| DD25 | 1.3009 | 3.5267 |

TABLE 72
Example 18

| Sn | 1 | 2 | 12 | 13 |
|---|---|---|---|---|
| KA | 1.0000000E+00 | 4.0600000E−01 | 1.0000000E+00 | 1.0000000E+00 |
| A3 | 1.6736897E−04 | 2.4790933E−04 | −8.3758769E−06 | −3.0982108E−05 |
| A4 | 1.2993900E−06 | −1.0462567E−05 | −2.5042296E−05 | −2.7366538E−06 |
| A5 | −2.5032639E−08 | 1.1977349E−06 | −7.9803913E−07 | −5.7510787E−07 |
| A6 | −6.6041799E−09 | −1.6956090E−08 | 2.7795172E−08 | −7.7216517E−08 |
| A7 | 1.0923673E−10 | −4.0305710E−09 | −1.5327036E−09 | 3.1907078E−09 |
| A8 | 8.2739053E−12 | 1.7223607E−10 | −3.3072332E−10 | 1.1768418E−10 |
| A9 | 8.8562284E−14 | 1.6431968E−12 | −1.1759483E−11 | −9.7249273E−12 |
| A10 | −8.3917653E−15 | 8.8948397E−15 | 6.6115846E−13 | −8.0611077E−13 |
| A11 | −6.7519578E−17 | 3.0129613E−15 | −6.5520680E−14 | −1.0289776E−13 |
| A12 | −7.7666666E−19 | −2.3406427E−16 | 4.5130679E−15 | 5.3465004E−15 |
| A13 | −1.8550707E−20 | −4.8615687E−18 | −5.5691686E−16 | −5.8217394E−17 |
| A14 | 2.3591278E−21 | −8.3212854E−19 | 5.1442192E−17 | 2.6720572E−17 |
| A15 | 1.4026366E−22 | −2.5727501E−20 | 7.7981046E−18 | 2.5970841E−19 |
| A16 | 2.2814064E−24 | 9.5075430E−22 | −2.8559768E−19 | −1.2514608E−20 |
| A17 | −1.9400466E−26 | 1.0793652E−22 | −4.8469335E−20 | 1.0975012E−20 |
| A18 | −4.1536818E−27 | 7.7739918E−24 | −5.4187554E−21 | −2.6622522E−21 |
| A19 | −1.1586517E−28 | −1.7824978E−25 | 6.8395963E−22 | 1.0255270E−22 |
| A20 | 3.6168265E−30 | −1.2662080E−26 | −1.5263475E−23 | 1.6020861E−26 |

| Sn | 24 | 25 |
|---|---|---|
| KA | 1.0000000E+00 | 1.0000000E+00 |
| A3 | −1.2882845E−04 | −7.9648813E−05 |
| A4 | −1.3964183E−04 | −1.4079877E−04 |
| A5 | −3.4999033E−06 | −3.4994672E−06 |
| A6 | 8.6966018E−08 | 3.3086063E−07 |
| A7 | 1.0331883E−09 | 2.9579832E−09 |
| A8 | 3.4268136E−09 | 2.7571702E−09 |
| A9 | 4.3732751E−11 | 2.2939217E−11 |
| A10 | −2.5399994E−11 | −2.0886606E−11 |
| A11 | 1.4910271E−13 | 9.4501874E−15 |
| A12 | 6.8176379E−14 | 4.3014724E−14 |
| A13 | −5.2951530E−16 | −1.4108587E−16 |
| A14 | −9.8114594E−17 | 3.6335556E−17 |
| A15 | −1.4913391E−18 | −2.7734574E−18 |
| A16 | 3.5427442E−19 | −5.9227523E−20 |
| A17 | −5.9471941E−20 | 3.9287534E−21 |
| A18 | 6.1468466E−22 | 3.7291322E−23 |
| A19 | 5.3977253E−22 | −3.0474841E−23 |
| A20 | −2.5664360E−23 | 1.0757625E−24 |

### Example 19

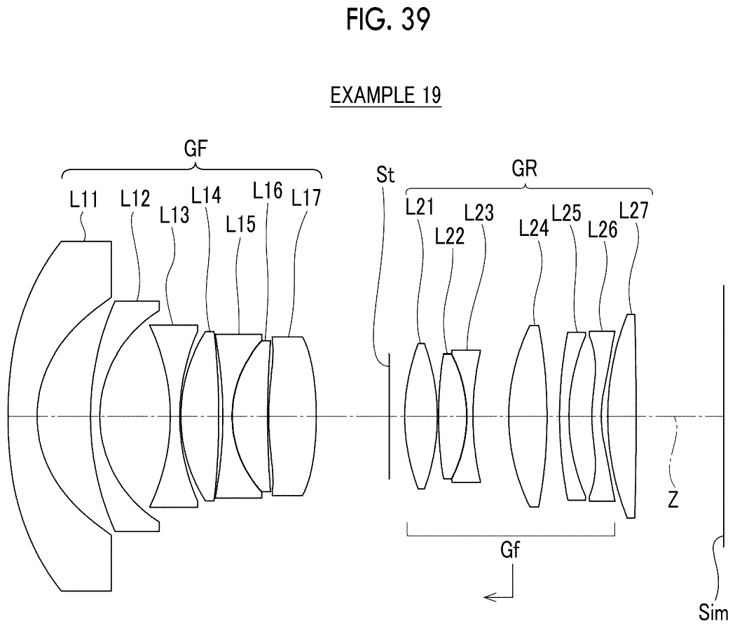

A cross-sectional view of a configuration of an imaging lens of Example 19 is shown in FIG. 39. The imaging lens of Example 19 consists of, in order from the object side to the image side, the front group GF having a negative refractive power, the aperture stop St, and the rear group GR having a positive refractive power. The rear group GR includes a single focus lens group Gf having a positive refractive power.

The front group GF consists of seven lenses of the lenses L11 to L17 in order from the object side to the image side. The rear group GR consists of seven lenses of the lenses L21 to L27 in order from the object side to the image side. The single focus lens group Gf consists of six lenses of the lenses L21 to L26. During focusing from the infinite distance object to the closest object, the single focus lens group Gf moves to the object side, and the other lenses and the aperture stop St are fixed with respect to the image plane Sim.

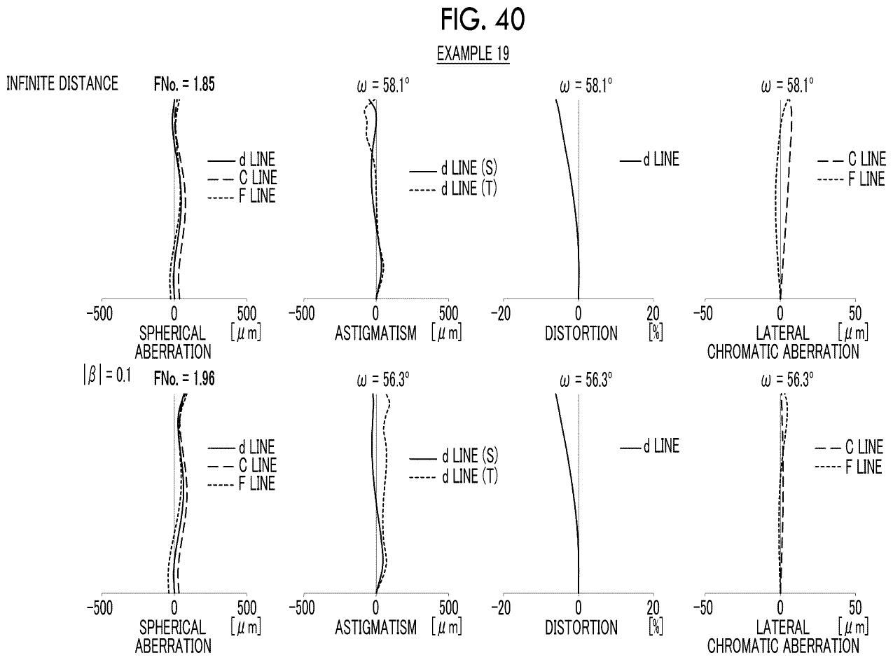

Regarding the imaging lens of Example 19, Table 73 shows basic lens data, Table 74 shows specifications, Table 75 shows a variable surface spacing, Table 76 shows an aspherical coefficient, and FIG. 40 shows each aberration diagram.

TABLE 73
Example 19

| | Sn | R | D | Nd | νd | θgF |
|---|---|---|---|---|---|---|
| Gf | *1 | 111.9028 | 4.6725 | 1.77387 | 47.25 | 0.55571 |
| | *2 | 22.2451 | 8.5700 | | | |
| | 3.00 | 47.9764 | 1.5000 | 1.59282 | 68.62 | 0.54414 |
| | 4.00 | 20.8086 | 11.3354 | | | |
| | 5.0 | −35.5850 | 1.5002 | 1.49700 | 81.54 | 0.53748 |
| | 6 | 35.6589 | 0.1998 | | | |
| | 7 | 26.9092 | 6.0792 | 1.86966 | 20.02 | 0.64349 |
| | 8 | −128.9072 | 0.6606 | | | |
| | 9 | −74.2194 | 1.4998 | 2.01960 | 21.45 | 0.63675 |
| | 10 | 18.8358 | 5.6814 | 1.84666 | 23.78 | 0.62054 |
| | 11 | 161.1574 | 0.1998 | | | |
| | *12 | 50.5944 | 7.6243 | 1.85060 | 41.62 | 0.56454 |
| | *13 | −57.9405 | 11.6258 | | | |
| | 14(St) | ∞ | DD14 | | | |
| | 15 | 34.2801 | 5.2283 | 1.49782 | 82.57 | 0.53862 |
| | 16 | −36.1144 | 0.1998 | | | |
| | 17 | 67.2655 | 4.5354 | 1.57144 | 71.61 | 0.54193 |
| | 18 | −23.2521 | 0.9998 | 1.90460 | 21.49 | 0.63238 |
| | 19 | 49.5343 | 5.7496 | | | |
| | 20 | 34.8819 | 6.1588 | 1.95906 | 17.47 | 0.65993 |
| | 21 | −83.9251 | 2.0081 | | | |
| | 22 | 73.7336 | 1.5002 | 1.84666 | 23.78 | 0.62054 |
| | 23 | 34.0534 | 3.6943 | | | |
| | *24 | 27.3812 | 1.4998 | 2.00178 | 19.32 | 0.64480 |
| | *25 | 19.6182 | DD25 | | | |
| | 26 | 46.8934 | 4.5610 | 1.49700 | 81.54 | 0.53748 |
| | 27 | −636.1526 | 14.0746 | | | |

TABLE 74
Example 19

| | |
|---|---|
| f | 14.32 |
| Bf | 14.07 |
| FNo. | 1.85 |
| 2 ωm[°] | 116.2 |

TABLE 75
Example 19

| | Infinity | \|β\| = 0.1 |
|---|---|---|
| DD14 | 2.4998 | 0.2420 |
| DD25 | 1.0516 | 3.3094 |

TABLE 76
Example 19

| Sn | 1 | 2 | 12 | 13 |
|---|---|---|---|---|
| KA | 1.0000000E+00 | 4.0600000E−01 | 1.0000000E+00 | 1.0000000E+00 |
| A3 | 2.3695648E−04 | 3.3564320E−04 | −1.0159972E−05 | −2.9992971E−05 |
| A4 | −3.2324991E−07 | −1.3810300E−05 | −2.0928448E−05 | −3.6119121E−06 |
| A5 | −4.7221803E−08 | 1.4132508E−06 | −9.1052510E−07 | −6.1050006E−07 |
| A6 | −6.4290689E−09 | −2.0839598E−08 | 3.1026505E−08 | −7.6518734E−08 |
| A7 | 1.2032942E−10 | −4.1895156E−09 | −1.9408387E−09 | 3.6138597E−09 |
| A8 | 8.9981149E−12 | 1.7609031E−10 | −3.2860580E−10 | 3.5412629E−11 |
| A9 | 8.2724393E−14 | 1.0878442E−12 | −1.4047804E−11 | −7.3774928E−12 |
| A10 | −9.5315372E−15 | 3.0549951E−14 | 2.3670629E−13 | −5.3353730E−13 |
| A11 | −4.9415720E−17 | 2.9205476E−15 | 4.9407213E−14 | −1.1496998E−13 |
| A12 | −1.1696626E−18 | −2.0781404E−16 | 2.5920002E−15 | 5.0693952E−15 |
| A13 | −2.0816969E−20 | −4.3219981E−18 | −5.5526777E−16 | 9.9789660E−17 |
| A14 | 2.4710734E−21 | −7.5261386E−19 | 2.3971624E−17 | 2.0828585E−17 |
| A15 | 1.4652651E−22 | −2.6001427E−20 | 6.5916091E−18 | 6.1170703E−19 |
| A16 | 2.1394477E−24 | 5.2069816E−22 | −2.1507344E−19 | −7.2029156E−20 |
| A17 | −1.4990618E−26 | 1.0021385E−22 | −5.6091173E−20 | 1.1689351E−20 |
| A18 | −4.2332351E−27 | 7.5182184E−24 | −3.4163767E−21 | −2.6560829E−21 |
| A19 | −1.1888076E−28 | −1.7588409E−25 | 6.9014080E−22 | 1.1694428E−22 |
| A20 | 3.6894220E−30 | −1.1789885E−26 | −2.0347913E−23 | −4.7962342E−25 |

| Sn | 24 | 25 |
|---|---|---|
| KA | 1.0000000E+00 | 1.0000000E+00 |
| A3 | −1.3061861E−04 | −9.0432441E−05 |
| A4 | −1.3109013E−04 | −1.3369853E−04 |
| A5 | −3.0638811E−06 | −3.1061841E−06 |
| A6 | 1.0617416E−07 | 3.2947750E−07 |
| A7 | 1.1177044E−09 | 2.3302984E−09 |
| A8 | 3.4100745E−09 | 2.7117487E−09 |
| A9 | 3.8380824E−11 | 2.1184154E−11 |
| A10 | −2.5423696E−11 | −2.0907705E−11 |
| A11 | 1.4042549E−13 | 9.8405526E−15 |
| A12 | 6.6482100E−14 | 4.2655731E−14 |
| A13 | −3.7228740E−16 | −1.3151797E−16 |
| A14 | −1.0782550E−16 | 3.6491653E−17 |
| A15 | −1.0976822E−18 | −2.7111422E−18 |
| A16 | 3.2737026E−19 | −6.3422852E−20 |
| A17 | −6.0607257E−20 | 3.8349409E−21 |
| A18 | 7.9069117E−22 | 6.9471821E−23 |
| A19 | 5.4079341E−22 | −2.7745357E−23 |
| A20 | −2.5262563E−23 | 9.2198598E−25 |

### Example 20

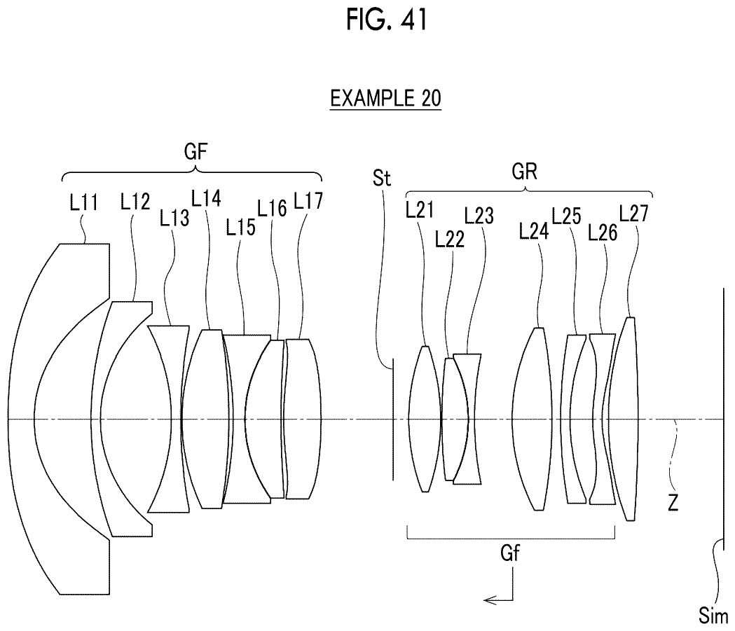

A cross-sectional view of a configuration of an imaging lens of Example 20 is shown in FIG. 41. The imaging lens of Example 20 consists of, in order from the object side to the image side, the front group GF having a negative refractive power, the aperture stop St, and the rear group GR having a positive refractive power. The rear group GR includes a single focus lens group Gf having a positive refractive power.

The front group GF consists of seven lenses of the lenses L11 to L17 in order from the object side to the image side. The rear group GR consists of seven lenses of the lenses L21 to L27 in order from the object side to the image side. The single focus lens group Gf consists of six lenses of the lenses L21 to L26. During focusing from the infinite distance object to the closest object, the single focus lens group Gf moves to the object side, and the other lenses and the aperture stop St are fixed with respect to the image plane Sim.

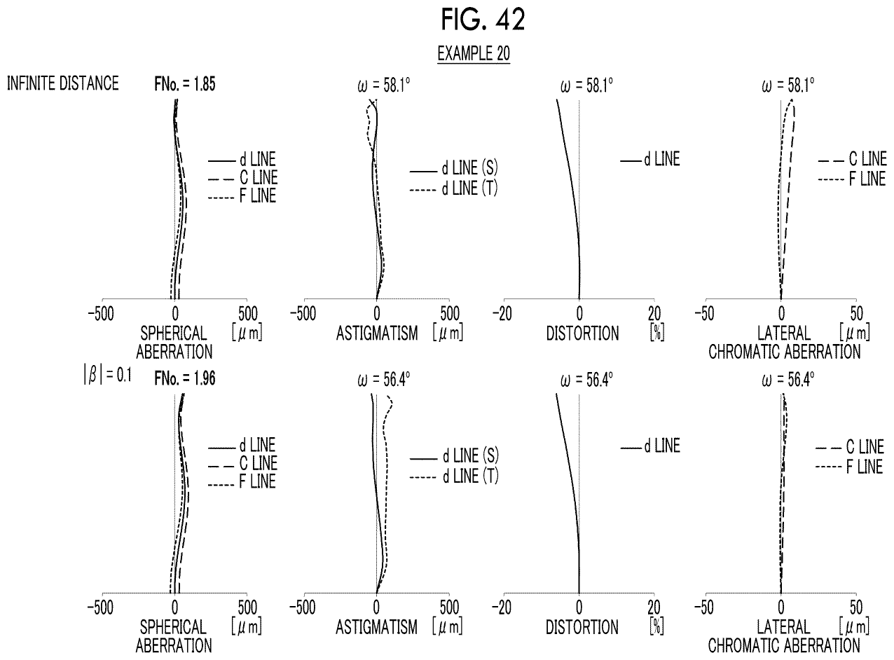

Regarding the imaging lens of Example 20, Table 77 shows basic lens data, Table 78 shows specifications, Table 79 shows a variable surface spacing, Table 80 shows an aspherical coefficient, and FIG. 42 shows each aberration diagram.

TABLE 77
Example 20

| | Sn | R | D | Nd | νd | θgF |
|---|---|---|---|---|---|---|
| Gf | *1 | 124.7103 | 4.1920 | 1.79526 | 45.25 | 0.55894 |
| | *2 | 22.5667 | 9.1445 | | | |
| | 3.00 | 56.8901 | 1.5000 | 1.55032 | 75.50 | 0.54001 |
| | 4.00 | 22.5311 | 11.4088 | | | |
| | 5.0 | −32.9833 | 1.4998 | 1.56907 | 71.30 | 0.54432 |
| | 6 | 83.5501 | 0.1998 | | | |
| | 7 | 35.3782 | 7.5276 | 1.89286 | 20.36 | 0.63944 |
| | 8 | −93.0817 | 0.6950 | | | |
| | 9 | −60.9099 | 1.9037 | 1.95906 | 17.47 | 0.65993 |
| | 10 | 22.7479 | 5.7847 | 1.98613 | 16.48 | 0.66558 |
| | 11 | 164.6946 | 0.4228 | | | |
| | *12 | 51.4378 | 6.0112 | 1.79890 | 41.85 | 0.56697 |
| | *13 | −73.5563 | 11.5043 | | | |
| | 14(St) | ∞ | DD14 | | | |
| | 15 | 34.5517 | 5.1221 | 1.49782 | 82.57 | 0.53862 |
| | 16 | −37.6195 | 0.1998 | | | |
| | 17 | 88.8755 | 4.2465 | 1.57144 | 71.61 | 0.54193 |
| | 18 | −22.7158 | 0.9998 | 1.86966 | 20.02 | 0.64349 |
| | 19 | 54.8879 | 6.0418 | | | |
| | 20 | 33.4040 | 6.3974 | 1.95906 | 17.47 | 0.65993 |
| | 21 | −83.0541 | 1.4006 | | | |
| | 22 | 83.8552 | 1.4998 | 2.00100 | 29.12 | 0.59962 |
| | 23 | 35.3125 | 3.6536 | | | |
| | *24 | 25.7810 | 1.5001 | 2.00178 | 19.32 | 0.64480 |
| | *25 | 18.8734 | DD25 | | | |
| | 26 | 49.5847 | 4.7533 | 1.49782 | 82.57 | 0.53862 |
| | 27 | −237.6927 | 13.7729 | | | |

TABLE 78
Example 20

| | |
|---|---|
| f | 14.32 |
| Bf | 13.77 |
| FNo. | 1.85 |
| 2 com[°] | 116.2 |

TABLE 79
Example 20

| | Infinity | \|β\| = 0.1 |
|---|---|---|
| DD14 | 2.4999 | 0.2449 |
| DD25 | 1.0295 | 3.2844 |

TABLE 80
Example 20

| Sn | 1 | 2 | 12 | 13 |
|---|---|---|---|---|
| KA | 1.0000000E+00 | 4.0600000E−01 | 1.0000000E+00 | 1.0000000E+00 |
| A3 | 2.7110108E−04 | 3.5719178E−04 | −1.6024418E−05 | −2.9517250E−05 |
| A4 | −2.5220827E−06 | −1.5204327E−05 | −2.0679615E−05 | −2.8242817E−06 |
| A5 | −4.6414563E−09 | 1.3767540E−06 | −9.9518539E−07 | −6.1658140E−07 |
| A6 | −6.3724392E−09 | −1.9725977E−08 | 2.9305696E−08 | −8.0227108E−08 |
| A7 | 1.1905767E−10 | −4.1941209E−09 | −2.8293557E−09 | 2.6349394E−09 |
| A8 | 8.5208445E−12 | 1.7288962E−10 | −3.0132497E−10 | 2.0631438E−11 |
| A9 | 9.1838747E−14 | 1.0880840E−12 | −1.1511977E−11 | −5.3357333E−12 |
| A10 | −9.4101564E−15 | 2.3086106E−14 | 3.3279995E−13 | −5.2000166E−13 |
| A11 | −5.8526453E−17 | 3.6110845E−15 | 4.2114039E−14 | −8.6532876E−14 |
| A12 | −6.4804375E−19 | −1.9616490E−16 | 3.0776675E−15 | 3.4288963E−15 |
| A13 | −1.7226270E−20 | −6.8309188E−18 | −7.5436625E−16 | −2.0160312E−16 |
| A14 | 2.2637672E−21 | −7.8127332E−19 | 1.4939853E−17 | 3.6016806E−17 |
| A15 | 1.4261108E−22 | −2.6390636E−20 | 7.9415702E−18 | 1.0368411E−18 |
| A16 | 1.9505865E−24 | 8.5450788E−22 | −1.9935702E−19 | −9.2406523E−20 |
| A17 | −1.4347173E−26 | 1.0654825E−22 | −5.0356326E−20 | 1.1425024E−20 |
| A18 | −4.0329387E−27 | 7.7366467E−24 | −4.0253954E−21 | −2.5019908E−21 |
| A19 | −1.1420408E−28 | −1.8002593E−25 | 7.1751924E−22 | 1.1111470E−22 |
| A20 | 3.5097703E−30 | −1.2717178E−26 | −2.1465546E−23 | −6.8782527E−25 |

| Sn | 24 | 25 |
|---|---|---|
| KA | 1.0000000E+00 | 1.0000000E+00 |
| A3 | −1.4901073E−04 | −1.2512803E−04 |
| A4 | −1.3958653E−04 | −1.3970307E−04 |
| A5 | −3.1075414E−06 | −3.6165767E−06 |
| A6 | 9.6709925E−08 | 3.5094509E−07 |
| A7 | 1.0993789E−09 | 3.0985756E−09 |
| A8 | 3.4504888E−09 | 2.7559386E−09 |
| A9 | 4.3266878E−11 | 2.1495518E−11 |
| A10 | −2.5366418E−11 | −2.1058499E−11 |
| A11 | 1.4304357E−13 | 3.6944028E−15 |
| A12 | 6.6126321E−14 | 4.2004414E−14 |
| A13 | −3.3655165E−16 | −1.0268953E−16 |
| A14 | −1.0727428E−16 | 3.6779070E−17 |
| A15 | −1.3845650E−18 | −2.6910168E−18 |
| A16 | 2.7514893E−19 | −6.5656984E−20 |
| A17 | −6.1639814E−20 | 2.9749415E−21 |
| A18 | 8.7689554E−22 | 5.9980947E−23 |
| A19 | 5.4828712E−22 | −2.7628251E−23 |
| A20 | −2.5114730E−23 | 1.1302794E−24 |

### Example 21

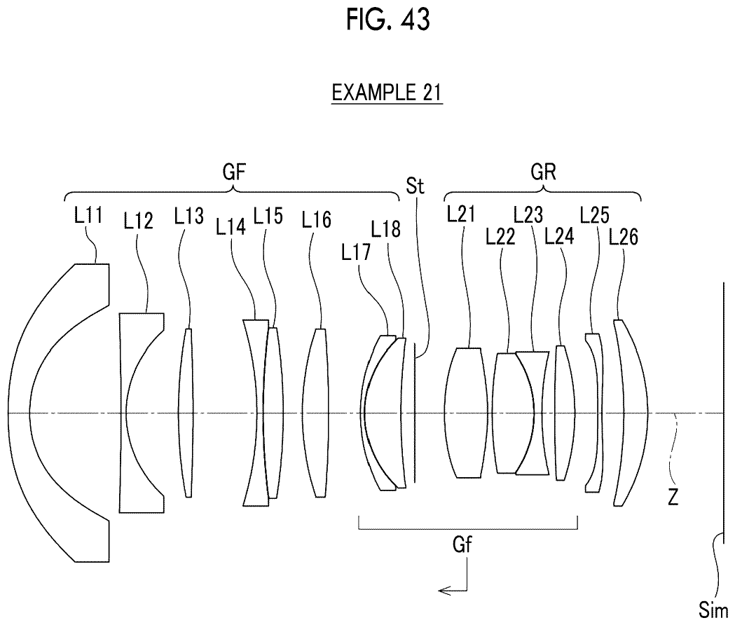

A cross-sectional view of a configuration of an imaging lens of Example 21 is shown in FIG. 43. The imaging lens of Example 21 consists of, in order from the object side to the image side, the front group GF having a positive refractive power, the aperture stop St, and the rear group GR having a positive refractive power. The imaging lens includes a single focus lens group Gf.

The front group GF consists of eight lenses of the lenses L11 to L18 in order from the object side to the image side.

The rear group GR consists of six lenses of the lenses L21 to L26 in order from the object side to the image side. The single focus lens group Gf consists of the lenses L17 and L18, the aperture stop St, and the lenses L21 to L24. During focusing from the infinite distance object to the closest object, the single focus lens group Gf moves to the object side, and the other lenses are fixed with respect to the image plane Sim.

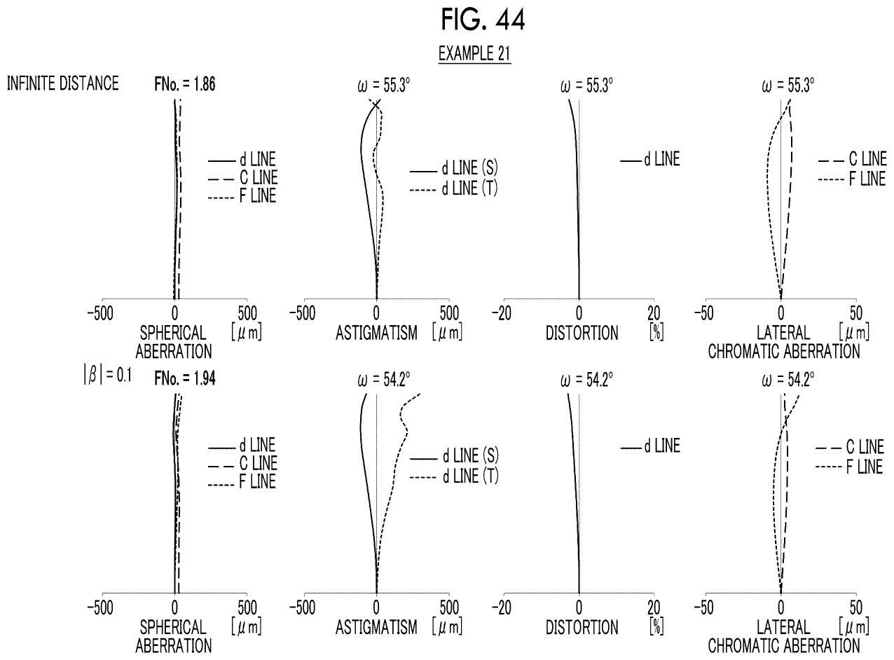

Regarding the imaging lens of Example 21, Table 81 shows basic lens data, Table 82 shows specifications, Table 83 shows a variable surface spacing, Table 84 shows an aspherical coefficient, and FIG. 44 shows each aberration diagram.

TABLE 81
Example 21

| | Sn | R | D | Nd | νd | θgF |
|---|---|---|---|---|---|---|
| Gf | *1 | 48.3795 | 3.4998 | 1.74199 | 52.68 | 0.54765 |
| | *2 | 19.6276 | 14.7875 | | | |
| | 3 | −554.9245 | 0.8555 | 1.72424 | 56.51 | 0.54265 |
| | 4 | 18.7182 | 8.4592 | | | |
| | 5 | 79.8562 | 2.3628 | 1.43999 | 66.25 | 0.52736 |
| | 6 | −337.6486 | 10.3709 | | | |
| | 7 | −54.1035 | 1.0100 | 1.43599 | 90.90 | 0.53134 |
| | 8 | 114.4957 | 3.2497 | 1.94202 | 34.53 | 0.58416 |
| | 9 | −94.5667 | 3.1042 | | | |
| | 10 | 45.5100 | 4.2501 | 1.70043 | 57.70 | 0.54226 |
| | 11 | −180.5458 | DD11 | | | |
| | 12 | 28.1162 | 0.6692 | 1.99999 | 28.60 | 0.60122 |
| | 13 | 17.2355 | 5.8049 | 1.53695 | 75.52 | 0.53974 |
| | 14 | 98.6565 | 2.2501 | | | |
| | 15(St) | ∞ | 4.8090 | | | |
| | *16 | 34.9172 | 7.0002 | 1.49833 | 81.40 | 0.53761 |
| | *17 | −38.8028 | 0.7352 | | | |
| | 18 | 59.7038 | 6.7988 | 1.53340 | 76.06 | 0.53955 |
| | 19 | −17.9401 | 1.2500 | 1.87451 | 41.44 | 0.56708 |
| | 20 | 45.8389 | 2.0831 | | | |
| | 21 | 231.8973 | 3.2560 | 1.44343 | 89.77 | 0.53209 |
| | 22 | −37.6525 | DD22 | | | |
| | *23 | −742.3099 | 0.6833 | 1.85400 | 40.39 | 0.56774 |
| | *24 | 88.1096 | 3.5464 | | | |
| | 25 | −70.4552 | 3.8726 | 1.77535 | 50.30 | 0.55004 |
| | 26 | −30.8140 | 12.3204 | | | |

TABLE 82
Example 21

| | |
|---|---|
| f | 15.39 |
| Bf | 12.32 |
| FNo. | 1.86 |
| 2 ωm[°] | 110.6 |

TABLE 83
Example 21

| | Infinity | \|β\| = 0.1 |
|---|---|---|
| DD11 | 5.1532 | 3.6163 |
| DD22 | 3.7251 | 5.2620 |

TABLE 84
Example 21

| Sn | 1 | 2 |
|---|---|---|
| KA | 1.0000000E+00 | 1.0000000E+00 |
| A4 | 2.3692064E−05 | 2.6842614E−05 |
| A6 | −3.7276990E−08 | −3.1514140E−09 |
| A8 | 3.3385145E−11 | 4.9679595E−11 |
| A10 | −1.9176905E−14 | −8.2860601E−13 |
| A12 | 2.2045223E−17 | 7.7875146E−16 |
| A14 | 6.5384964E−21 | 1.2570350E−18 |
| A16 | −8.3479917E−23 | 1.0695980E−20 |
| A18 | 6.8794733E−26 | −4.8582124E−23 |
| Sn | 16 | 17 |
| KA | 1.0000000E+00 | 1.0000000E+00 |
| A4 | 1.5709615E−05 | 2.9524649E−05 |
| A6 | 2.9041615E−08 | −4.2470915E−08 |
| A8 | 2.2563879E−10 | 3.0126048E−10 |
| A10 | −7.3303567E−13 | −1.9304744E−12 |
| Sn | 23 | 24 |
| KA | 3.2439831E+03 | 3.2005465E+01 |
| A4 | −7.6750128E−05 | −6.2770834E−05 |
| A6 | 9.6326718E−08 | 4.3545678E−08 |
| A8 | −5.8126441E−10 | 9.4772143E−10 |
| A10 | 4.7776236E−12 | −1.1179141E−11 |
| A12 | −3.0861179E−13 | −6.2333720E−14 |
| A14 | 3.7881779E−15 | 1.3970699E−15 |
| A16 | −1.8755066E−17 | −7.1743885E−18 |
| A18 | 3.2089431E−20 | 1.2202221E−20 |

Tables 85 to 94 show the corresponding values of Conditional Expressions (1) to (43) of the imaging lenses of Examples 1 to 21. In the columns of the corresponding values of Conditional Expressions (40) to (43), reference numerals of the corresponding lenses are written in parentheses below the corresponding values. Preferable ranges of the conditional expressions may be set using the corresponding values of the examples shown in Tables 85 to 94 as the upper limits and the lower limits of the conditional expressions.

TABLE 85

| Expres- | | Ex- | Ex- | Ex- | Ex- | Ex- |
|---|---|---|---|---|---|---|
| sion | | am- | am- | am- | am- | am- |
| number | | ple 1 | ple 2 | ple 3 | ple 4 | ple 5 |
| (1) | Bf/(f × tan | 0.550 | 0.511 | 0.704 | 0.683 | 0.589 |
| | ωm) | | | | | |
| (2) | STI/TL | 0.544 | 0.523 | 0.498 | 0.522 | 0.516 |
| (3) | fR/fF | 1.368 | 0.542 | 1.786 | 1.106 | −0.002 |
| (4) | f/RL1f | 0.284 | 0.175 | 0.100 | 0.167 | 0.105 |
| (5) | f/RL1r | 0.622 | 0.573 | 0.520 | 0.621 | 0.615 |
| (6) | f/fF | 0.547 | 0.315 | 0.522 | 0.342 | −0.001 |
| (7) | \|β\| | 0.2 | 0.2 | 0.2 | 0.1 | 0.1 |
| (8) | TL/(f × tan | 4.790 | 4.571 | 4.468 | 4.636 | 4.999 |
| | ωm) | | | | | |
| (9) | FNo/tan | 1.082 | 1.156 | 1.142 | 1.296 | 1.337 |
| | ωm | | | | | |
| (10) | νL1 | 54.89 | 67.86 | 67.86 | 54.89 | 66.92 |
| (11) | \|f/ff\| | — | — | — | 0.078 | 0.252 |
| (12) | \|TL/ff\| | — | — | — | 0.501 | 1.694 |
| (13) | f/ff_r | — | — | — | 0.510 | 0.534 |
| (14) | f/ff_f | — | — | — | −0.679 | −1.158 |
| (15) | f/ffs | — | — | — | — | — |
| (16) | \|ff1/ff2\| | 1.942 | 1.846 | 1.272 | — | — |
| (17) | \|βf1/βf2\| | 0.019 | 0.000 | 0.272 | — | — |
| (18) | {βf1 + | 0.141 | 0.112 | 0.167 | — | — |
| | (1/f1)}⁻² | | | | | |
| (19) | {βf2 + | 0.214 | 0.003 | 0.017 | — | — |
| | (1/βf2)}⁻² | | | | | |
| (20) | f/f2r | 0.400 | −0.044 | 0.525 | — | — |
| (21) | f/f1f | −0.808 | −1.013 | −1.096 | — | — |
| (22) | fL1/fL2 | 0.943 | 1.321 | 1.068 | 1.131 | 0.654 |
| (23) | fL1/f | −4.513 | −4.311 | −4.044 | −3.287 | −3.344 |
| (24) | (RL1r − | −0.373 | −0.533 | −0.679 | −0.576 | −0.708 |
| | RL1f)/ | | | | | |
| | (RL1r + | | | | | |
| | RL1f) | | | | | |
| (25) | (RL2r − | −0.266 | −0.535 | −0.365 | −0.265 | −0.382 |
| | RL2f)/ | | | | | |
| | (RL2r + | | | | | |
| | RL2f) | | | | | |
| (26) | fL3/fL4 | −0.040 | −0.312 | −0.296 | −1.271 | −0.703 |
| (27) | (RLer − | 2.772 | 2.760 | 0.718 | 2.214 | 3.857 |
| | RLef)/ | | | | | |
| | (RLer + | | | | | |
| | RLef) | | | | | |
| (28 | (1/RL1f − | 2.211 | 3.042 | 5.150 | 1.957 | 3.904 |
| | 1/RL1r)/ | | | | | |
| | (1/RyL1f − | | | | | |
| | 1/RyL1r) | | | | | |

TABLE 86

| Expres- | | Ex- | Ex- | Ex- | Ex- | Ex- |
|---|---|---|---|---|---|---|
| sion | | am- | am- | am- | am- | am- |
| number | | ple 1 | ple 2 | ple 3 | ple 4 | ple 5 |
| (29) | f/fFp | 0.514 | 0.795 | 0.557 | 0.228 | 0.439 |
| (30) | fR/fRp | 1.546 | 1.000 | 1.955 | 2.498 | 1.512 |
| (31) | νRp − νRn | — | — | — | — | — |
| (32) | NRp − NRn | — | — | — | — | — |
| (33) | (1/RcLFef − | — | — | — | — | — |
| | 1/RcLFer)/ | | | | | |
| | (1/RyLFef − | | | | | |
| | 1/RyLFer) | | | | | |
| (34) | (RcLFef − | −2.508 | −1.408 | −1.770 | −1.034 | −0.801 |
| | RcLFer)/ | | | | | |
| | (RcLFef + | | | | | |
| | RcLFer) | | | | | |
| (35) | νLFe | 56.25 | 42.34 | 47.22 | 81.49 | 88.97 |
| (36) | D1/TL | 0.020 | 0.027 | 0.022 | 0.021 | 0.033 |
| (37 | DH1/D1 | 5.562 | 4.497 | 4.803 | 3.961 | 2.835 |
| (38) | νLe | 66.38 | 86.42 | 72.45 | 57.78 | 56.99 |
| (39) | EL1/(f × tan ωm) | 1.209 | 1.293 | 1.288 | 1.168 | 1.395 |
| (40) | NLs − | 0.1122(L13) | — | 0.1142(L15) | 0.1135(L15) | — |
| | (2.015 − | | | | | |
| | 0.0068 × | | | | | |
| | νLs) | | | | | |
| (41) | νLs | 51.21(L13) | — | 50.56(L15) | 50.77(L15) | — |
| (42) | θgFLs | 0.54893(L13) | — | 0.54987(L15) | 0.54956(L15) | — |
| (43) | θgFLs − | −0.00684(L13) | — | −0.00699(L15) | −0.00695(L15) | — |
| | (0.6418 − | | | | | |
| | 0.00168 × | | | | | |
| | νLs) | | | | | |

TABLE 87

| Expres- | | Ex- | Ex- | Ex- | Ex- | Ex- |
|---|---|---|---|---|---|---|
| sion | | am- | am- | am- | am- | am- |
| number | | ple 6 | ple 7 | ple 8 | ple 9 | ple 10 |
| (1) | Bf/(f × tan | 0.560 | 0.742 | 0.598 | 0.594 | 0.494 |
| | ωm) | | | | | |
| (2) | STI/TL | 0.507 | 0.505 | 0.521 | 0.606 | 0.606 |
| (3) | fR/fF | −0.180 | −0.488 | 1.358 | 1.033 | 1.462 |
| (4) | f/RL1f | 0.057 | −0.005 | −0.070 | 0.114 | 0.129 |
| (5) | f/RL1r | 0.625 | 0.657 | 0.684 | 0.598 | 0.602 |
| (6) | f/fF | −0.074 | −0.241 | 0.387 | 0.326 | 0.411 |
| (7) | \|β\| | 0.2 | 0.2 | 0.2 | 0.1 | 0.1 |
| (8) | TL/(f × tan | 4.992 | 4.921 | 4.871 | 5.072 | 5.112 |
| | ωm) | | | | | |
| (9) | FNo/tan | 1.158 | 1.170 | 1.217 | 1.176 | 1.185 |
| | ωm | | | | | |
| (10) | νL1 | 67.86 | 67.86 | 66.92 | 54.89 | 53.30 |
| (11) | \|f/ff\| | — | — | — | 0.359 | 0.352 |
| (12) | \|TL/ff\| | — | — | — | 2.880 | 2.821 |
| (13) | f/ff_r | — | — | — | 0.098 | 0.093 |
| (14) | f/ff_f | — | — | — | 1.486 | 1.476 |
| (15) | f/ffs | — | — | — | — | — |
| (16) | \|ff1/ff2\| | 0.858 | 0.230 | 0.687 | — | — |
| (17) | \|βf1/βf2\| | 0.002 | 0.017 | 0.016 | — | — |
| (18) | {βf1 + | 0.008 | 0.068 | 0.193 | — | — |
| | (1/βf1)}⁻² | | | | | |
| (19) | {βf2 + | 0.039 | 0.242 | 0.244 | — | — |
| | (1/βf2)}⁻² | | | | | |
| (20) | f/f2r | 0.147 | 0.200 | 0.192 | — | — |
| (21) | f/f1f | −0.074 | −0.241 | 0.536 | — | — |
| (22) | fL1/fL2 | 0.772 | 0.677 | 0.522 | 0.624 | 0.639 |
| (23) | fL1/f | −2.975 | −2.550 | −2.233 | −3.064 | −3.069 |
| (24) | (RL1r | −0.834 | −1.014 | −1.228 | −0.681 | −0.648 |
| | RL1f)/ | | | | | |
| | (RL1r + | | | | | |
| | RL1f) | | | | | |
| (25) | (RL2r − | −0.561 | −0.562 | −0.436 | −0.288 | −0.304 |
| | RL2f)/ | | | | | |
| | (RL2r + | | | | | |
| | RL2f) | | | | | |
| (26) | fL3/fL4 | −2.204 | −3.024 | −4.447 | — | — |
| (27) | (RLer − | 1.029 | 1.030 | 1.031 | 1.178 | 1.262 |
| | RLef)/ | | | | | |
| | (RLer + | | | | | |
| | RLef) | | | | | |
| (28) | (1/RL1f − | 2.417 | 1.958 | 1.923 | 1.366 | 1.354 |
| | 1/RL1r)/ | | | | | |
| | (1/RyL1f − | | | | | |
| | 1/RyL1r) | | | | | |

TABLE 88

| Expression | | | | | | |
|---|---|---|---|---|---|---|
| number | | Example 6 | Example 7 | Example 8 | Example 9 | Example 10 |
| (29) | f/fFp | 0.918 | 0.833 | 0.928 | 0.457 | 0.441 |
| (30) | fR/fRp | 1.591 | 1.232 | 3.041 | 2.320 | 2.600 |
| (31) | νRp − νRn | 26.85 | 47.54 | 31.54 | 41.66 | 50.13 |
| (32) | NRp − NRn | 0.05019 | 0.29967 | 0.16583 | 0.24366 | 0.33775 |
| (33) | (1/RcLFef − | 1.626 | −1.031 | 4.566 | — | — |
| | 1/RcLFer)/ | | | | | |
| | (1/RyLFef − | | | | | |
| | 1/RyLFer) | | | | | |
| (34) | (RcLFef − | 0.804 | 0.227 | 0.388 | −0.809 | −0.703 |
| | RcLFer)/ | | | | | |
| | (RcLFef + | | | | | |
| | RcLFer) | | | | | |
| (35) | νLFe | 53.20 | 19.32 | 63.43 | 81.60 | 76.45 |
| (36) | D1/TL | 0.014 | 0.015 | 0.015 | 0.014 | 0.014 |
| (37) | DH1/D1 | 8.161 | 8.310 | 8.808 | 8.025 | 7.947 |
| (38) | νLe | 81.61 | 52.16 | 81.56 | 81.56 | 81.56 |
| (39) | EL1/(f × | 1.257 | 1.280 | 1.281 | 1.268 | 1.281 |
| | tan ωm) | | | | | |
| (40) | NLs − | 0.0403(L17) | — | 0.08442(L22) | 0.0958(L13) | — |
| | (2.015 − | 0.0958(L22) | | | | |
| | 0.0068 × | | | | | |
| | νLs) | | | | | |
| (41) | νLs | 53.20(L17) | — | 52.71(L22) | 52.32(L13) | — |
| | | 52.32(L22) | | | | |
| (42) | θgFLs | 0.54661(L17) | — | 0.54828(L22) | 0.54757(L13) | — |
| | | 0.54758(L22) | | | | |
| (43) | θgFLs − | −0.00581(L17) | — | −0.00497(L22) | −0.00633(L13) | — |
| | (0.6418 − | −0.00632(L22) | | | | |
| | 0.00168 × | | | | | |
| | νLs) | | | | | |

TABLE 89

| Expression | | | | | | |
|---|---|---|---|---|---|---|
| number | | Example 11 | Example 12 | Example 13 | Example 14 | Example 15 |
| (1) | Bf/(f × tan | 0.592 | 0.600 | 0.635 | 0.589 | 0.581 |
| | ωm) | | | | | |
| (2) | STI/TL | 0.496 | 0.504 | 0.490 | 0.499 | 0.496 |
| (3) | fR/fF | −0.258 | −0.222 | −0.297 | −0.299 | −0.351 |
| (4) | f/RL1f | 0.240 | 0.222 | 0.143 | 0.275 | 0.223 |
| (5) | f/RL1r | 0.731 | 0.775 | 0.821 | 0.774 | 0.782 |
| (6) | f/fF | −0.127 | −0.107 | −0.146 | −0.147 | −0.175 |
| (7) | \|β\| | 0.1 | 0.1 | 0.1 | 0.1 | 0.1 |
| (8) | TL/(f × tan | 4.551 | 4.551 | 4.551 | 4.551 | 4.551 |
| | ωm) | | | | | |
| (9) | FNo/tan ωm | 1.310 | 1.310 | 1.310 | 1.310 | 1.310 |
| (10) | νL1 | 40.74 | 47.25 | 45.25 | 40.74 | 47.25 |
| (11) | \|f/ff\| | 0.436 | 0.427 | 0.429 | 0.444 | 0.453 |
| (12) | \|TL/ff\| | 2.803 | 2.743 | 2.759 | 2.856 | 2.913 |
| (13) | f/ff_r | 0.155 | 0.148 | 0.166 | 0.146 | 0.145 |
| (14) | f/ff_f | −0.127 | −0.107 | −0.146 | −0.147 | −0.175 |
| (15) | f/ffs | — | — | — | — | — |
| (16) | \|ff1/ff2\| | — | — | — | — | — |
| (17) | \|βf1/βf2\| | — | — | — | — | — |
| (18) | {βf1 + | — | — | — | — | — |
| | (1/βf1)}⁻² | | | | | |
| (19) | {βf2 + | — | — | — | — | — |
| | (1/βf2)}⁻² | | | | | |
| (20) | f/f2r | — | — | — | — | — |
| (21) | f/f1f | — | — | — | — | — |
| (22) | fL1/fL2 | 0.519 | 0.428 | 0.150 | 0.554 | 0.413 |
| (23) | fL1/f | −2.564 | −2.371 | −1.874 | −2.522 | −2.335 |
| (24) | (RL1r − | −0.505 | −0.555 | −0.704 | −0.477 | −0.557 |
| | RL1f)/ | | | | | |
| | (RL1r + | | | | | |
| | RL1f) | | | | | |
| (25) | (RL2r − | −0.353 | −0.305 | −0.075 | −0.326 | −0.297 |
| | RL2f)/ | | | | | |
| | (RL2r + | | | | | |
| | RL2f) | | | | | |
| (26) | fL3/fL4 | −1.147 | −1.132 | −1.123 | −1.161 | −1.149 |
| (27) | (RLer − | 1.044 | 1.046 | 1.041 | 1.047 | 1.047 |
| | RLef)/ | | | | | |
| | (RLer + | | | | | |
| | RLef) | | | | | |
| (28) | (1/RL1f − | 1.826 | 1.779 | 2.031 | 1.511 | 1.630 |
| | 1/RL1r)/ | | | | | |
| | (1/RyL1f − | | | | | |
| | 1/RyL1r) | | | | | |

TABLE 90

| Expression | | | | | | |
|---|---|---|---|---|---|---|
| number | | Example 11 | Example 12 | Example 13 | Example 14 | Example 15 |
| (29) | f/fFp | 0.630 | 0.671 | 0.623 | 0.600 | 0.627 |
| (30) | fR/fRp | 1.212 | 1.262 | 1.200 | 1.351 | 1.294 |
| (31) | νRp − νRn | — | — | 64.59 | 55.14 | 55.28 |
| (32) | NRp − NRn | — | — | 0.44813 | 0.34254 | 0.37841 |
| (33) | (1/RcLFef | 2.234 | 3.133 | 3.059 | 1.981 | 1.921 |
| | 1/RcLFer)/ | | | | | |
| | (1/RyLFef − | | | | | |
| | 1/RyLFer) | | | | | |
| (34) | (RcLFef − | 1.992 | 1.081 | 1.280 | 1.950 | 2.275 |
| | RcLFer)/ | | | | | |
| | (RcLFef + | | | | | |
| | RcLFer) | | | | | |
| (35) | νLFe | 49.98 | 49.98 | 37.28 | 45.45 | 45.45 |
| (36) | D1/TL | 0.013 | 0.017 | 0.022 | 0.013 | 0.013 |
| (37) | DH1/D1 | 6.271 | 5.494 | 4.422 | 6.577 | 6.846 |
| (38) | νLe | 82.57 | 82.57 | 81.54 | 82.57 | 81.54 |
| (39) | EL1/(f × | 1.064 | 1.077 | 1.053 | 1.044 | 1.057 |
| | tan ωm) | | | | | |
| (40) | NLs − | 0.0969(L16) | 0.0969(L16) | — | — | — |
| | (2.015 − | | | | | |
| | 0.0068 × | | | | | |
| | νLs) | | | | | |
| (41) | νLs | 49.98(L16) | 49.98(L16) | — | — | — |
| (42) | θgFLs | 0.55475(L16) | 0.55475(L16) | — | — | — |
| (43) | θgFLs − | −0.00308(L16) | −0.00308(L16) | — | — | — |
| | (0.6418 − | | | | | |
| | 0.00168 × | | | | | |
| | νLs) | | | | | |

TABLE 91

| Expression | | | | | | |
|---|---|---|---|---|---|---|
| number | | Example 16 | Example 17 | Example 18 | Example 19 | Example 20 |
| (1) | Bf/(f × tan | 0.584 | 0.600 | 0.598 | 0.612 | 0.599 |
| | ωm) | | | | | |
| (2) | STI/TL | 0.498 | 0.535 | 0.533 | 0.532 | 0.538 |
| (3) | fR/fF | −0.317 | −0.223 | −0.305 | −0.267 | −0.167 |
| (4) | f/RL1f | 0.245 | 0.083 | 0.161 | 0.128 | 0.115 |
| (5) | f/RL1r | 0.786 | 0.634 | 0.634 | 0.644 | 0.635 |
| (6) | f/fF | −0.156 | −0.095 | −0.132 | −0.115 | −0.071 |
| (7) | \|β\| | 0.1 | 0.1 | 0.1 | 0.1 | 0.1 |
| (8) | TL/(f × tan | 4.551 | 4.995 | 4.995 | 4.995 | 4.995 |
| | ωm) | | | | | |
| (9) | FNo/tan ωm | 1.310 | 1.139 | 1.152 | 1.152 | 1.152 |
| (10) | νL1 | 45.25 | 54.89 | 40.74 | 47.25 | 45.25 |
| (11) | \|f/ff\| | 0.445 | 0.357 | 0.374 | 0.367 | 0.354 |
| (12) | \|TL/ff\| | 2.859 | 2.868 | 2.997 | 2.942 | 2.839 |
| (13) | f/ff_r | 0.145 | 0.175 | 0.161 | 0.163 | 0.173 |
| (14) | f/ff_f | −0.156 | −0.095 | −0.132 | −0.115 | −0.071 |
| (15) | f/ffs | — | — | — | — | — |
| (16) | \|ff1/ff2\| | — | — | — | — | — |
| (17) | \|βf1/βf2\| | — | — | — | — | — |
| (18) | {βf1 + | — | — | — | — | — |
| | (1/βf1)}−2 | | | | | |
| (19) | {βf2 + | — | — | — | — | — |
| | (1/βf2)}−2 | | | | | |
| (20) | f/f2r | — | — | — | — | — |
| (21) | f/f1f | — | — | — | — | — |
| (22) | fL1/fL2 | 0.450 | 0.588 | 0.622 | 0.580 | 0.512 |
| (23) | fL1/f | −2.357 | −2.700 | −2.710 | −2.564 | −2.464 |
| (24) | (RL1r − RL1f)/ | −0.525 | −0.768 | −0.595 | −0.668 | −0.694 |
| | (RL1r + | | | | | |
| | RL1f) | | | | | |
| (25) | (RL2r − RL2f)/ | −0.324 | −0.391 | −0.440 | −0.395 | −0.433 |
| | (RL2r + | | | | | |
| | RL2f) | | | | | |
| (26) | fL3/fL4 | −1.171 | −1.199 | −1.183 | −1.365 | −1.401 |
| (27) | (RLer − RLef)/ | 1.047 | 1.428 | 1.442 | 1.159 | 1.527 |
| | (RLer + | | | | | |
| | RLef) | | | | | |
| (28) | (1/RL1f − | 1.514 | 2.072 | 1.997 | 1.877 | 2.000 |
| | 1/RL1r)/ | | | | | |
| | (1/RyL1f − | | | | | |
| | 1/RyL1r) | | | | | |

TABLE 92

| Expression | | | | | | |
|---|---|---|---|---|---|---|
| number | | Example 16 | Example 17 | Example 18 | Example 19 | Example 20 |
| (29) | f/fFp | 0.627 | 0.647 | 0.612 | 0.579 | 0.546 |
| (30) | fR/fRp | 1.326 | 1.275 | 1.304 | 1.262 | 1.318 |
| (31) | νRp − νRn | 54.01 | 50.13 | 56.09 | 50.12 | 51.59 |
| (32) | NRp − NRn | 0.35428 | 0.33775 | 0.36445 | 0.33316 | 0.29822 |
| (33) | (1/RcLFef − | 2.016 | 2.104 | 1.781 | 1.744 | 2.212 |
| | 1/RcLFer)/ | | | | | |
| | (1/RyLFef − | | | | | |
| | 1/RyLFer) | | | | | |
| (34) | (RcLFef − | 1.793 | −7.600 | −186.909 | −14.774 | −5.651 |
| | RcLFer)/ | | | | | |
| | (RcLFef + | | | | | |
| | RcLFer) | | | | | |
| (35) | νLFe | 45.45 | 37.29 | 46.75 | 41.62 | 41.85 |
| (36) | D1/TL | 0.014 | 0.028 | 0.042 | 0.041 | 0.036 |
| (37) | DH1/D1 | 6.634 | 3.997 | 2.688 | 2.853 | 3.092 |
| (38) | νLe | 82.57 | 52.16 | 81.54 | 81.54 | 82.57 |
| (39) | EL1/(f × tan | 1.052 | 1.260 | 1.260 | 1.259 | 1.260 |
| | ωm) | | | | | |
| (40) | NLs − | — | — | — | — | — |
| | (2.015 − | | | | | |
| | 0.0068 × | | | | | |
| | νLs) | | | | | |
| (41) | νLs | — | — | — | — | — |
| (42) | θgFLs | — | — | — | — | — |
| (43) | θgFLs − | — | — | — | — | — |
| | (0.6418 − | | | | | |
| | 0.00168 × | | | | | |
| | νLs) | | | | | |

TABLE 93

| Expression | | |
|---|---|---|
| number | | Example 21 |
| (1) | Bf/(f × tan ωm) | 0.554 |
| (2) | STI/TL | 0.568 |
| (3) | fR/fF | 1.551 |
| (4) | f/RL1f | 0.318 |
| (5) | f/RL1r | 0.784 |
| (6) | f/fF | 0.411 |
| (7) | | 0.1 |
| (8) | TL/(f × tan ωm) | 5.215 |
| (9) | FNo/tan ωm | 1.288 |
| (10) | νL1 | 52.68 |
| (11) | \|f/ff\| | — |
| (12) | \|TL/ff\| | — |
| (13) | f/ff_r | — |
| (14) | f/ff_f | — |
| (15) | f/ffs | 0.284 |
| (16) | \|ff1/ff2\| | — |
| (17) | \|βf1/βf2\| | — |
| (18) | {βf1 + (1/βf1)}⁻² | — |
| (19) | {βf2 + (1/βf2)}⁻² | — |
| (20) | f/f2r | — |
| (21) | f/flf | — |
| (22) | fL1/fL2 | 1.879 |
| (23) | fL1/f | −3.050 |
| (24) | (RL1r − RL1f)/ | −0.423 |
| | (RL1r + RL1f) | |
| (25) | (RL2r − RL2f) | −1.070 |
| | (RL2r + RL2f)/ | |
| (26) | fL3/fL4 | −1.748 |
| (27) | (RLer − RLef)/ | −0.391 |
| | (RLer + RLef) | |
| (28) | (1/RL1f − 1/RL1r)/ | 1.596 |
| | (1/RyL1f − 1/RyL1r) | |

TABLE 94

| Expression | | |
|---|---|---|
| number | | Example 21 |
| (29) | f/fFp | 0.406 |
| (30) | fR/fRp | 2.176 |
| (31) | νRp − νRn | 34.62 |
| (32) | NRp − NRn | 0.34111 |
| (33) | (1/RcLFef − | — |
| | 1/RcLFer)/ | |
| | (1/RyLFef − | |
| | 1/RyLFer) | |
| (34) | (RcLFef − | −0.703 |
| | RcLFer)/ | |
| | (RcLFef + | |
| | RcLFer) | |
| (35) | νLFe | 75.52 |
| (36) | D1/TL | 0.030 |
| (37) | DH1/D1 | 3.243 |
| (38) | νLe | 50.30 |
| (39) | EL1/(f × tan ωm) | 1.119 |
| (40) | NLs − (2.015 − | 0.0852(L11) |
| | 0.0068 × νLS) | 0.1024(L26) |
| (41) | νLs | 52.68(L11) |
| | | 50.30(L26) |
| (42) | θgFLs | 0.54765(L11) |
| | | 0.55004(L26) |
| (43) | θgFLs − (0.6418 − | −0.00565(L11) |
| | 0.00168 × νLs) | |
| | | 0.00726(L26) |

The imaging lenses of Examples 1 to 21 have a full angle of view of more than 100 degrees and have a wide angle of view. The imaging lenses of Examples 1 to 21 have a state in which the open F-number is less than 2 in a state in which the infinite distance object is in focus, and realize an optical system having a small F-number. Further, although the imaging lenses of Examples 1 to 21 each are configured to have a small size, various aberrations are satisfactorily corrected in both a state in which the infinite distance object is in focus and a state in which the closest object is in focus, and thus high optical performance is maintained.

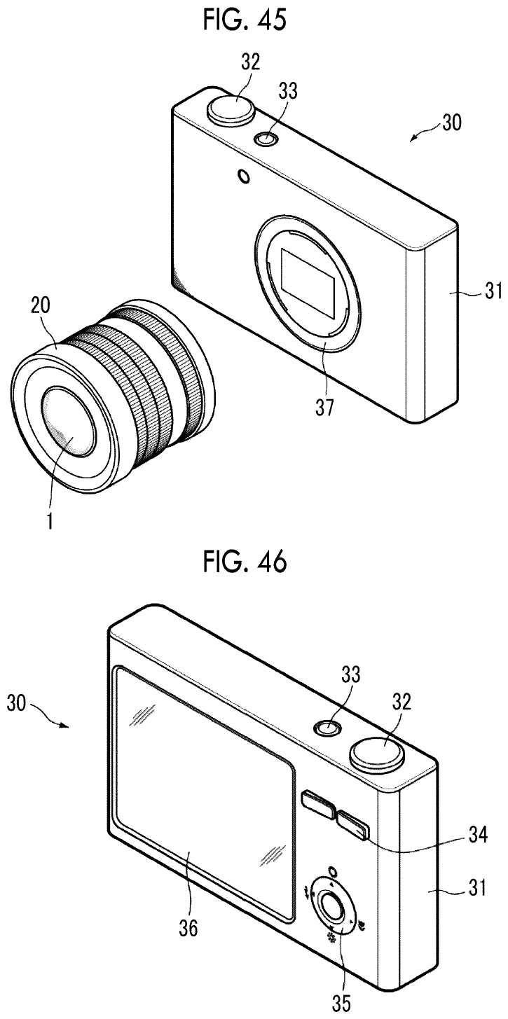

Hereinafter, an imaging apparatus according to the embodiment of the present disclosure will be described. FIGS. 45 and 46 are external views of a camera 30 that is the imaging apparatus according to the embodiment of the present disclosure. FIG. 45 is a perspective view of the camera 30, which is viewed from a front side, and FIG. 46 is a perspective view of the camera 30, which is viewed from a rear side. The camera 30 is a so-called mirrorless type digital camera in which an interchangeable lens 20 can be attachably and detachably mounted. The interchangeable lens 20 includes an imaging lens 1 according to the embodiment of the present disclosure accommodated in a lens barrel.

The camera 30 comprises a camera body 31, in which a shutter button 32 and a power button 33 are provided on an upper surface of the camera body 31. A rear surface of the camera body 31 is provided with an operation unit 34, an operation unit 35, and a display unit 36. The display unit 36 can display the captured image and an image within an angle of view before capturing.

An imaging aperture on which light from an imaging target is incident is provided in a center portion of a front surface of the camera body 31, a mount 37 is provided at a position corresponding to the imaging aperture, and the interchangeable lens 20 is mounted on the camera body 31 through the mount 37.

An imaging element, such as a charge coupled device (CCD) or a complementary metal oxide semiconductor (CMOS), that outputs an imaging signal corresponding to a subject image formed by the interchangeable lens 20, a signal processing circuit that processes the imaging signal output from the imaging element to generate an image, a recording medium for recording the generated image, and the like are provided in the camera body 31. In the camera 30, a still image or a moving image can be captured by pressing the shutter button 32, and the image data obtained by this capturing is recorded on the recording medium.

While the technology of the present disclosure has been described above using the embodiment and the examples, the technology of the present disclosure is not limited to the embodiment and the examples, and can be subjected to various modifications. For example, the curvature radius, the surface spacing, the refractive index, the Abbe number, the aspherical coefficient, and the like of each lens are not limited to the values shown in the examples, and different values may be used.

In addition, the imaging apparatus according to the embodiment of the present disclosure is not limited to the above-described example, and may be modified into various forms such as a camera other than the mirrorless type, a film camera, and a video camera.

The following supplementary notes are further disclosed regarding the embodiment and the examples described above.

### [Supplementary Note 1]

An imaging lens consisting of, in order from an object side to an image side, a front group, a stop, and a rear group, in which the front group includes, in successive order from a side closest to the object side to the image side, a first lens that is a negative lens having a concave surface facing the image side and a second lens that is a negative lens having a concave surface facing the image side, two or less focus lens groups are disposed on the image side with respect to the second lens, during focusing, the two or less focus lens groups move along an optical axis, and lenses other than the two or less focus lens groups are fixed with respect to an image plane, and in a case in which a back focus of an entire system at an air conversion distance in a state in which an infinite distance object is in focus is denoted by Bf, a focal length of the entire system in a state in which the infinite distance object is in focus is denoted by f, and a maximum half angle of view in a state in which the infinite distance object is in focus is denoted by ωm, Conditional Expression (1) is satisfied, which is represented by 0.3<Bf/(f×tan ωm)<1.5 (1).

### [Supplementary Note 2]

The imaging lens according to supplementary note 1, in which, in a case in which a distance on the optical axis from a lens surface of the imaging lens closest to the object side to the stop in a state in which the infinite distance object is in focus is denoted by STI, and a sum of a distance on the optical axis from the lens surface of the imaging lens closest to the object side to a lens surface of the imaging lens closest to the image side and the back focus of the entire system at the air conversion distance, in a state in which the infinite distance object is in focus, is denoted by TL, Conditional Expression (2) is satisfied, which is represented by 0.3<STI/TL<0.75 (2).

### [Supplementary Note 3]

The imaging lens according to supplementary note 1 or 2, in which, in a case in which a focal length of the front group in a state in which the infinite distance object is in focus is denoted by fF, and a focal length of the rear group in a state in which the infinite distance object is in focus is denoted by fR, Conditional Expression (3) is satisfied, which is represented by −2<fR/fF<4 (3).

### [Supplementary Note 4]

The imaging lens according to any one of supplementary notes 1 to 3, in which, in a case in which a paraxial curvature radius of an object side surface of the first lens is denoted by RL1f, Conditional Expression (4) is satisfied, which is represented by −0.3<f/RL1f<8 (4).

### [Supplementary Note 5]

The imaging lens according to any one of supplementary notes 1 to 4, in which, in a case in which a paraxial curvature radius of an image side surface of the first lens is denoted by RL1r, Conditional Expression (5) is satisfied, which is represented by 0<f/RL1r<4 (5).

### [Supplementary Note 6]

The imaging lens according to any one of supplementary notes 1 to 5, in which, in a case in which a focal length of the front group in a state in which the infinite distance object is in focus is denoted by fF, Conditional Expression (6) is satisfied, which is represented by −1<f/fF<2 (6).

### [Supplementary Note 7]

The imaging lens according to any one of supplementary notes 1 to 6, in which, in a case in which a maximum imaging magnification of the imaging lens is denoted by β, Conditional Expression (7) is satisfied, which is represented by 0.06<|β|<0.5 (7).

### [Supplementary Note 8]

The imaging lens according to any one of supplementary notes 1 to 7, in which, in a case in which a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (8) is satisfied, which is represented by 3<TL/(f×tan ωm)<7 (8).

### [Supplementary Note 9]

The imaging lens according to any one of supplementary notes 1 to 8, in which, in a case in which an open F-number in a state in which the infinite distance object is in focus is denoted by FNo, Conditional Expression (9) is satisfied, which is represented by 0.55<FNo/tan ωm<2 (9).

### [Supplementary Note 10]

The imaging lens according to any one of supplementary notes 1 to 9, in which, in a case in which an Abbe number of the first lens based on a d line is denoted by νL1, Conditional Expression (10) is satisfied, which is represented by 20<νL1<95 (10).

### [Supplementary Note 11]

The imaging lens according to any one of supplementary notes 1 to 10, in which the imaging lens includes only one focus lens group, the focus lens group is disposed in the rear group, and in a case in which a focal length of the focus lens group is denoted by ff, Conditional Expression (11) is satisfied, which is represented by 0.05<|f/ff|<0.9 (11).

### [Supplementary Note 12]

The imaging lens according to any one of supplementary notes 1 to 11, in which the imaging lens includes only one focus lens group, the focus lens group is disposed in the rear group, and in a case in which a focal length of the focus lens group is denoted by ff, and a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (12) is satisfied, which is represented by 0.1<|TL/ff|<6 (12).

### [Supplementary Note 13]

The imaging lens according to supplementary note 11 or 12, in which, in a case in which a combined focal length of all lenses on the image side with respect to the focus lens group is denoted by ff_r, Conditional Expression (13) is satisfied, which is represented by 0.05<f/ff_r<1.5 (13).

### [Supplementary Note 14]

The imaging lens according to any one of supplementary notes 11 to 13, in which, in a case in which a combined focal length of all lenses on the object side with respect to the focus lens group is denoted by ff_f, Conditional Expression (14) is satisfied, which is represented by −3<f/ff_f<0 (14).

### [Supplementary Note 15]

The imaging lens according to any one of supplementary notes 1 to 10, in which the imaging lens includes only one focus lens group, and the focus lens group is disposed in the front group.

### [Supplementary Note 16]

The imaging lens according to any one of supplementary notes 1 to 10, in which the focus lens group includes the stop, and the stop moves along the optical axis during focusing.

### [Supplementary Note 17]

The imaging lens according to supplementary note 16, in which the imaging lens includes only one focus lens group, and in a case in which a focal length of the focus lens group is denoted by ffs, Conditional Expression (15) is satisfied, which is represented by 0.1<f/ffs<0.5 (15).

### [Supplementary Note 18]

The imaging lens according to any one of supplementary notes 1 to 10, in which the imaging lens includes two focus lens groups, and in a case in which, among the two focus lens groups, the focus lens group on the object side is defined as a first focus lens group, and the focus lens group on the image side is defined as a second focus lens group, the first focus lens group and the second focus lens group move by different movement amounts during focusing.

### [Supplementary Note 19]

The imaging lens according to supplementary note 18, in which the first focus lens group is disposed in the front group, and the second focus lens group is disposed in the rear group.

### [Supplementary Note 20]

The imaging lens according to supplementary note 18 or 19, in which, in a case in which a focal length of the first focus lens group is denoted by ff1, and a focal length of the second focus lens group is denoted by ff2, Conditional Expression (16) is satisfied, which is represented by 0.2<|ff1/ff2|<5 (16).

### [Supplementary Note 21]

The imaging lens according to any one of supplementary notes 18 to 20, in which, in a case in which a lateral magnification of the first focus lens group in a state in which the infinite distance object is in focus is denoted by βf1, and a lateral magnification of the second focus lens group in a state in which the infinite distance object is in focus is denoted by βf2, Conditional Expression (17) is satisfied, which is represented by 0<|βf1/βf2|<0.6 (17).

### [Supplementary Note 22]

The imaging lens according to any one of supplementary notes 18 to 21, in which, in a case in which a lateral magnification of the first focus lens group in a state in which the infinite distance object is in focus is denoted by βf1, Conditional Expression (18) is satisfied, which is represented by 0<{βf1+(1/βf1)}⁻²<0.25 (18).

### [Supplementary Note 23]

The imaging lens according to any one of supplementary notes 18 to 22, in which, in a case in which a lateral magnification of the second focus lens group in a state in which the infinite distance object is in focus is denoted by βf2, Conditional Expression (19) is satisfied, which is represented by 0<{βf2+(1/βf2)}⁻²<0.25 (19).

### [Supplementary Note 24]

The imaging lens according to any one of supplementary notes 18 to 23, in which, in a case in which a combined focal length of all lenses on the image side with respect to the second focus lens group is denoted by f2r, Conditional Expression (20) is satisfied, which is represented by 0.1<f/f2r<2 (20).

### [Supplementary Note 25]

The imaging lens according to any one of supplementary notes 18 to 24, in which, in a case in which a combined focal length of all lenses on the object side with respect to the first focus lens group is denoted by f1f, Conditional Expression (21) is satisfied, which is represented by −3<f/f1f<2 (21).

### [Supplementary Note 26]

The imaging lens according to any one of supplementary notes 1 to 25, in which, in a case in which a focal length of the first lens is denoted by fL1, and a focal length of the second lens is denoted by fL2, Conditional Expression (22) is satisfied, which is represented by 0<fL1/fL2<5.5 (22).

### [Supplementary Note 27]

The imaging lens according to any one of supplementary notes 1 to 26, in which, in a case in which a focal length of the first lens is denoted by fL1, Conditional Expression (23) is satisfied, which is represented by −8<fL1/f<−0.5 (23).

### [Supplementary Note 28]

The imaging lens according to any one of supplementary notes 1 to 27, in which, in a case in which a paraxial curvature radius of an object side surface of the first lens is denoted by RL1f, and a paraxial curvature radius of an image side surface of the first lens is denoted by RL1r, Conditional Expression (24) is satisfied, which is represented by −2.5<(RL1r−RL1f)/(RL1r+RL1f)<−0.1 (24).

### [Supplementary Note 29]

The imaging lens according to any one of supplementary notes 1 to 28, in which, in a case in which a paraxial curvature radius of an object side surface of the second lens is denoted by RL2f, and a paraxial curvature radius of an image side surface of the second lens is denoted by RL2r, Conditional Expression (25) is satisfied, which is represented by −1.5<(RL2r−RL2f)/(RL2r+RL2f)<−0.05 (25).

### [Supplementary Note 30]

The imaging lens according to any one of supplementary notes 1 to 29, in which a third lens that is a negative lens is disposed adjacent to the image side of the second lens, a fourth lens that is a positive lens is disposed adjacent to the image side of the third lens, and in a case in which a focal length of the third lens is denoted by fL3, and a focal length of the fourth lens is denoted by fL4, Conditional Expression (26) is satisfied, which is represented by −8<fL3/fL4<0 (26).

### [Supplementary Note 31]

The imaging lens according to any one of supplementary notes 1 to 30, in which, in a case in which a paraxial curvature radius of an object side surface of a lens of the imaging lens closest to the image side is denoted by RLef, and a paraxial curvature radius of an image side surface of a lens of the imaging lens closest to the image side is denoted by RLer, Conditional Expression (27) is satisfied, which is represented by 0.4<(RLer−RLef)/(RLer+RLef)<5.5 (27).

### [Supplementary Note 32]

The imaging lens according to any one of supplementary notes 1 to 31, in which at least one of an object side surface or an image side surface of the first lens is an aspherical surface, and in a case in which a paraxial curvature radius of the object side surface of the first lens is denoted by RL1f, a paraxial curvature radius of the image side surface of the first lens is denoted by RL1r, a curvature radius of the object side surface of the first lens at a position of a maximum effective diameter is denoted by RyL1f, and a curvature radius of the image side surface of the first lens at the position of the maximum effective diameter is denoted by RyL1r, Conditional Expression (28) is satisfied, which is represented by 0.5<(1/RL1f−1/RL1r)/(1/RyL1f−1/RyL1r)<7 (28).

### [Supplementary Note 33]

The imaging lens according to any one of supplementary notes 1 to 32, in which the front group includes at least one positive lens, and in a case in which a focal length of a positive lens having a strongest refractive power among the positive lenses included in the front group is denoted by fFp, Conditional Expression (29) is satisfied, which is represented by 0.1<f/fFp<3 (29).

### [Supplementary Note 34]

The imaging lens according to any one of supplementary notes 1 to 33, in which the rear group includes at least one positive lens, and in a case in which a focal length of a positive lens having a strongest refractive power among the positive lenses included in the rear group is denoted by fRp, and a focal length of the rear group in a state in which the infinite distance object is in focus is denoted by fR, Conditional Expression (30) is satisfied, which is represented by 0.3<fR/fRp<5 (30).

### [Supplementary Note 35]

The imaging lens according to any one of supplementary notes 1 to 34, in which the rear group includes a cemented lens in which a positive lens having a convex surface facing the object side and a negative lens are cemented in order from the object side, and in a case in which an Abbe number of the positive lens of the cemented lens based on a d line is denoted by νRp, and an Abbe number of the negative lens of the cemented lens based on the d line is denoted by νRn, Conditional Expression (31) is satisfied, which is represented by 10<νRp−νRn<75 (31).

### [Supplementary Note 36]

The imaging lens according to supplementary note 35, in which, in a case in which a refractive index of the positive lens of the cemented lens at the d line is denoted by NRp, and a refractive index of the negative lens of the cemented lens at the d line is denoted by NRn, Conditional Expression (32) is satisfied, which is represented by 0.2<NRp−NRn<0.9 (32).

### [Supplementary Note 37]

The imaging lens according to any one of supplementary notes 1 to 36, in which an LFe lens that is a positive lens is disposed on a side of the front group closest to the image side.

### [Supplementary Note 38]

The imaging lens according to supplementary note 37, in which the LFe lens is a biconvex lens.

### [Supplementary Note 39]

The imaging lens according to supplementary note 37 or 38, in which at least one of an object side surface or an image side surface of the LFe lens is an aspherical surface, and in a case in which a paraxial curvature radius of the object side surface of the LFe lens is denoted by RcLFef, a paraxial curvature radius of the image side surface of the LFe lens is denoted by RcLFer, a curvature radius of the object side surface of the LFe lens at a position of a maximum effective diameter is denoted by RyLFef, and a curvature radius of the image side surface of the LFe lens at the position of the maximum effective diameter is denoted by RyLFer, Conditional Expression (33) is satisfied, which is represented by 0.5<(1/RcLFef−1/RcLFer)/(1/RyLFef−1/RyLFer)<7 (33).

### [Supplementary Note 40]

The imaging lens according to any one of supplementary notes 37 to 39, in which, in a case in which a paraxial curvature radius of an object side surface of the LFe lens is denoted by RcLFef, and a paraxial curvature radius of an image side surface of the LFe lens is denoted by RcLFer, Conditional Expression (34) is satisfied, which is represented by −4<(RcLFef−RcLFer)/(RcLFef+RcLFer)<10 (34).

### [Supplementary Note 41]

The imaging lens according to any one of supplementary notes 37 to 40, in which, in a case in which an Abbe number of the LFe lens based on a d line is denoted by νLFe, Conditional Expression (35) is satisfied, which is represented by 15<νLFe<90 (35).

### [Supplementary Note 42]

The imaging lens according to any one of supplementary notes 1 to 41, in which, in a case in which a central thickness of the first lens is denoted by D1, and a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (36) is satisfied, which is represented by 0.007<D1/TL<0.1 (36).

### [Supplementary Note 43]

The imaging lens according to any one of supplementary notes 1 to 42, in which, in a case in which a thickness of the first lens in an optical axis direction at a height of a maximum effective diameter of an image side surface of the first lens is denoted by DH1, and a central thickness of the first lens is denoted by D1, Conditional Expression (37) is satisfied, which is represented by 2<DH1/D1<10 (37).

### [Supplementary Note 44]

The imaging lens according to any one of supplementary notes 1 to 43, in which, in a case in which an Abbe number of a lens of the imaging lens closest to the image side based on a d line is denoted by νLe, Conditional Expression (38) is satisfied, which is represented by 30<νLe<95 (38).

### [Supplementary Note 45]

The imaging lens according to any one of supplementary notes 1 to 44, in which, in a case in which an effective radius of an object side surface of the first lens is denoted by EL1, Conditional Expression (39) is satisfied, which is represented by 0.7<EL1/(f×tan ωm)<2 (39).

### [Supplementary Note 46]

The imaging lens according to any one of supplementary notes 1 to 45, further comprising: an Ls lens on the image side with respect to the second lens, in which, in a case in which a refractive index of the Ls lens at a d line is denoted by NLs, an Abbe number of the Ls lens based on the d line is denoted by νLs, and a partial dispersion ratio of the Ls lens between a g line and an F line is denoted by θgFLs, Conditional Expressions (40), (41), (42), and (43) are satisfied, which are represented by 0.005<NLs−(2.015−0.0068×νLs)<0.15 (40), 49.8<νLs<65 (41), 0.543<θgFLs<0.58 (42), and −0.011<θgFLs−(0.6418−0.00168×νLs)<0.035 (43).

### [Supplementary Note 47]

The imaging lens according to any one of supplementary notes 1 to 46, in which Conditional Expression (1-1) is satisfied, which is represented by 0.43<Bf/(f×tan ωm)<1.1 (1-1).

### [Supplementary Note 48]

The imaging lens according to any one of supplementary notes 1 to 47, in which, in a case in which a sum of a distance on the optical axis from a lens surface of the imaging lens closest to the object side to a lens surface of the imaging lens closest to the image side and the back focus of the entire system at the air conversion distance, in a state in which the infinite distance object is in focus, is denoted by TL, Conditional Expression (8-1) is satisfied, which is represented by 3.2<TL/(f×tan ωm)<6.5 (8-1).

### [Supplementary Note 49]

The imaging lens according to supplementary note 48, in which Conditional Expression (8-2) is satisfied, which is represented by 3.4<TL/(f×tan ωm)<5.9 (8-2).

### [Supplementary Note 50]

The imaging lens according to supplementary note 48, in which Conditional Expression (8-3) is satisfied, which is represented by 3.5<TL/(f×tan ωm)<5.65 (8-3).

### [Supplementary Note 51]

The imaging lens according to any one of supplementary notes 1 to 50, in which, in a case in which an open F-number in a state in which the infinite distance object is in focus is denoted by FNo, Conditional Expression (9-1) is satisfied, which is represented by 0.64<FNo/tan ωm<1.62 (9-1).

### [Supplementary Note 52]

The imaging lens according to supplementary note 51, in which Conditional Expression (9-2) is satisfied, which is represented by 0.66<FNo/tan ωm<1.55 (9-2).

### [Supplementary Note 53]

The imaging lens according to supplementary note51, in which Conditional Expression (9-3) is satisfied, which is represented by 0.7<FNo/tan ωm<1.35 (9-3).

### [Supplementary Note 54]

The imaging lens according to any one of supplementary notes 1 to 53, in which, in a case in which an Abbe number of the first lens based on a d line is denoted by νL1, Conditional Expression (10-1) is satisfied, which is represented by 28<νL1<59 (10-1).

### [Supplementary Note 55]

The imaging lens according to supplementary note 54, in which Conditional Expression (10-2) is satisfied, which is represented by 32<νL1<48 (10-2).

### [Supplementary Note 56]

An imaging apparatus comprising: the imaging lens according to any one of supplementary notes 1 to 55.

All of the documents, the patent applications, and the technical standards described in the present specification are incorporated in the present specification by reference to the same extent as in a case in which each of the documents, the patent applications, and the technical standards are specifically and individually described to be incorporated by reference.

What is claimed is:

1. An imaging lens consisting of, in order from an object side to an image side, a front group, a stop, and a rear group,
wherein the front group includes, in successive order from a side closest to the object side to the image side, a first lens that is a negative lens having a concave surface facing the image side and a second lens that is a negative lens having a concave surface facing the image side,
two or less focus lens groups are disposed on the image side with respect to the second lens,
during focusing, the two or less focus lens groups move along an optical axis, and lenses other than the two or less focus lens groups are fixed with respect to an image plane, and
in a case in which
a back focus of the imaging lens at an air conversion distance in a state in which an infinite distance object is in focus is denoted by Bf,
a focal length of the imaging lens in a state in which the infinite distance object is in focus is denoted by f, and
a maximum half angle of view in a state in which the infinite distance object is in focus is denoted by ωm,
Conditional Expression (1) is satisfied, which is represented by
$$0.3 < Bf / ( f \times tan ω m ) < 1.5 . \qquad ( 1 )$$

2. The imaging lens according to claim 1,
wherein, in a case in which
a distance on the optical axis from a lens surface of the imaging lens closest to the object side to the stop in a state in which the infinite distance object is in focus is denoted by STI, and
a sum of a distance on the optical axis from the lens surface of the imaging lens closest to the object side to a lens surface of the imaging lens closest to the image side and the back focus of the imaging lens at the air conversion distance, in a state in which the infinite distance object is in focus, is denoted by TL,
Conditional Expression (2) is satisfied, which is represented by
$$0.3 < STI / TL < 0.75 . \qquad ( 2 )$$

3. The imaging lens according to claim 1,
wherein, in a case in which
a focal length of the front group in a state in which the infinite distance object is in focus is denoted by fF, and
a focal length of the rear group in a state in which the infinite distance object is in focus is denoted by fR,
Conditional Expression (3) is satisfied, which is represented by
$$- 2 < fR / fF < 4. \qquad ( 3 )$$

4. The imaging lens according to claim 1,
wherein, in a case in which a paraxial curvature radius of an object side surface of the first lens is denoted by RL1f,
Conditional Expression (4) is satisfied, which is represented by
$$- 0.3 < f / RL 1 f < 8. \qquad ( 4 )$$

5. The imaging lens according to claim 1,
wherein, in a case in which a paraxial curvature radius of an image side surface of the first lens is denoted by RL1r,
Conditional Expression (5) is satisfied, which is represented by
$$0 < f / RL 1 r < 4. \qquad ( 5 )$$

6. The imaging lens according to claim 1,
wherein, in a case in which a focal length of the front group in a state in which the infinite distance object is in focus is denoted by IF,
Conditional Expression (6) is satisfied, which is represented by
$$- 1 < f / fF < 2. \qquad ( 6 )$$

7. The imaging lens according to claim 1,
wherein, in a case in which a maximum imaging magnification of the imaging lens is denoted by β,
Conditional Expression (7) is satisfied, which is represented by
$$0.06 < \vert β \vert < 0.5 . \qquad ( 7 )$$

8. The imaging lens according to claim 1,
wherein, in a case in which a sum of a distance on the optical axis from a lens surface of the imaging lens closest to the object side to a lens surface of the imaging lens closest to the image side and the back focus of the imaging lens at the air conversion distance, in a state in which the infinite distance object is in focus, is denoted by TL,
Conditional Expression (8) is satisfied, which is represented by
$$3 < TL / ( f \times tan ω m ) < 7. \qquad ( 8 )$$

9. The imaging lens according to claim 1,
wherein, in a case in which an open F-number in a state in which the infinite distance object is in focus is denoted by FNo,
Conditional Expression (9) is satisfied, which is represented by
$$55 < FNo / tan ω m < 2. \qquad ( 9 )$$

10. The imaging lens according to claim 1,
wherein, in a case in which an Abbe number of the first lens based on a d line is denoted by νL1,
Conditional Expression (10) is satisfied, which is represented by
$$20 < vL 1 < 95. \qquad ( 10 )$$

11. The imaging lens according to claim 1,
wherein, in a case in which a sum of a distance on the optical axis from a lens surface of the imaging lens closest to the object side to a lens surface of the imaging lens closest to the image side and the back focus of the imaging lens at the air conversion distance, in a state in which the infinite distance object is in focus, is denoted by TL,
Conditional Expression (8-3) is satisfied, which is represented by
$$3.5 < TL / ( f \times tan ω m ) < 5.65 . \qquad ( 8 - 3 )$$

12. The imaging lens according to claim 11,
wherein, in a case in which an open F-number in a state in which the infinite distance object is in focus is denoted by FNo,
Conditional Expression (9-3) is satisfied, which is represented by
$$0.7 < FNo / tan ω m < 1 \text{.35} . \qquad ( 9 - 3 )$$

13. The imaging lens according to claim 12,
wherein, in a case in which an Abbe number of the first lens based on a d line is denoted by νL1,
Conditional Expression (10-1) is satisfied, which is represented by
$$28 < vL 1 < 59. \qquad ( 10 - 1 )$$

14. The imaging lens according to claim 1,
wherein the imaging lens includes only one focus lens group,
the focus lens group is disposed in the rear group, and
in a case in which a focal length of the focus lens group is denoted by ff,
Conditional Expression (11) is satisfied, which is represented by
$$0.05 < \vert f / ff \vert < 0.9 . \qquad ( 11 )$$

15. The imaging lens according to claim 1,
wherein the imaging lens includes only one focus lens group,
the focus lens group is disposed in the rear group, and
in a case in which
a focal length of the focus lens group is denoted by ff, and
a sum of a distance on the optical axis from a lens surface of the imaging lens closest to the object side to a lens surface of the imaging lens closest to the image side and the back focus of the imaging lens at the air conversion distance, in a state in which the infinite distance object is in focus, is denoted by TL,
Conditional Expression (12) is satisfied, which is represented by
$$0.1 < \vert TL / ff \vert < 6. \qquad ( 12 )$$

16. The imaging lens according to claim 14,
wherein, in a case in which a combined focal length of all lenses on the image side with respect to the focus lens group is denoted by ff_r,
Conditional Expression (13) is satisfied, which is represented by
$$0.05 < f / ff\_r < 1.5 . \qquad ( 13 )$$

17. The imaging lens according to claim 14,
wherein, in a case in which a combined focal length of all lenses on the object side with respect to the focus lens group is denoted by ff_f,
Conditional Expression (14) is satisfied, which is represented by
$$- 3 < f / ff\_f < 0. \qquad ( 14 )$$

18. The imaging lens according to claim 14,
wherein, in a case in which a sum of a distance on the optical axis from a lens surface of the imaging lens closest to the object side to a lens surface of the imaging lens closest to the image side and the back focus of the imaging lens at the air conversion distance, in a state in which the infinite distance object is in focus, is denoted by TL,
Conditional Expression (8-1) is satisfied, which is represented by
$$3.2 < TL / ( f \times tan ω m ) < 6.5 . \qquad ( 8 - 1 )$$

19. The imaging lens according to claim 18,
wherein, in a case in which an open F-number in a state in which the infinite distance object is in focus is denoted by FNo,
Conditional Expression (9-3) is satisfied, which is represented by
$$0.7 < FNo / tan ω m < 1 \text{.35} . \qquad ( 9 - 3 )$$

20. The imaging lens according to claim 19,
wherein, in a case in which an Abbe number of the first lens based on a d line is denoted by νL1,
Conditional Expression (10-1) is satisfied, which is represented by
$$28 < vL 1 < 59. \qquad ( 10 - 1 )$$

21. The imaging lens according to claim 1,
wherein the imaging lens includes only one focus lens group, and
the focus lens group is disposed in the front group.

22. The imaging lens according to claim 21,
wherein, in a case in which a sum of a distance on the optical axis from a lens surface of the imaging lens closest to the object side to a lens surface of the imaging lens closest to the image side and the back focus of the imaging lens at the air conversion distance, in a state in which the infinite distance object is in focus, is denoted by TL,
Conditional Expression (8-2) is satisfied, which is represented by
$$3.4 < TL / ( f \times tan ω m ) < 5.9 . \qquad ( 8 - 2 )$$

23. The imaging lens according to claim 22,
wherein, in a case in which an open F-number in a state in which the infinite distance object is in focus is denoted by FNo,
Conditional Expression (9-2) is satisfied, which is represented by
$$0.66 < FNo / tan ω m < 1.55 . \qquad ( 9 - 2 )$$

24. The imaging lens according to claim 1,
wherein the focus lens group includes the stop, and
the stop moves along the optical axis during focusing.

25. The imaging lens according to claim 24,
wherein the imaging lens includes only one focus lens group, and
in a case in which a focal length of the focus lens group is denoted by ffs,
Conditional Expression (15) is satisfied, which is represented by
$$0.1 < f / ffs < 0.5 . \qquad ( 15 )$$

26. The imaging lens according to claim 24,
wherein, in a case in which a sum of a distance on the optical axis from a lens surface of the imaging lens closest to the object side to a lens surface of the imaging lens closest to the image side and the back focus of the imaging lens at the air conversion distance, in a state in which the infinite distance object is in focus, is denoted by TL,
Conditional Expression (8-2) is satisfied, which is represented by
$$3.4 < TL / ( f \times tan ω m ) < 5.9 . \qquad ( 8 - 2 )$$

27. The imaging lens according to claim 26,
wherein, in a case in which an open F-number in a state in which the infinite distance object is in focus is denoted by FNo,
Conditional Expression (9) is satisfied, which is represented by
$$0.55 < FNo / tan ω m < 2. \qquad ( 9 )$$

28. The imaging lens according to claim 24,
wherein, in a case in which a sum of a distance on the optical axis from a lens surface of the imaging lens closest to the object side to a lens surface of the imaging lens closest to the image side and the back focus of the imaging lens at the air conversion distance, in a state in which the infinite distance object is in focus, is denoted by TL,
Conditional Expression (8) is satisfied, which is represented by
$$3 < TL / ( f \times tan ω m ) < 7. \qquad ( 8 )$$

29. The imaging lens according to claim 28,
wherein, in a case in which an open F-number in a state in which the infinite distance object is in focus is denoted by FNo,
Conditional Expression (9-1) is satisfied, which is represented by
$$0.64 < FNo / tan ω m < 1.62 . \qquad ( 9 - 1 )$$

30. The imaging lens according to claim 1,
wherein the imaging lens includes two focus lens groups, and
in a case in which, among the two focus lens groups, the focus lens group on the object side is defined as a first focus lens group, and the focus lens group on the image side is defined as a second focus lens group,
the first focus lens group and the second focus lens group move by different movement amounts during focusing.

31. The imaging lens according to claim 30,
wherein, in a case in which a sum of a distance on the optical axis from a lens surface of the imaging lens closest to the object side to a lens surface of the imaging lens closest to the image side and the back focus of the imaging lens at the air conversion distance, in a state in which the infinite distance object is in focus, is denoted by TL,
Conditional Expression (8-2) is satisfied, which is represented by
$$3.4 < TL / ( f \times tan ω m ) < 5.9 . \qquad ( 8 - 2 )$$

32. The imaging lens according to claim 31,
wherein, in a case in which an open F-number in a state in which the infinite distance object is in focus is denoted by FNo,
Conditional Expression (9-2) is satisfied, which is represented by
$$0.66 < FNo / tan ω m < 1.55 . \qquad ( 9 - 2 )$$

33. The imaging lens according to claim 30,
wherein the first focus lens group is disposed in the front group, and the second focus lens group is disposed in the rear group.

34. The imaging lens according to claim 33,
wherein, in a case in which a sum of a distance on the optical axis from a lens surface of the imaging lens closest to the object side to a lens surface of the imaging lens closest to the image side and the back focus of the imaging lens at the air conversion distance, in a state in which the infinite distance object is in focus, is denoted by TL,
Conditional Expression (8) is satisfied, which is represented by
$$3 < TL / ( f \times tan ω m ) < 7. \qquad ( 8 )$$

35. The imaging lens according to claim 34,
wherein, in a case in which an open F-number in a state in which the infinite distance object is in focus is denoted by FNo,
Conditional Expression (9-2) is satisfied, which is represented by
$$0.66 < FNo / tan ω m < 1.55 . \qquad ( 9 - 2 )$$

36. The imaging lens according to claim 35,
wherein Conditional Expression (1-1) is satisfied, which is represented by
$$0.43 < Bf / ( f \times tan ω m ) < 1.1 . \qquad ( 1 - 1 )$$

37. The imaging lens according to claim 36,
wherein, in a case in which an Abbe number of the first lens based on a d line is denoted by νL1,
Conditional Expression (10) is satisfied, which is represented by
$$20 < vL 1 < 95. \qquad ( 10 )$$

38. The imaging lens according to claim 1,
wherein an Ls lens is disposed on the image side with respect to the second lens, and
in a case in which
a refractive index of the Ls lens at a d line is denoted by NLs,
an Abbe number of the Ls lens based on the d line is denoted by νLs, and
a partial dispersion ratio of the Ls lens between a g line and an F line is denoted by θgFLs,
Conditional Expressions (40), (41), (42), and (43) are satisfied, which are represented by
$$0.005 < NLs - ( 2.015 - 0.0068 \times vLs ) < 0.15 , \qquad ( 40 )$$
$$49.8 < vLs < 65 , \qquad ( 41 )$$
$$0.543 < θ gFLs < 0.58 , and \qquad ( 42 )$$
$$- 0.011 < θ gFLs - ( 0.6418 - 0.00168 \times vLs ) < 0.035 . \qquad ( 43 )$$

39. The imaging lens according to claim 38,
wherein, in a case in which a sum of a distance on the optical axis from a lens surface of the imaging lens closest to the object side to a lens surface of the imaging lens closest to the image side and the back focus of the imaging lens at the air conversion distance, in a state in which the infinite distance object is in focus, is denoted by TL,
Conditional Expression (8-3) is satisfied, which is represented by
$$3.5 < TL / ( f \times tan ω m ) < 5.65 . \qquad ( 8 - 3 )$$

40. The imaging lens according to claim 39,
wherein, in a case in which an open F-number in a state in which the infinite distance object is in focus is denoted by FNo,
Conditional Expression (9) is satisfied, which is represented by
$$0.55 < FNo / tan ω m < 2. \qquad ( 9 )$$

41. An imaging apparatus comprising:
the imaging lens according to claim 1.
